(19) United States
(12) Patent Application Publication
(10) Pub. No.: US 2025/0348988 A1
(43) Pub. Date: Nov. 13, 2025

(54) DEVICES, SYSTEMS, AND METHODS FOR PLANTER AND SEED TRENCH IMAGING AND ANALYSIS

(71) Applicant: Ag Leader Technology, Ames, IA (US)

(72) Inventors: Scott Eichhorn, Ames, IA (US); Brett Buehler, Dallas Center, IA (US); Alan F. Barry, Nevada, IA (US)

(21) Appl. No.: 19/207,115

(22) Filed: May 13, 2025

Related U.S. Application Data
(60) Provisional application No. 63/646,038, filed on May 13, 2024.
(60) Provisional application No. 63/683,149, filed on Aug. 14, 2024.
(60) Provisional application No. 63/696,721, filed on Sep. 19, 2024.
(60) Provisional application No. 63/723,436, filed on Nov. 21, 2024.

(51) Int. Cl. G06T 7/00; A01B 76/00; A01C 14/00; B60K 35/22; H04N 23/23

(52) U.S. Cl. CPC G06T 7/0002; A01B 76/00; A01C 14/00; B60K 35/22; H04N 23/23; B60K 2360/176; G06T 2207/10048; G06T 2207/20081; G06T 2207/30168; G06T 2207/30188; G06T 2207/30252

(57) ABSTRACT

An agricultural image analysis system comprising at least one vision sensor configured to view a seed trench; a storage module in communication with the at least one vision sensor; a processor in communication with the storage module, the processor executing at least one machine learning module for analysis of images from the at least one vision sensor. The system including at least one laser configured to emit a beam at an open seed trench and at least one vision sensor configured to view the open seed trench and the beam. The system including a thermal camera mounted to a row unit.

### CROSS-REFERENCE TO RELATED APPLICATION(S)

This application claims the benefit under 35 U.S.C. § 119(e) to U.S. Provisional Application 63/646,038, filed May 13, 2024, and entitled Seed Tube Camera and Related Devices, Systems, and Methods, U.S. Provisional Application 63/683,149, filed Aug. 14, 2024, U.S. Provisional Application 63/696,721, filed Sep. 19, 2024, U.S. Provisional Application 63/723,436, filed Nov. 21, 2024, each of which is hereby incorporated herein by reference in its entirety for all purposes.

### TECHNICAL FIELD

The disclosure relates to agricultural planters and real-time monitoring during planting processes.

### BACKGROUND

Modern planting operations allow operators to run their planters at 6+ mph. Additional accessories added to planters such as present-day seed metering and downforce systems, such as SureSpeed® and SureForce® from Ag Leader®, maintain planting accuracy and precision throughout the field in any soil condition. As would be appreciated most modern corn planter row units operate by opening a trench in the soil, depositing a seed from a delivery tube into the trench, then closing the trench with a collection of closing and/or press wheels. This process is not visible to the equipment operator seated in the tractor cabin.

There are problems that can occur during the planting process that can reduce the germination and/or health of the plant and ultimately reduce yield during harvest. These problems can include crop reside in the seed trench, soil clods in the seed trench, dry topsoil falling into the trench, collapsing or blown out trench sidewalls, improper seed planting depth, improper trench closure, air voids in the closed trench, inconsistent seed to soil contact, and/or other issues that would be appreciated by those of skill in the art.

Currently the operator must stop the equipment and carefully dig into the seed trench to observe the quality of the trench formation, seed placement, and closure. This manual process is time-consuming and requires a degree of skill and/or training, as well as being subjective in many aspects. Even by manually observing the trench and/or seed it can be difficult to determine the root cause of any problems discovered because only the end results of the planting process can be observed.

This manual process requires a skilled operator to identify key trench characteristics that may determine whether a seed trench is properly formed or not. If the seed trench is not properly formed, then the operator must adjust their downforce settings so that the seed trench is not collapsing in on itself due to insufficient downforce but not so much that the trench sidewalls become compacted. This may require the operator to get out of the cab several times to recheck seed trench formation until a proper seed trench is made, making this process both time intensive and frustrating. Furthermore, soil conditions change across a field requiring the operator to periodically check the seed trench and make downforce adjustments as needed to prevent collapsing and compaction.

As would be understood, a seed trench with too little downforce applied to it will have weak sidewalls that collapse into the center of the seed trench. This may prevent seeds from being deposited at the proper planting depth. Collapsed trenches can also introduce dry topsoil to the seed which may prevent the necessary amount of moisture needed for the seed to germinate. Comparatively too much downforce may over compact the sidewalls of the trench, and the roots of the seed will not be able to break through this compacted soil, thus negatively impacting plant growth and yield. This is especially troubling when the soil is particularly moist as the sidewalls can be smeared against the opening disks with enough force that the closing wheels cannot breakup the sidewalls. This risks the seed trench reopening as the soil dries out exposing seeds to the outside environment. Moist soil can also stick to the opening disks and fall off in ribbons into the seed trench disturbing the seed trench in a similar manner to a collapsing trench.

Further, crop care additives such as insecticide, herbicide, and others are often applied during planting operations to aid in crop growth and protection. These additives are not visible to the operator while being placed in the seed trench and without knowing the quality of application, seeds could be left vulnerable to pests and/or stunted growth due to lack of nutrients. Being able to detect and evaluate the application of additives can be important to maximizing yields by protecting plants and providing proper nutrients.

Prior known solutions propose mounting visual sensors or cameras between the opening disks and the closing wheels of a row unit to capture images of the seed trench while it is still open. An implementation of a prior system includes a camera positioned on a row unit, such as that of FIG. 1, between the opening disk and closing wheel providing a top-down view of the trench. This view can provide basic feedback on trench formation, seed placement, and if there is debris falling into the trench. The top-down perspective provided, by prior systems, makes it difficult to assess the depth of the trench and/or seed planting depth. Additionally, dust that is commonly generated during planting can also obscure the view of the trench.

### BRIEF SUMMARY

In Example 1, an agricultural image analysis system comprising at least one vision sensor configured to view a seed trench, a storage module in communication with the at least one vision sensor, and a processor in communication with the storage module, the processor executing at least one machine learning module for analysis of images from the at least one vision sensor.

Example 2 relates to the system of any of claims 2-20, wherein the at least one machine learning module is configured to detect trench formation issues including one more of peeling, smearing, collapsing, debris incursion, sidewall blowout, improper width, and improper depth.

Example 3 relates to the system of any of claims 1-2 and 4-20, wherein the processor is configured to command adjustments to one or more of a closing wheel downforce, gauge wheel downforce, row cleaner deployment based on detected trench formation issues.

Example 4 relates to the system of any of claims 1-3 and 5-20, wherein the at least one machine learning module is configured to alert an operator to the trench formation issues when more than a threshold number instances of the trench formation issue has occurred.

Example 5 relates to the system of any of claims 1-4 and 6-20, wherein the at least one machine learning module is configured to detect trench formation quality.

Example 6 relates to the system of any of claims 1-5 and 7-20, further comprising at least one supplemental lighting source mounted on a row unit.

Example 7 relates to the system of any of claims 1-6 and 8-20, further comprising one or more light filters in association with the at least one vision sensor or supplemental lighting source.

Example 8 relates to the system of any of claims 1-7 and 9-20, further comprising a position sensor configured to detect the vertical position of a row unit.

Example 9 relates to the system of any of claims 1-8 and 10-20, further comprising at least one laser configured to project a beam into the seed trench for viewing by the at least one vision sensor.

Example 10 relates to the system of any of claims 1-9 and 11-20, further comprising at least one thermal camera configured to view of the seed trench.

Example 11 relates to the system of any of claims 1-10 and 12-20, wherein the at least one vision sensor is mounted at a distal end of a seed tube.

Example 12 relates to the system of any of claims 1-11 and 13-20, further comprising at least one seed firmer disposed on a row unit, and wherein the at least one vision sensor view the seed firmer.

Example 13 relates to the system of any of claims 1-12 and 14-20, wherein the at least one vision sensor is mounted at a distal end of a seed tube guard below a seed exit point of a seed tube.

Example 14 relates to the system of any of claims 1-13 and 15-20, further comprising at least one vision sensor actuator, wherein the at least one vision sensor actuator is configured to move the at least one vision sensor.

In Example 15, an seed trench analysis system comprising at least one laser configured to emit a beam at an open seed trench, at least one vision sensor configured to view the open seed trench and the beam, a storage module in communication with the at least one vision sensor, and a processor in communication with the storage module, the processor executing at least one machine learning module for analysis of images from the at least one vision sensor.

Example 16 relates to the system of any of claims 1-15 and 17-20, wherein the at least one machine learning module is configured to detect one or more of trench peeling, trench smearing, trench collapsing, debris in the trench, seed placement errors, seed firmer errors, opening disk errors, gauge wheel errors, closing wheel errors, insecticide application errors, fertilizer application errors.

Example 17 relates to the system of any of claims 1-16 and 18-20, wherein the at least one machine learning module is configured to detect trench formation quality.

In Example 18, an agricultural planting monitoring system comprising a thermal camera mounted to a row unit, a processor in communication with the thermal camera, the processor executing at least one machine learning module for analysis of images from the thermal camera, and a display in communication with the processor, wherein the thermal camera is configured to capture images of a seed trench during planting operations for processing by the processor and display to an operator on the display.

Example 19 relates to the system of any of claims 1-18 and 20, wherein the at least one machine learning module is configured to detect one or more of trench peeling, trench smearing, trench collapsing, debris in the trench, seed placement errors, seed firmer errors, opening disk errors, gauge wheel errors, closing wheel errors, insecticide application errors, fertilizer application errors.

Example 20 relates to the system of any of claims 1-19, wherein the at least one machine learning module is configured to detect trench formation quality.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1A is a rear view of the trench visualization system fitted to an agricultural vehicle, according to one implementation.

FIG. 1B is a diagram of the operations system of the trench visualization system, according to one implementation.

FIG. 2 is an image of a seed trench under peeling conditions, according to one implementation.

FIG. 3 is an image of a seed trench under smearing conditions, according to one implementation.

FIG. 4 is an image of a seed trench under collapsing conditions, according to one implementation.

FIG. 5 is an image of a seed trench with debris present, according to one implementation.

FIG. 6 is an image of a seed trench under clodding conditions, according to one implementation.

FIG. 7 is an image of a seed trench that is too wide, according to one implementation.

FIG. 8 is an image of a seed trench that is too narrow, according to one implementation.

FIG. 9 is an image of a seed trench with a sidewall blowout, according to one implementation.

FIG. 10 is an image of a well-formed seed trench, according to one implementation.

FIG. 11 is a diagram of a row unit, according to one implementation.

FIG. 12 is an image of a seed placed in a seed trench, according to one implementation.

FIG. 13 is an image of a seed firmer on a row unit, according to one implementation.

FIG. 14 is a diagram of a row unit with a seed firmer shown, according to one implementation.

FIG. 15 is an image of closing wheels closing a seed trench, according to one implementation.

FIG. 16 is diagram of how closing wheels may be misaligned, according to one implementation.

FIG. 17 is an image of gauge wheels on a raised row unit, according to one implementation.

FIG. 18 is a diagram of the top view of a vision sensor on a row unit, according to one implementation.

FIG. 19 is a diagram of the side view of a vision sensor on a row unit, according to one implementation.

FIG. 20 is a diagram of a color filtration setup that may be used with the vision sensor, according to one implementation.

FIG. 21 is a diagram of a color filtration setup that filters light as it enters the lens, according to one implementation.

FIG. 22 is a diagram of a color filtration setup with a light emitter with a light filter, according to one implementation.

FIG. 23 is a diagram of how residue may be highlighted using color filtration, according to one implementation.

FIG. 24 is a diagram of a row unit having multiple lighting sources, according to one implementation.

FIG. 25 is an image of a seed trench created by row unit having multiple lighting sources, according to one implementation.

FIG. 26 is an image of a seed trench with warm filtered light, according to one implementation.

FIG. 27 is an image of a seed trench with cool filtered light, according to one implementation.

FIG. 28 is an image of a seed trench without a polarizing filter, according to one implementation.

FIG. 29 is an image of a seed trench with a polarizing filter, according to one implementation.

FIG. 30A is an illustration of an image without light filtration, according to one implementation.

FIG. 30B is an illustration of an image with light filtration, according to one implementation.

FIG. 31 is a diagram of a row unit with a camera above the trench firmer, according to one implementation.

FIG. 32 is a diagram of a row unit with a camera, according to one implementation.

FIG. 33 is a diagram of a row unit with a camera with adjustable angle, according to one implementation.

FIG. 34 is a diagram of a row unit with a camera and multiple lights, according to one implementation.

FIG. 35 is a diagram of a row unit with camera with a trench firmer used as a light source, according to one implementation.

FIG. 36 is a diagram of a row unit with a camera and a lux sensor, according to one implementation.

FIG. 37 is a diagram of a row unit with a camera and a light source built into the frame of the row unit, according to one implementation.

FIG. 38 is a diagram of a row unit with closing wheels that operate under automated actuators, according to one implementation.

FIG. 39 is a diagram of a row unit with automated gauge wheel control, according to one implementation.

FIG. 40 is a diagram of a row unit with connectivity to storage and display components, according to one implementation.

FIG. 41 is an image that the trench visualization system would analyze for peeling, according to one implementation.

FIG. 42 is an image of a display that may be used in the trench visualization system, according to one implementation.

FIG. 43 is an image of a display with an embedded diagram of a presently forming seed trench, according to one implementation.

FIG. 44 is an image of a display of various seed trenches being formed, according to one implementation.

FIG. 45 is an image of a display with an embedded diagram with a corresponding video feed image of diagramed trench, according to one implementation.

FIG. 46 is an image of a display with the location of rows positioned onto a field map, according to one implementation.

FIG. 47 is an image of an overview display informed by a camera mounted to a trench firmer, according to one implementation.

FIG. 48 is an image of a display with operational errors displayed to a user, according to one implementation.

FIG. 49 is an image of a seed trench with a laser used to highlight trench conditions, according to one implementation.

FIG. 50 is an image of a seed trench with a laser highlighting sidewalls that are closing in, according to one implementation.

FIG. 51 is an image of a seed trench with a laser showing the depth and full shape of the seed trench, according to one implementation.

FIG. 52 is an image of a seed trench with a laser showing that the seed trench is compacted, according to one implementation.

FIG. 53 is an image of a seed trench with a laser showing that the seed trench walls are buckled, according to one implementation.

FIG. 54 is an image of a seed trench with a laser showing that the seed trench is properly formed, according to one implementation.

FIG. 55 is an image of a seed trench with a laser showing that the seed trench is too shallow, according to one implementation.

FIG. 56 is an image of a seed trench with a laser showing that the seed trench contains residue, according to one implementation.

FIG. 57 is an image of a seed trench with a laser showing that the seed trench contains debris, according to one implementation.

FIG. 58 is an image of a seed trench in which dirt and dust has obscured the laser in regards to the seed trench, according to one implementation.

FIG. 59 is an image of a seed trench with a laser showing that the seed trench has collapsed, according to one implementation.

FIG. 60 is an image of a seed trench with a laser showing that the seed trench is properly formed, despite debris lightly obscuring the laser, according to one implementation.

FIG. 61 is an image of a seed trench with a crosshair laser, according to one implementation.

FIG. 62A is an image of a seed trench with a laser showing that the seed trench is shallower than concurrently formed seed trenches, according to one implementation.

FIG. 62B is an image of a seed trench with a laser showing that the seed trench is deeper than concurrently formed seed trenches, according to one implementation.

FIG. 63 is a graph of soil temperature gradients through various depths in different seasons, according to one implementation.

FIG. 64 is a thermal image of a seed trench, according to one implementation.

FIG. 65 is a thermal image of a seed trench with warm topsoil falling into the seed trench, according to one implementation.

FIG. 66 is a thermal image of a seed trench with a warm clod falling into the seed trench, according to one implementation.

FIG. 67 is a thermal image of a seed trench with warm residue in the seed trench, according to one implementation.

FIG. 68 is a thermal image the opening wheels of a row unit, according to one implementation.

FIG. 69 is a thermal image the opening wheels of a row unit collecting soil, according to one implementation.

FIG. 70 is a diagram of insecticide being applied to a seed trench, according to one implementation.

FIG. 71 is a diagram of fertilizer being applied to a seed trench, according to one implementation.

FIG. 72 is a diagram of a row unit with a thermal camera facing the seed tube, according to one implementation.

FIG. 73 is a diagram of a row unit with a thermal camera facing the closing wheels, according to one implementation.

FIG. 74 is a diagram of a row unit with a thermal camera mounted on a motorized arm, according to one implementation.

FIG. 75 is a diagram of a row unit with a thermal camera mounted to give a top-down view of the seed trench, according to one implementation.

FIG. 76 is an image of a display with combined thermal and RGB images of a seed trench, according to one implementation.

FIG. 77 is a decision matrix that may be used by the trench visualization system, according to one implementation.

FIG. 78 a diagram of a row unit with an imaging sensor placed on seed tube, according to one implementation.

FIG. 79 a close-up diagram of a row unit with an imaging sensor placed on seed tube, near the seed tube guard, according to one implementation.

FIG. 80 a diagram of supplemental lighting that may be placed near the imaging sensor, according to one implementation.

FIG. 81 is an image of a seed trench taken as low speeds, according to one implementation.

FIG. 82 is an image of a seed trench taken as low speeds with an extra seed entering the seed trench, according to one implementation.

FIG. 83 is an image of a well-formed seed trench taken as low speeds, according to one implementation.

FIG. 84 is an image of a compacted seed trench taken as low speeds, according to one implementation.

FIG. 85 is a diagram of a row unit with an imaging sensor placed on seed tube guard, according to one implementation.

FIG. 86 is an image of a seed trench taken as low speeds with the gauge wheel and closing wheels shown, according to one implementation.

FIG. 87 is a diagram of a row unit with supplemental lighting integrated into the seed firmer, according to one implementation.

FIG. 88 is a diagram of a row unit supplemental lighting behind the camera, which is located on the seed firmer, according to one implementation.

FIG. 89 is a diagram of a row unit supplemental lighting behind the camera, according to one implementation.

FIG. 90 is a diagram of a row unit with cameras on each side of the seed tube, according to one implementation.

FIG. 91 is an image of the gauge wheel of a row unit in the raised position, according to one implementation.

FIG. 92 is a diagram of a row unit with the camera on the front side of the seed tube and supplemental lighting on the backside, according to one implementation.

FIG. 93 is an image of a seed trench taken as low speeds residue in the trench, according to one implementation.

### DETAILED DESCRIPTION

Disclosed herein is an agricultural monitoring system and particularly a system for observing and monitoring agricultural planting including high speed planting. In various implementations, the system includes at least one sensor, optionally a camera (also referred to herein as a “vision sensor”) mounted on the row unit, optionally, near the bottom of a seed delivery tube facing the rear of a row unit toward the closing wheels. This viewing perspective, looking along the seed trench (also referred to herein a “seed trench” or “trench”) and parallel to the ground, provides a view of the vertical axis of the seed placement and trench conditions. Various further implementations, include the use of supplemental lighting, lux sensors, position sensors, lasers, and thermal cameras for viewing and obtaining detailed data regarding trench formation and planter performance. In various implementations a machine learning model is used and taught to analyze and interpret that trench formation and planter performance data to score and otherwise inform operators about planting performance and trench quality.

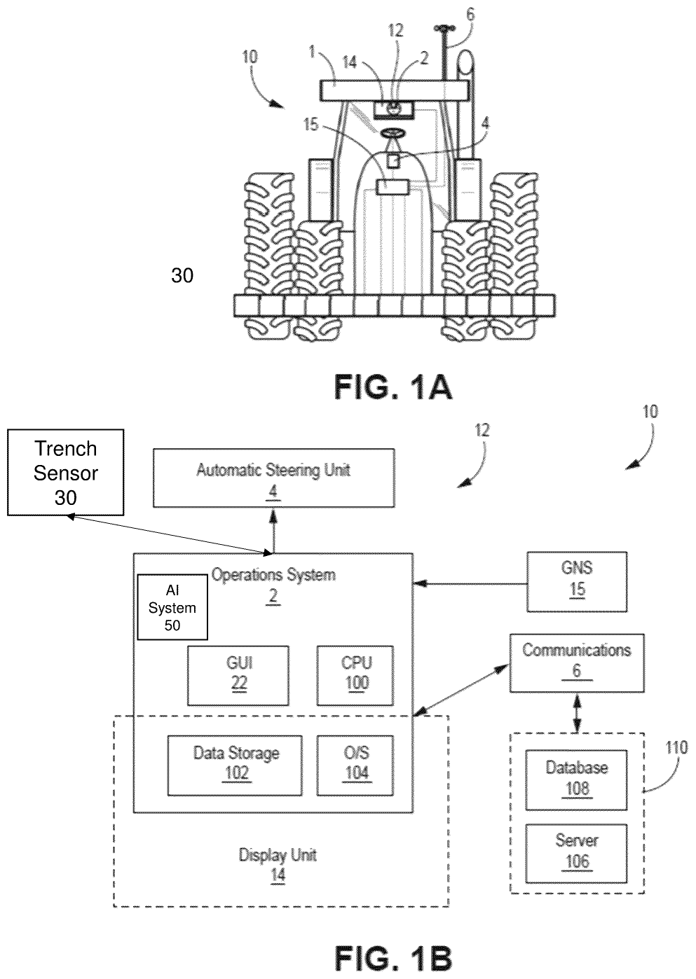

Turning to the drawings in greater detail, FIGS. 1A-1B depict exemplary implementations of the trench visualization system 10 components fitted to an agricultural vehicle 1. In various implementations, the agricultural vehicle 1 may be a tractor 1, optionally having an implement such as a planter, as would be understood. It is understood that a variety of vehicles 1 and implements can be utilized in various implementations. It is further understood that the components depicted in FIGS. 1A-1B are optional, and can be utilized or omitted in the various claimed implementations, and that certain additional components may be required to effectuate the various processes and systems described herein. Such additional components may include hardware, software, firmware, and other electronic components that would be known and appreciated by those of skill in the art.

At planting speeds, the seed trench moves too fast for the operator to review the images manually, so a machine learning algorithm is employed to monitor the quality of the seed trench instead. Having high quality images that are clear allows the model to make accurate assessments of the seed trench and report those findings to the operator. The machine learning model, in various implementations, is trained to detect signs of compaction, collapsing, debris within the seed trench, seed placement, and consistent depth and may also be used to monitor the presence of the closing and gauge wheels when the planter is operating. The machine learning model may then report the quality of the seed trench to the operator so that they can adjust planter settings as needed, or the model may automatically adjust planter settings as needed.

As shown in FIG. 1A, the trench visualization system 10 has an operations system 2 that comprises or is configured to be operationally integrated with a steering unit 4, such as SteerCommand®, and an optional communications component 6. The system 10 is operationally integrated with at least one in-cab display 14, such as an InCommand® display 14, or other suitable display 14 understood in the art. It is appreciated that certain of these displays 14 feature touchscreens, while others are equipped with necessary components for interaction with the various prompts and adjustments discussed herein, such as via a keyboard or other interface and associated Graphical User Interface (GUI) 22.

In various implementations, the system 10 is also operationally integrated with a GNSS or GPS unit 15, such as a GPS 7500, such that the system 10 is configured to input positional data for use in defining boundaries, locating the tractor 1 and plotting guidance and the like, as would be readily appreciated from the present disclosure.

As shown in FIG. 1B, in various implementations, the operations system 2 is optionally in operational communication with the automatic steering unit 4 or controller 4, the communications component 6, and/or GNSS 15. In certain of these implementations, the operations system 2 is housed in the display 14, though the various components described herein can be housed elsewhere, as would be readily appreciated.

As shown in FIG. 1B, the operations system 2 further has one or more optional processing and computing components, such as a CPU/processor 100, data storage 102, operating system 104, and other computing components necessary for implementing the various technologies disclosed herein. It is appreciated that the various optional system components are in operational communication with one another via wired or wireless connections and are configured to perform the processes and execute the commands described herein.

In certain implementations, like that of FIG. 1B, the communications component 6 is configured for the sending and receiving of data for cloud 110 storage and processing, such as to a remote server 106, database 108, and/or other cloud computing components readily understood in the art. Such connections by the communications component 6 can be made wirelessly via understood internet and/or cellular technologies such as Bluetooth, WiFi, LTE, 3G, 4G, or 5G connections and the like. It is understood that in certain implementations, the communications component 6 and/or cloud 110 components comprise encryption or other data privacy components such as hardware, software, and/or firmware security aspects. In various implementations, the operator or enterprise manager or other third parties are able to receive notifications such as adjustment prompts and confirmation screens on their mobile devices, and in certain implementations can review the trench and planter performance data and make adjustments via their mobile phones.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/776,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. Patent Application 63/651,831, filed May 24, 224, entitled “Non-Contact Methods for Interactions in Navigational Space of Relatively Located Mobile Systems, and Related Devices and Systems,” U.S. Patent Application 63/654,634, filed May 31, 2024, entitled “Equipment Thermal Monitoring System and Associated Methods and Devices,” U.S. Patent Application 63/667,546, filed Jul. 3, 2024, entitled “Cover for Port Openings,” U.S. Patent Application 63/667,530, filed Jul. 3, 2024, entitled “Agricultural Seed Meters and Related Devices, Systems and Methods,” U.S. Patent Application 63/685,000, filed Aug. 20, 2024, entitled “Crop Sensor Wands and Related Devices, Systems, and Methods,” U.S. Patent Application 63/682,229, filed Aug. 12, 2024, entitled “Integrated Crop Sensor and GPS Steering Systems and Related Devices and Methods,” U.S. Patent Application 63/710,492, filed Oct. 22, 2024, entitled “Crop Sensors and Related Devices, Systems, and Methods,” U.S. Patent Application 63/710,641, filed Oct. 23, 2024, entitled “Agricultural Sprayer Boom Flush, Chemical Detection and Chemical Concentration Detection,” U.S. Patent Application 63/720,611, filed Nov. 14, 2024, entitled “Liquid Product Distribution for See and Spray Systems,” U.S. Patent Application 63/722,916, filed Nov. 20, 2024, entitled “Agricultural Harvesting Systems and Related Devices and Methods,” U.S. Patent Application 63/722,934, filed Nov. 20, 2024, entitled “Sprayer PWM Nozzle Valve Pressure Drop Mitigation,” U.S. Patent Application 63/723,400, filed Nov. 21, 2024, entitled “Systems, Methods and Devices for Increasing Machine Operating Range Using PWM and Dynamic Pressure Range Control,” U.S. Patent Application 63/727,579, filed Dec. 3, 2024, entitled “Smart Shift for Automatic AB Line Adjustment in Agricultural Operations and Related Devices and Methods,” U.S. Patent Application 63/752,279, filed Jan. 31, 2025, entitled “System and Automatic Adjustment to Target Pressure and Related Devices and Methods,” U.S. Patent Application 63/752,341, filed Jan. 31, 2025, entitled “Harvester Liquid Application System, Devices, and Methods,” U.S. Patent Application 63/753,258, filed Feb. 3, 2025, entitled “Agricultural Navigation Methods, Devices, and Systems,” U.S. Patent Application 63/753,201, filed Feb. 3, 2025, entitled “Agricultural Mapping and Related Devices, Systems, and Methods” U.S. Patent Application 63/755,675, filed Feb. 7, 2025, entitled “Remote Assistance for Agricultural Display Methods and Related Devices and Systems,” U.S. Patent Application 63/757,242, filed Feb. 11, 2025, entitled “Seed Meter,” U.S. Patent Application 63/757,434, filed Feb. 12, 2025, entitled “Grain Fill Sensor,” U.S. Patent Application 63/760,907, filed Feb. 20, 2025, entitled Agricultural Yield Monitoring and Estimation Devices, Systems, and Methods,” each of which is incorporated herein by reference.

### Planting Errors

The creation of a well-formed trench includes careful consideration of the planting environment and the planter condition. In various implementations, trench images collected by the system 10 and devices described herein are analyzed and used to identify yield robbing seed trench errors. Trench errors detectable by the system 10 include, but are not limited to trench peeling, trench smearing, trench collapsing, debris in the trench, seed placement errors, seed firmer errors, opening disk errors, gauge wheel errors, closing wheel errors, insecticide application errors, fertilizer application errors, and others as would be understood. The image analysis implemented herein may include computer or machine vision artificial intelligence, such as machine learning models and other like artificial intelligence system. Additionally or alternatively, non-artificial intelligence methods for image analysis may be implemented including rules-based computer or machine vision.

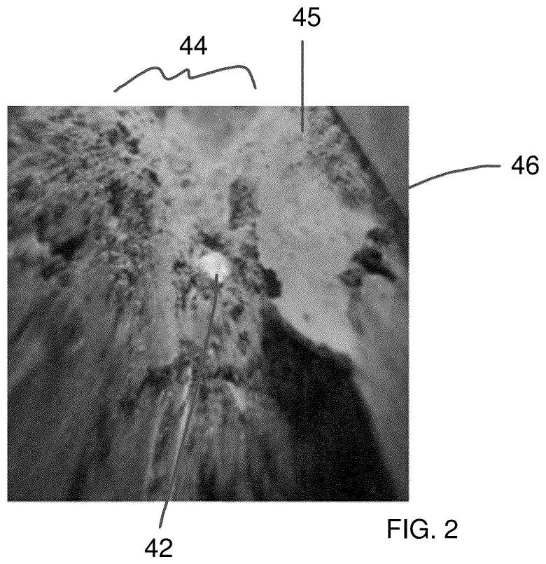

Peeling—Shown for example in FIG. 2, peeling is a phenomenon that occurs when planting in overly wet soil conditions. As the opening disk opens the trench 44, the wet soil 45 may stick to the disk when the disk rotates up and out of the soil 45. The wet soil 45 may then come off the disk in peels 46. Peels 56 of soil 45 in a seed trench 44 can cause poor seed 42-to-soil 45 contact. This can cause germination problems and uneven emergence.

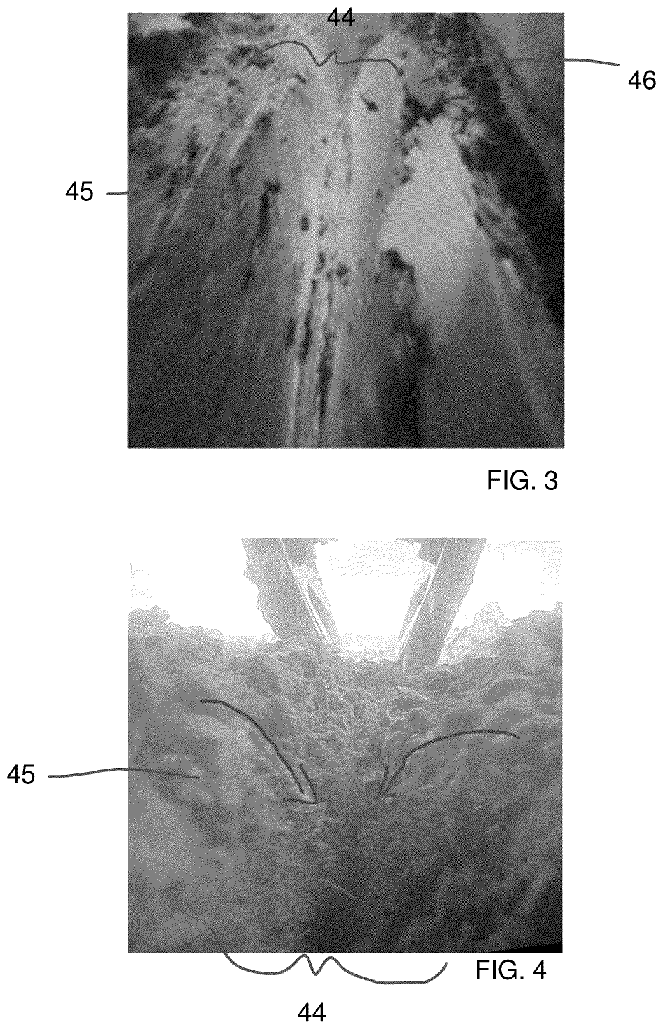

Smearing—Shown for example in FIG. 3, smearing is another event that can happen in wet soil 45 where soil 45 is pressed against the sidewalls of the trench 44 compacting the sidewall. If the soil 45 dries before roots can penetrate the sidewalls of the trench 44, root and plant growth can be negatively impacted. These traits may be monitored to ensure proper trench 44 quality and health of crops. As can be seen in FIG. 3, the trench 44 is a well-defined ‘V’ shape but due to wet soil 45, the trench 44 sidewalls are very smooth and appear to even be peeling 46 slightly in the top right of the image.

Collapsing—A collapsed trench 44 occurs when the trench 44 sidewalls cannot sufficiently support the profile of the trench 44 and cave in on itself, shown for example in FIG. 4. This can happen in a variety of different planting conditions and may be monitored to ensure proper placement of the seed within the trench 44. Dry soil 45 has the potential to break away and flake off into the valley of the trench 44 while insufficient downforce prevents the sidewalls from being compacted enough to hold the profile. When collapsing soil 45 falls back into the trench 44 before the seed is deposited, the seed will be planted at a shallower depth than intended. This may cause germination and emergence problems. Collapsing may also have traits of peeling when strips of soil 45 fall into the trench 44 preventing the formation of the sidewalls. Increasing row unit down force will often reduce collapsing, as would be generally understood, yet excessive downforce may also cause issues. The disclosed system 10 may optionally include an open or closed loop downforce control that uses “collapsing” as an input.

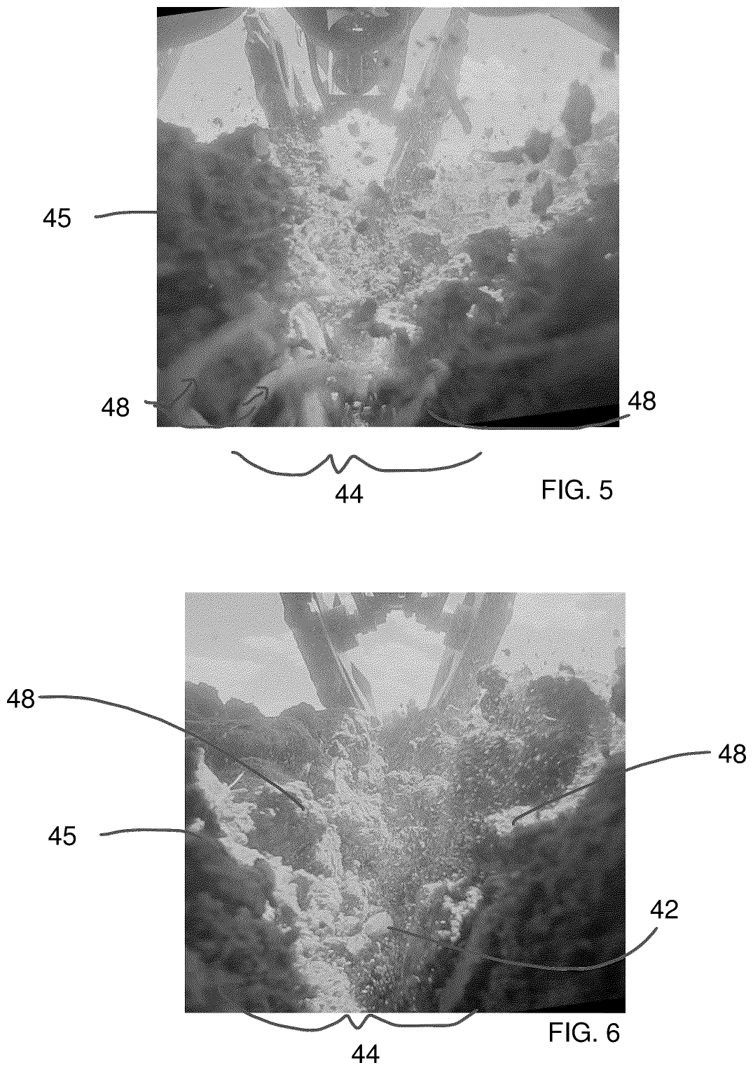

Debris—FIG. 5 is an exemplary image showing debris 48 in the trench 44, where residue 48 can be seen coming from under the camera into view of the image. Quantifying debris 48 present in or around the trench 44 may be valuable information in examining trench 44, planting, and soil quality. Plant material, known as residue 48, may fall into the open trench 44 between the opening discs and closing wheels. This material 48 may be pieces of the prior crop, such as corn, soybeans, or cover crops. When residue 48 lands on top of or beside the seed it can impede germination and plant emergence. Residue 48 may be mixed in the soil 45 through tilling or other methods to aid in breaking down matter from previous crops. Identification of the kind of residue 48 present in the trench 44 (i.e. soybean stubble or corn stalks) may be of benefit to operators during planting and field planning. To limit the amount of residue 48 in the seed trench 44, cleaners may be installed in front of the opening disks to remove debris 48 from the path of the trench 44.

In the case of tillage, there are many distinct levels of tillage so the amount of residue 48 within the trench 44 may change drastically from field to field. Viewing the residue 48 present allows operators to remain informed about the health and condition of the soil 45. Other debris 48 in the form of rocks, clods, or other undesirable items may be seen within the trench 44 at different rates and sizes and reported to the operator via the system 10 and devices that will be described in more detail herein.

FIG. 6 shows a trench 44 with no defined trench 44 profile from clods 48 falling into the trench 44. This type of trench 44 formation issue can also be feedback to the operator regarding their tillage practices.

Further, debris 48 can get caught in the closing wheel brackets and wedged against the closing wheels, which can cause improper trench 44 closing. Heavy corn residue 48, like stalks, can be dragged along the trench 44 disturbing where the trench 44 is already closed or the surrounding space before closure. Large pieces of residue 48 can also impact the closing wheels by causing them to bounce when they strike debris 48 in their path. This can damage the closing wheel alignment preventing the closing wheel from effectively closing the trench 44. In situations where residue 48 is disrupting trench 44 formation or closure the operator should be notified to correct the problem, so it does not impact yield.

Row Cleaners—An additional disruption to trench 44 formation may occur when the row cleaners are too aggressive in clearing residue 48 from the trench 44. Soil may be caught in the cleaners and thrown out of the way of the opening disks creating a furrow in front of the trench 44.

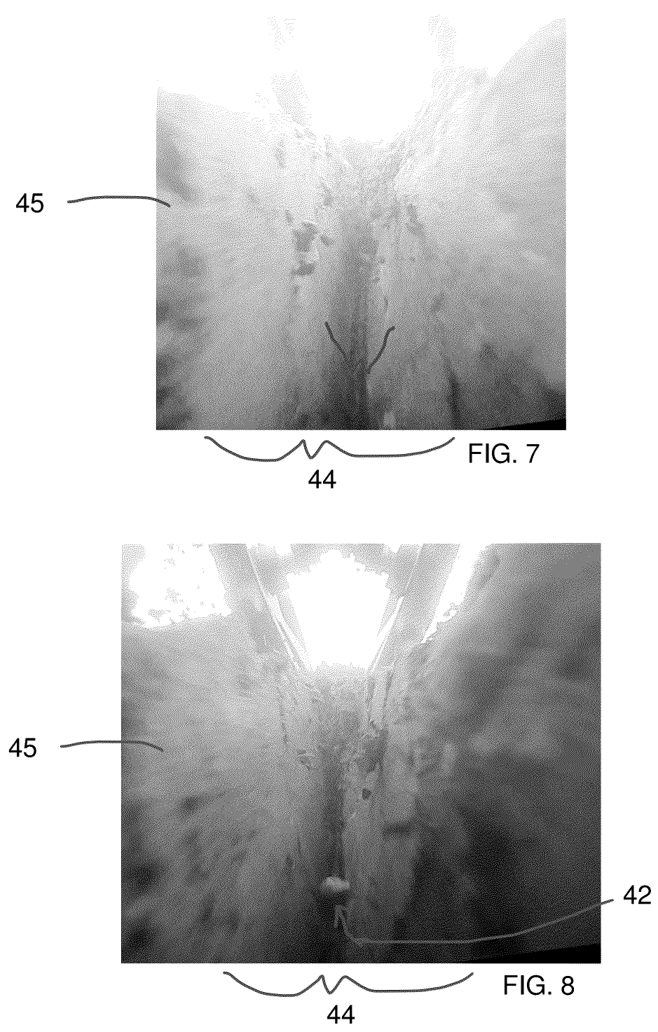

Trench Width—If the trench 44 is too wide, narrow, or has a ‘W’ shaped point this could be a sign of improperly placed opening disks. FIG. 7 shows a ‘W’ shaped point that could be a sign of improperly placed opening disks. The system 10 and associated devices disclosed herein may be configured to alert an operator of the condition and optional need for correction. In FIG. 8 the trench 44 appears to be too narrow for seeds 42 to be placed at the bottom of the trench 44. In this situation, the operator may need to adjust the opening disks or use a seed firmer to achieve the set planting depth.

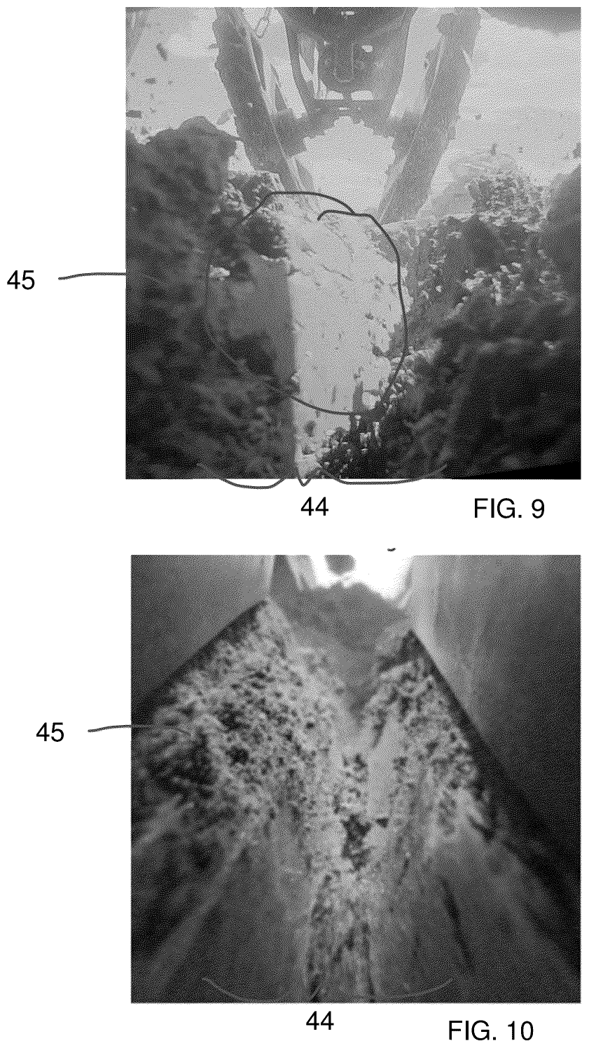

Sidewall Blowout—In some planting conditions as the trench 44 walls form, pieces of the trench 44 wall can flake off, creating voids in the sidewall. FIG. 9 is an example of sidewall blowout where a piece of the sidewall has stuck to the opening disk then fallen into the trench 44. This sidewall blowout causes uneven depth and inconsistent seed to soil contact. Once the trench 44 is closed by the closing disks these voids can lead to air pockets within the trench 44 that could impact plant growth and soil health. The trench 44 should be free of these inflictions to prevent a poor trench rating. Optionally, an operator can be notified if these events occur or after a certain number of these events occur, as will be discussed further herein.

Trench Depth—A trench 44 should be created at the depth set by the operator and remain consistent while the planter is in motion. Contact between the gauge wheels and soil should create a clearly defined line where the trench sidewall meets the surface. This defined line is a sign that enough downforce is being applied to form the trench 44 but not compact the soil 45 to the point of smearing.

Good Trench—A good trench 44 encompasses many different qualities that are to be taken into consideration when determining if a trench 44 has been formed correctly. FIG. 10 shows an example of a good trench 44. When the trench 44 forms it should be free of residue 48, clods 48, and other debris 48 that could prevent proper seed 42 to soil 45 contact. If loose soil 45 is present within the trench 44, it should be minimal and should not collect in the center of the trench 44. The sidewalls of the trench 44 should be a well-defined ‘V’ shape that come to a point in the center without overly compacted sidewalls.

### Seed Placement Quality

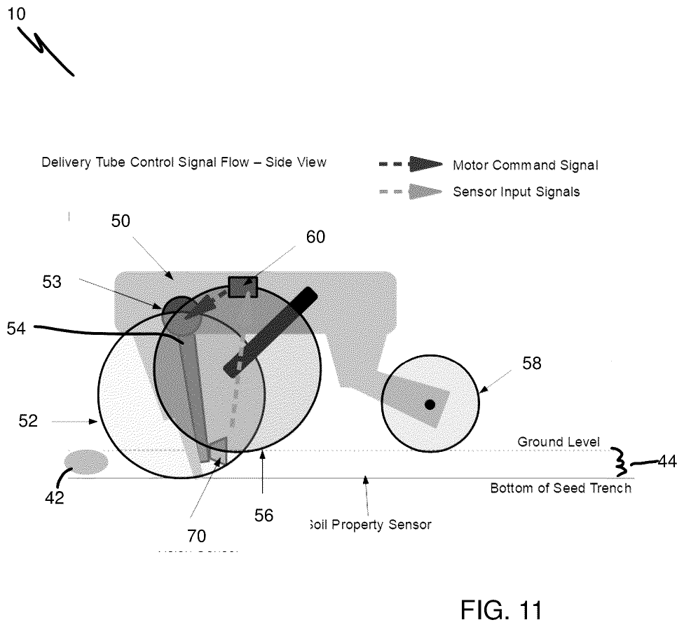

Turning to FIG. 11, information regarding the quality of seed placement may be available to an operator by identifying the seed 42 within the trench 44. As a seed 42 is dispensed out of the seed tube 54 into the trench 44, the seed 42 can bounce and roll within the trench 44. When the seed 42 bounces or rolls, instead of being placed at determined intervals in the center of the trench 44, the seeds 42 can be off center or move towards or away from each other, causing improper spacing. Crops must be planted at precise intervals to ensure that plants are not competing for nutrients and space. Should the seeds 42 not be placed correctly the operator should be notified so that corrective action can take place to prevent any loss of yield.

FIG. 11 shows an exemplary row unit 50, implementing the system 10 for notifying an operator of seed 42 placement issues in addition to or instead of trench 44 formation issues. For example, if the seed 42 is recognized as tumbling in the seed trench 44 and the system 10 is equipped with a powered seed delivery tube 54, such as that on the Ag Leader® SureSpeed® system or similar system, as would be recognized by those of skill in the art, delivery tube 54 speed can be controlled to minimize seed 42 tumble by adjusting the exit speed of the seed 42.

Row units 50 may include a variety of components in a variety of configurations. Typical row units 50 will include one or more opening disks 52, one or more gauge wheels 56, and one or more closing wheels 58. Row units 50 may also include a seed meter 53 and seed delivery tube 54, for seed 42 singulation and delivery to the trench 44. The row unit 50 may also include various processing components or controllers 60 for control of the various components on the row unit 50, as would be understood. The controller 60 may receive inputs from the various components of the row unit 50 and send commands to the same. The controller 60 may optionally be integrated with or in control with the operations system 2 and/or communications component 6 of the system 10.

The row unit 50 may further include one or more trench visualization sensors 70, as will be discussed variously herein.

Information can be gathered by viewing the seed 42 in the trench 44, such as the percentage of seed 42 refuge, the percentage of seeds 42 covered by clods 48 or residue 48, or instances regarding seed 42 placement that happens after the sensor 70 in the seed tube 54. If seeds 42 are recognized to be tumbling, having too many doubles, or any other flaws in placement then the system 10 may automatically or semi-automatically adjust the row unit 50 or system thereon to correct the issue. For example, if the operator is using a powered seed delivery tube 54, the seed delivery system (optionally the seed meter 53) may be automatically adjusted by the system 10, optionally via a machine learning model, to minimize issues or suggest changes to the operator.

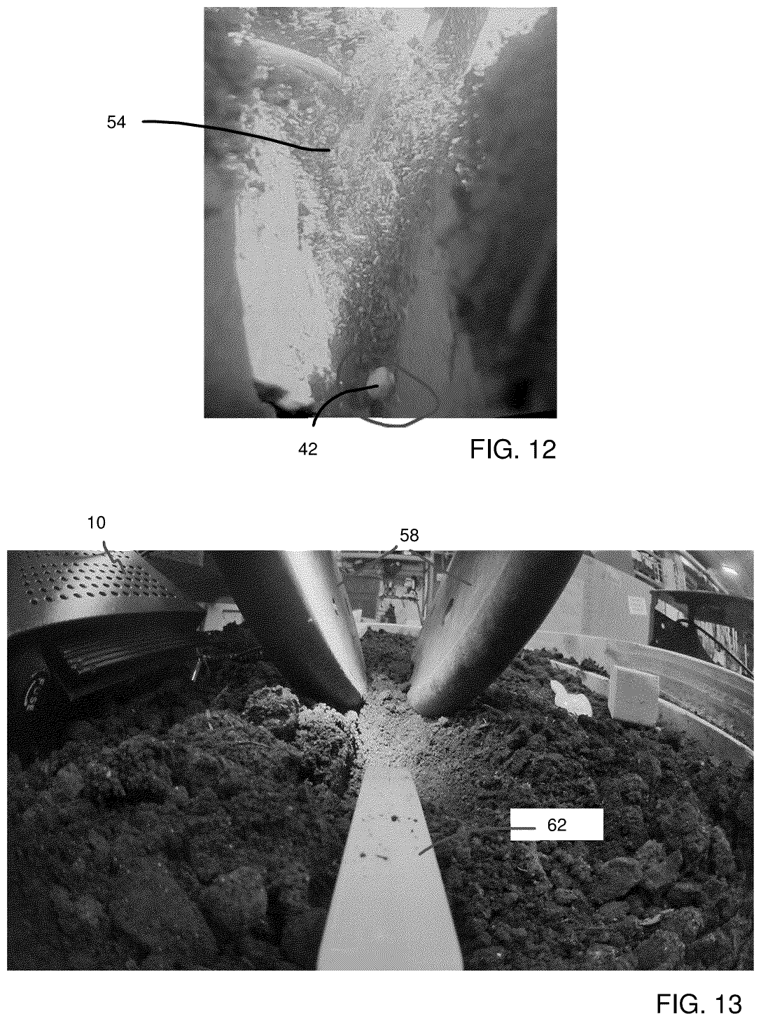

FIG. 12 shows an exemplary image of a seed 42 in a trench 44 that would be analyzed by the system 10 described herein. As would be understood, by the time the seed 42 comes into frame it is at rest in the bottom of the trench 44. If the seed 42 doesn't bounce (as it might do with a gravity tube style seed tube 45), then there is not as much opportunity for the seed 42 to change its position within the trench 44.

### Seed Firmer Performance

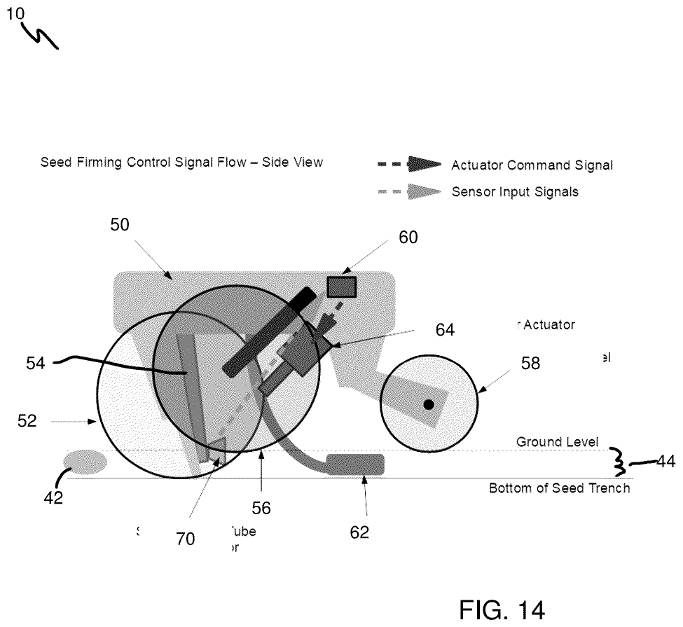

Operators may choose to use a seed firmer (shown at 62 in FIGS. 13 and 14) while planting. As the seed firmer 62 is in use, pressing the seeds 42 into the trench 44 may cause them to get stuck underneath the firmer 62 or dragged along with the firmer 62 as the row unit 50 traverses the field. This prevents proper placement and spacing of the seeds 42 within the trench 44 impacting the growth of crops. As the firmer 612 is moving along the bottom of the trench 44 there is also the potential for the firmer 62 to bounce as it strikes debris 48 within the trench 44 or have soil 45 stick to the firmer 62 and disturb the sidewalls of the trench 44.

FIG. 13 shows an exemplary view seen by a vision sensor 70 (optionally a camera 70) when a seed firmer 62 is installed on to the row unit 50. From this position the seed firmer 62 can be monitored for movement and the seeds 42 being pressed into the trench 44 by the firmer 62 would be visible before the trench 44 is closed by the closing wheels 58.

Continuing with FIG. 14, in various implementations, the seed firmer 62 may be modified to deploy or retract based on trench 44 and seed 42 placement quality. This could be done, optionally, by an actuator 64 that adjusts the amount of force on the seed firmer 62 to keep it pressed firmly to the bottom of the trench 44 or raise the firmer 62 up to remove reduce pressure. Various alternate designs for actuation of the seed firmer 62 are possible and would be understood in light of this disclosure.

In one example, if a seed firmer 62 is installed it may be deployed if the seed 42 is shown reaching the bottom of the seed trench 44. The seed firmer 62 may be retracted if the system 10 detects excessive soil sticking to a deployed seed firmer 62. Additionally or alternately, a system 10 applying supplemental force to the seed firmer 62 could be adjusted based on if the seed 42 is reaching the bottom of the seed trench 44.

### Closing Wheel

In various implementations, the position of the vision sensor 70 allows for a clear view of the closing wheels 58. This grants the ability to examine the behavior of the closing wheels 58, such as trench 44 alignment where the closing wheels 58 fail to close the trench 44 properly. This may occur from a wheel 58 being off center to the point it is riding in the trench 44 disturbing the trench 44 entirely and is caused by improper placement of the closing wheel 58, damage occurring while planting, or when the planter rides a too tight contour. As would be understood, the alignment and centering of the closing wheels 58 should be checked periodically to ensure the trench 44 is properly closed and that the closing wheels 58 maintain contact with the ground. This can be done while the planter is in motion or when the row unit 50 is raised and reported back to the operator.

Closing wheel 58 wobble and bounce may also occur from an improperly aligned wheel 58 and may optionally be analyzed by the system 10 to alert the operator if it impacts trench 44 closing. Additionally, soil can build up around the closing wheel 58 during operation preventing proper performance by causing a wheel 58 to wobble as the weight of the soil sticks to the wheel 58 unevenly or prevents it from turning entirely. The closing wheel 58 may throw soil and disturb seed 42 spacing; if this occurs, the operator should be alerted to prevent productivity loss.

Instances that prevent the closing of the trench 44 entirely can be identified and alerted to the operator for corrective action so that planting is not negatively impacted. For example, a plugged closing wheel 58, where residue caught in the closing wheel 58 prevents it from closing the trench 44 properly, or if a closing wheel 58 is missing entirely. Correctly operating closing wheels 58 close the trench and create a mound that runs directly above and in parallel to the trench 44. In various implementations, adjustment to the force, pitch, and spacing of the closing wheels 58 may be done automatically by the system 10 or by the operator.

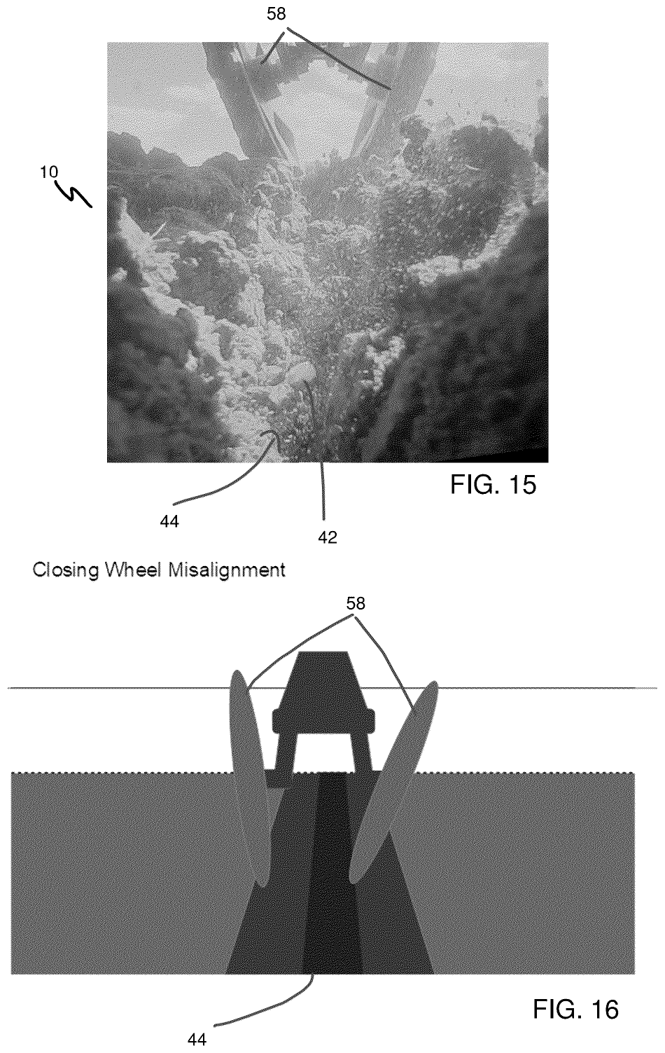

FIG. 15 shows an example of how the closing wheels 58 may be viewed by the system 10 while the planter is in operation. FIG. 16 shows an example of how the closing wheels 58 may be misaligned and fail to close the trench 44 properly.

### Gauge Wheel

In various implementations, information about the performance of the gauge wheels (shown at 56 in FIG. 14) may be presented on the display 14, such as identifying their presence and notifying the operator if they are missing. Additional sensors along with vision sensors 70 allow for measurements that can assess the quality of gauge wheel 56 operation. For example, revolutions per minute (RPM) may be collected to monitor spindown which is the amount of spin a gauge wheel 56 has when the planter row unit 50 is lifted off the ground. The gauge wheel 56 should spin for a short duration before coming to a stop when lifted. Wheels 56 that spin too freely or not at all may be an indicator of poor gauge wheel 56 alignment and may require adjustment.

RPM sensors may also be used to monitor the gauge wheels 56 while they are in contact with the soil. Gauge wheels 56 should rotate smoothly to ensure the proper planting depth but have the potential to become stuck and drag disrupting trench 44 formation. The system 10 may optionally use RPM, vision 70, and other sensors to see if plant residue is caught in the gauge wheel 56 preventing rotation and verify if the gauge wheel 56 is operating properly.

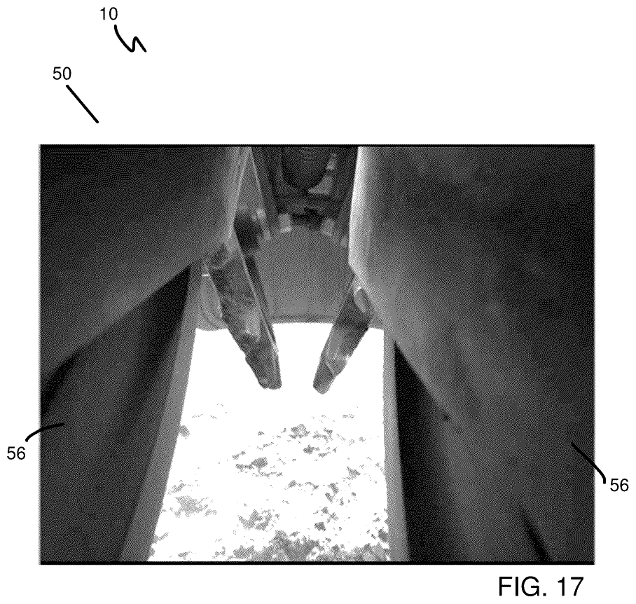

When gauge wheels 56 are spaced too far away from the opening disc 52, they can kick up a vertical plane of dry soil. Sometimes this is called a “rooster tail.” The system 10 can detect this and alert the operator to this planting error. FIG. 17 shows an exemplary image from a vision sensor 18 where the gauge wheels 56 are visible when row unit 50 is raised.

### Non-Seed Application

In certain implementations, during treatments to the trench 44, the vision sensor 70 may be used to detect accuracy and consistency. In the case of a pulsing application, the image sensor 70 may be triggered by each instance to record images that can then be processed by the system 10. Furthermore, during continuous application analysis the evenness of the spray may be seen and reported to the system 10 and optionally the operator. As would be understood, some seed 42 treatments are most effective when applied directly to the seed 42; others should only be applied on the soil between the seeds 42. The vision sensor 70 can be used to sense and adjust the timing of the treatment to ensure proper application.

### System Hardware

The camera/vision sensor 70 placement on the row unit 50 may differ depending on if a seed firmer 62 is in use. The position of the camera/vision sensor 70 is selected for the ability to see both within and outside the trench 44. For image capture, the angle that the vision sensor 70 is placed is adjustable and may be able to automatically adjust the angle from a monitor 14, depending on the view or depth setting. The precise location of the camera/vision sensor 70 may depend on the specific type, model, features of the vision sensor 70 (camera) and lighting.

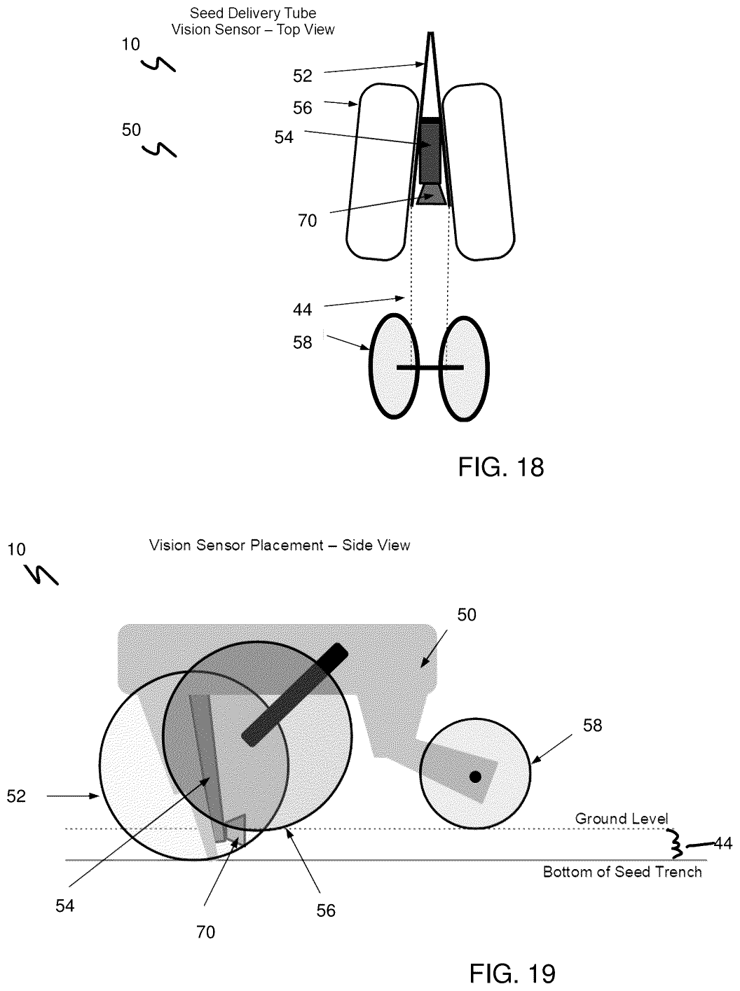

Further, it would be understood that the mounting location of these devices is selected so as to not impact planter performance and instead be adaptable depending on the configuration of the row unit 50. Additional techniques may be used to aid in image processing so that analyzing the environment inside and outside the trench 44 is done efficiently and accurately. FIGS. 18 and 19 show bottom and side views of an exemplary vision sensor 70 mounting on the row unit 50 for use as part of the system 10.

### Filters

As would be understood, light produces colors and shades is the visible light spectrum and appears as a ‘white’ light or combination of all the different wavelengths of visible light. This broad-spectrum lighting then strikes objects that are colored in different combinations of wavelengths. Wavelengths that are not present in the object are absorbed and neutralized while the wavelengths it does have are reflected out into the world making the object appear that specific color.

There are several different wavelength categories that corresponds to set colors:

| Color | Wavelength |
|---|---|
| Violet | 380-450 |
| Indigo | 420-440 |
| Blue | 450-495 |
| Green | 495-570 |
| Yellow | 570-590 |
| Orange | 590-620 |
| Red | 620-750 |
| Deep Red | 850+ |

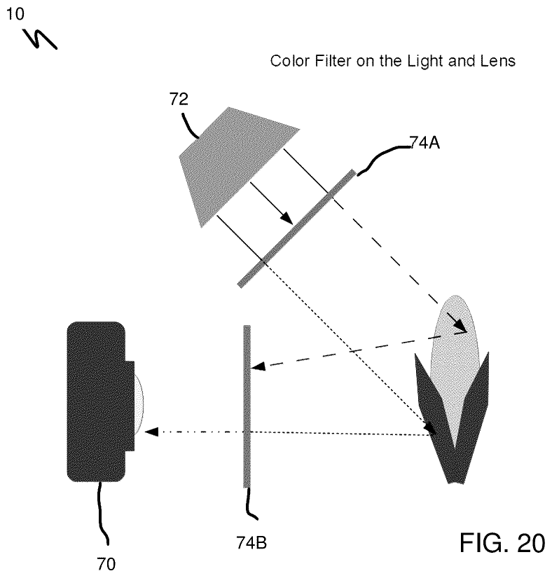

By using color filters (shown at 74, 74A, and 74B in FIS. 20-22) and colored light the system 10 can take advantage of this phenomena to filter images based on certain criteria. Color filters are commonly used in art applications, such as theater and machine vision, and are a transparent plastic or glass sheet that is tinted to allow certain wavelengths of light through to produce a colored light. In the system 10, a filter 74 can be placed in front of a light source 72, like an LED chip or light bulb, and transforms broad spectrum lighting into a narrow one, seen in FIG. 20. This can dim light as only certain wavelengths are allowed through the filter 74 depending on the spectrum.

In FIG. 20 the wavelengths of light that make up the beam produced by the supplemental light source 72 are shown by the solid lines. The light then penetrates a filter 74A that filters out certain wavelengths before striking the object. The light is then further filtered after passing through the final filter 74B in front of the camera 70.

The lines coming from the light source 72 represent the wavelengths of light. When they first come from the light source 72, they are unfiltered and appear as a unified broad-spectrum beam. After passing through the first filter 74A some of the wavelengths are refined to their individual wavelengths which then strike the object and reflect into the camera 70. As these individual wavelengths pass through the second filter 74B they are refined again to an even more specific spectrum of light.

In using supplemental 72 and ambient lighting, that is broad spectrum, the system 10 is able to achieve the necessary brightness for image quality. Uses of color filters 74 include placing a color filter 74 sheet over the camera 70 lens and/or using a filter 74 over a supplemental light source 72 to act as a focal point for the camera 70 to focus on and analyze. In various implementations, filtering of light can be done in a single spot or along the whole field of view with multiple light sources 72.

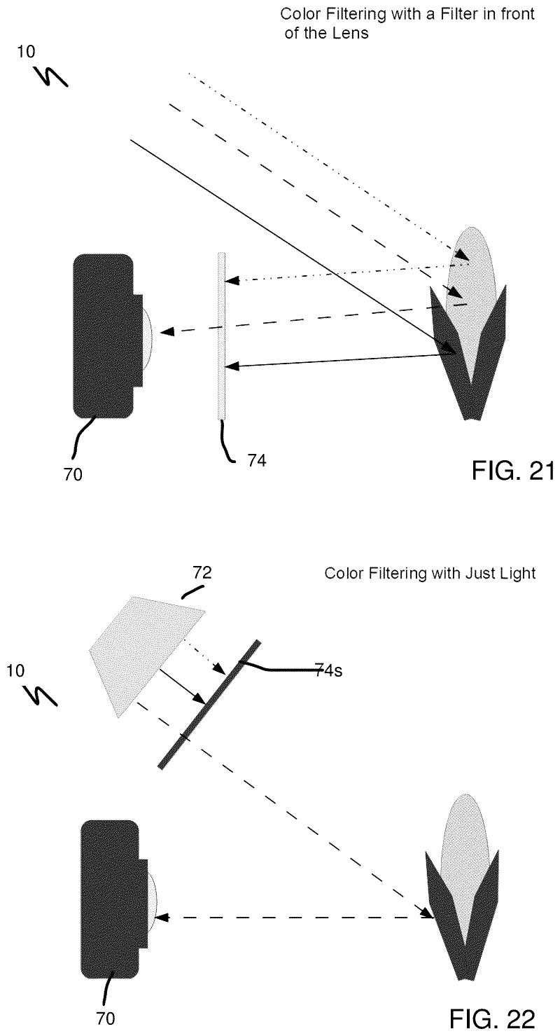

FIGS. 21 and 22 show various examples of filtering light in front of the vision sensor 70 and supplemental light source 72, respectively. In FIG. 21 the light is ambient light. In FIG. 22 the light is from a supplemental light source 72.

Filters 72 may be used in and outside the trench 44 to highlight specific traits. When focusing on in-trench applications filters 74 can be used to identify residue, the trench 44 profile, soil composition, and aid in filtering dust.

For example, soil and residue come in a variety of colors depending on the type. By using color filters 74 tuned to the color of residue 48 the system 10 is able to more easily detect the residue 48 as the color filter 74 will only allow the specific wavelength that the residue reflects through to the vision sensor 18. This allows the system 10 to sort residue 48 from soil 45, and different types of residues 48, from each other. Residue is shown for example in FIG. 5.

In one example, a color filter 74 is placed on the camera 70 lens to minimize the soil 45 appearance to make the residue 48 stand out in comparison. As would be appreciated, residue 48 typically dries into a yellow-tan color that can be matched to a filter 74 so that when the matching light reflects off it, here there will be a clearer distinction between residue 48 and the soil 45. Alternatively, the filter 74 may be placed on a supplemental light source 72 and/or a color filter 74 used on supplemental lighting 72. With the correct placement of the vision sensor 70 the ability to see the trench 44 profile will not be negatively impacted.

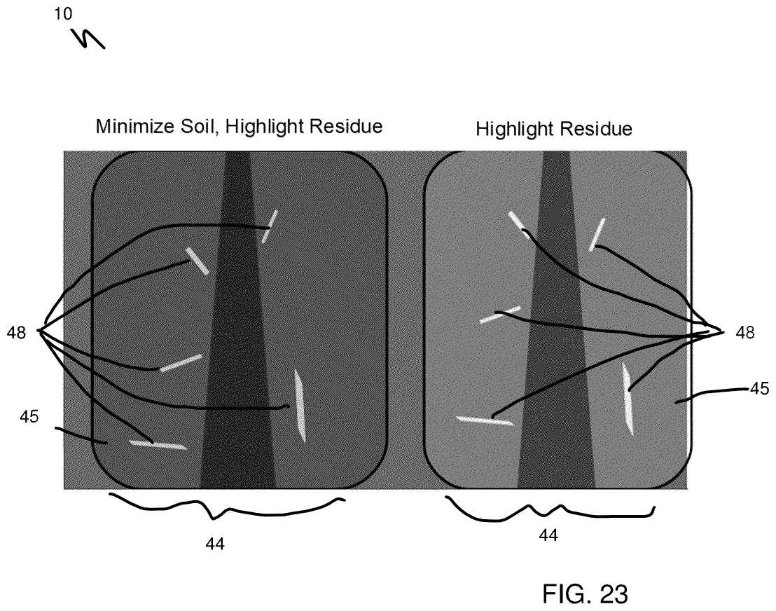

FIG. 23 shows an exemplary image highlighting residue 48 in a trench 44 through use of lighting filters 74. As can be seen there are two images that show how filtering the soil 45 in the trench 44 could be done to emphasize the appearance of residue 48. On the left side the soil 45 is filtered to appear darker than the residue 48 while on the right the residue 48 is filtered to appear brighter than the soil 45.

This same technique can also be used to better emphasize the trench 44 profile as adding a color filter 74 to the system 10, either by placing a color filter 74 on the camera 70 lens or on the supplemental lighting 72, can help the camera 70 filter out ambient lighting conditions that can affect trench 44 image quality. In conditions with a high amount of residue 48, filters tuned to the color and composition of the soil 45 can be used to highlight the image better while reducing debris 48. Using multiple lights 72 and filters 74 simultaneously may create focal points that the camera 70 and the system 10 can look at without disturbing the trench 44 formation process. Additionally, adding filters 74 can highlight specific characteristics of the soil 45 such as mineral deposits that will make it easier to identify changes in trench 44 structure. Adding filters 74 can also make the shadows of the soil 42 texture more definable, allowing a clearer image.

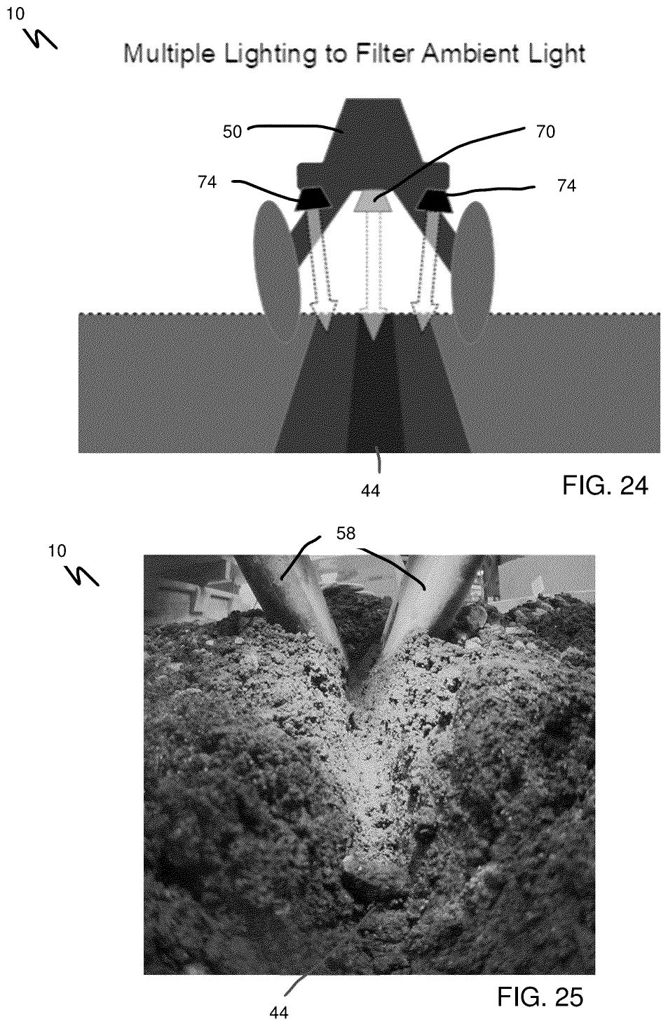

FIGS. 24 and 25 show an image of a row unit 50 having multiple lighting sources 74 and an exemplary image generated by the system 10. By using multiple-colored lights, the trench 44 profile can be enhanced, and a clear ‘V’ shape shown. Here the trench 44 depth is shown within the image without negatively impacting the clarity.

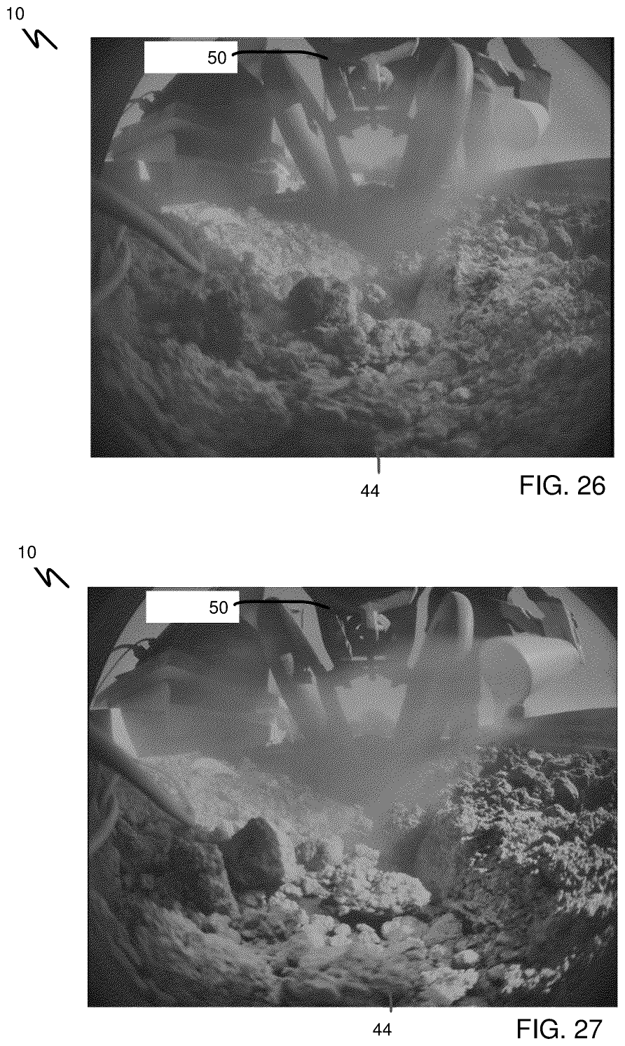

During dry conditions dust may fly up and obscure the camera 70 preventing a clear image for analysis to be taken. Certain longer light wavelengths near the infrared spectrum, such as amber, allow the light to penetrate through the dust and achieve a clearer image. Bright white lights are shorter, cooler wavelengths that can create a glare that blocks visibility, severely reducing image clarity. FIG. 26 shows an exemplary image using a warm light while FIG. 27 shows an exemplary image using a cool neutral light. As can be seen FIG. 26 is clearer than FIG. 27 as the dust particles reflected warmer light less than cool.

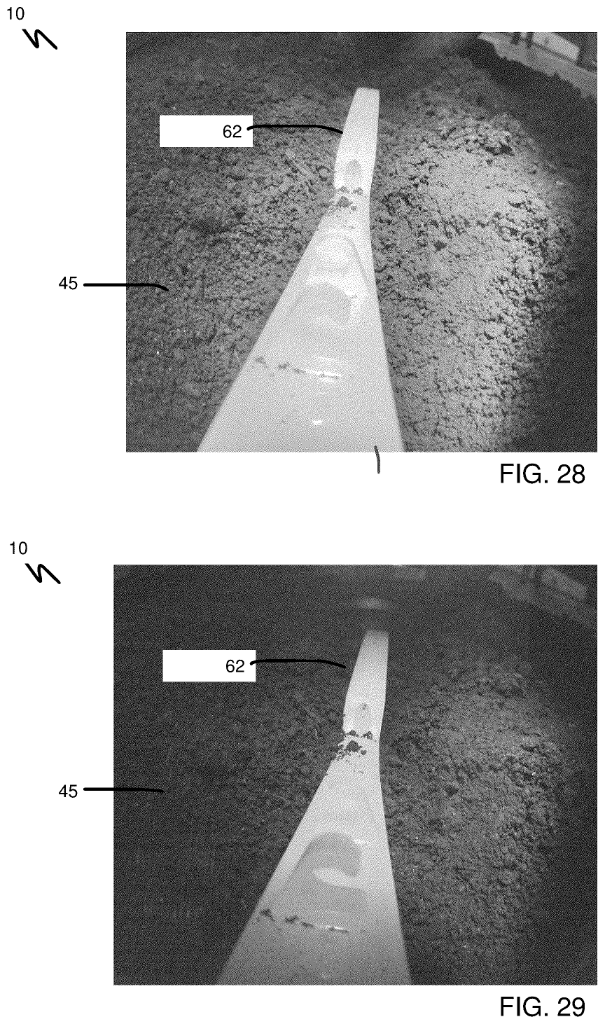

Non-colored filters 74 like polarizing and infrared (IR) filters 74 may also be used to cut through non-ideal lighting conditions. In using polarizing filters 74, reflections caused by dust or intense supplemental lighting 72 can be mitigated. IR cut edge filters 74 prevent image distortion from infrared lights from the sun and supplemental lighting 72. FIG. 28 shows an exemplary image without a polarizing filter 74 while FIG. 29 shows an exemplary image with a polarizing filter 74. The seed firmer 62, texture of the soil 45, and minerals present are all more defined when using a polarizing filter 74 than without.

### Vision Sensor

There are many types of vision sensors 70 (also referred to as a camera 70) that may be used to image the seed trench 44 and gather a wide variety of data. The cameras 70 used as part of the system 10 include, but are not limited to, those in the non-visible spectrum such as LiDAR, near infrared, and ultra-violet, and those that are in the visible spectrum which are primarily monochromatic and color cameras 70.

As would be appreciated, monochromatic cameras 70 capture images in a black and white scale and work best with colored filters 74 and lighting 72, as due to their nature, are sensitive to subtle changes in wavelengths that can allow clear filtering of unwanted features, while color or RGB cameras 70 capture images with the full color spectrum. Image characteristics that can be identified by color such as residue 48 and soil 45 moisture are more apparent with a color camera 70 and do not significantly impact the ability to use color filters 74.

An additional feature, in certain implementations, includes a camera 70 with a high-dynamic range. A high-dynamic range means that the camera 70 can form an image in extreme lighting conditions. A camera 70 without this feature may not be able to perform well in situations with direct sunlight as the vision sensor 70 cannot capture both the trench 44 and the area surrounding it causing distortion in the image.

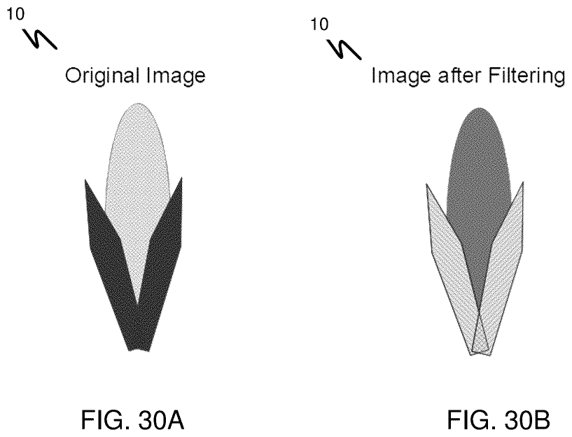

FIGS. 30A and 30B show how an object may be viewed by the vision sensor 18 after filtering and using a monochromatic camera 70. Before (FIG. 30A) the leaves were darker but after (FIG. 30B) adding a filter 74 that enhances the appearance the leaves are now brighter and the focus of the image.

The vision sensor 70 characteristics/attributes can be further broken down by the shutter used in image capturing. There are two types of camera 70 shutters, rolling and global. Rolling shutters expose parts of the vision sensor 70 at different times. During situations with rapid changes, such as a moving object or flashing lighting, a rolling shutter can cause distortion within the image as the pixels are capturing different moments of motion as they unfurl. Global shutters open all the pixels for image at the same time allowing the capture of an instant moment of time.

The lens and casing used for the vision sensor 70 ensures that the camera 70 can operate. The lens controls the focal length and the field of view. For use in the system 10 the focal length and lens should be selected to clearly display not only the trench 44 profile but allow views of the closing wheels 58 and gauge wheels 56 when the planter is lifted. This allows a full view of the planting process to be captured without distorting the image from having too wide of a field of vision. In various implementations, an IP67 rated camera 70 casing is used which makes the vision sensor 70 capable of operating in outdoor environments full of dust, dirt, water, and flying debris that could otherwise damage the camera 70. In the case of needing to image the trench 44 at unfavorable angles a camera 70 lens that refracts the image into the vision sensor 70, such as a right-angle spy lens, may be used to achieve this result.

How often images are collected by the camera 70 may be set by the operator or by the system 10 and not run continuously. This can be done by adjusting the camera 70 settings to trigger a photo or short video to be taken after an event occurs. For example, an image or video may only be taken after specified a linear distance has been travelled, such as every 5 feet. Optionally, these images/videos may be strung together in sections to be assessed as a group for image processing, such as 50 ft block sections. Various other sectioning is possible at different linear distances, times, and the like. Other examples can include using a time-of-flight sensor to take images after a set time has passed or making the number of pictures taken based on how fast the planter is moving. Adjustments to the frames per second for video recordings may be changed to reflect the number of images taken to best monitor trench 44 formation.

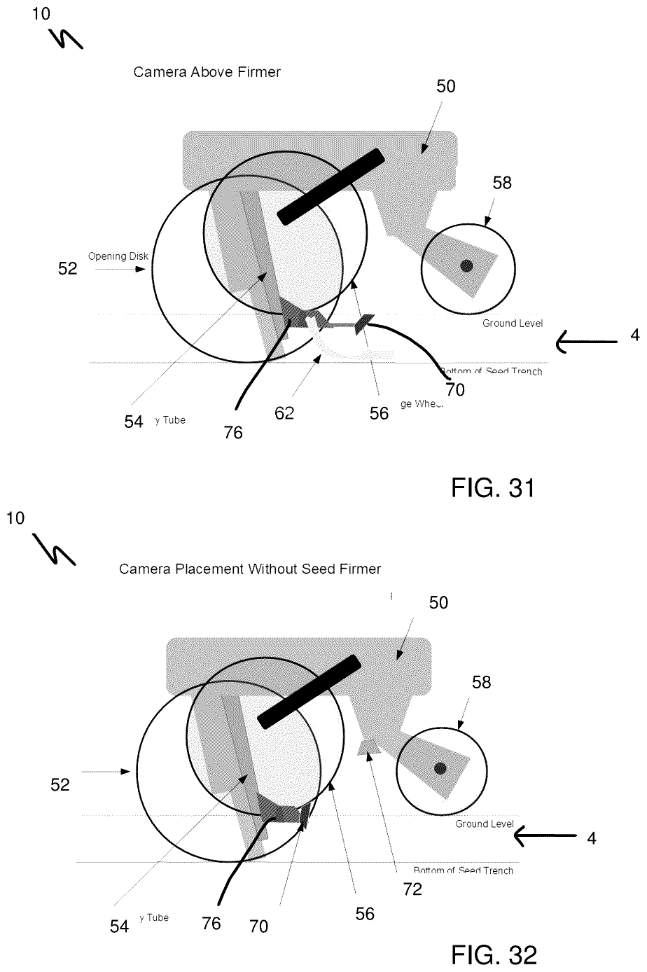

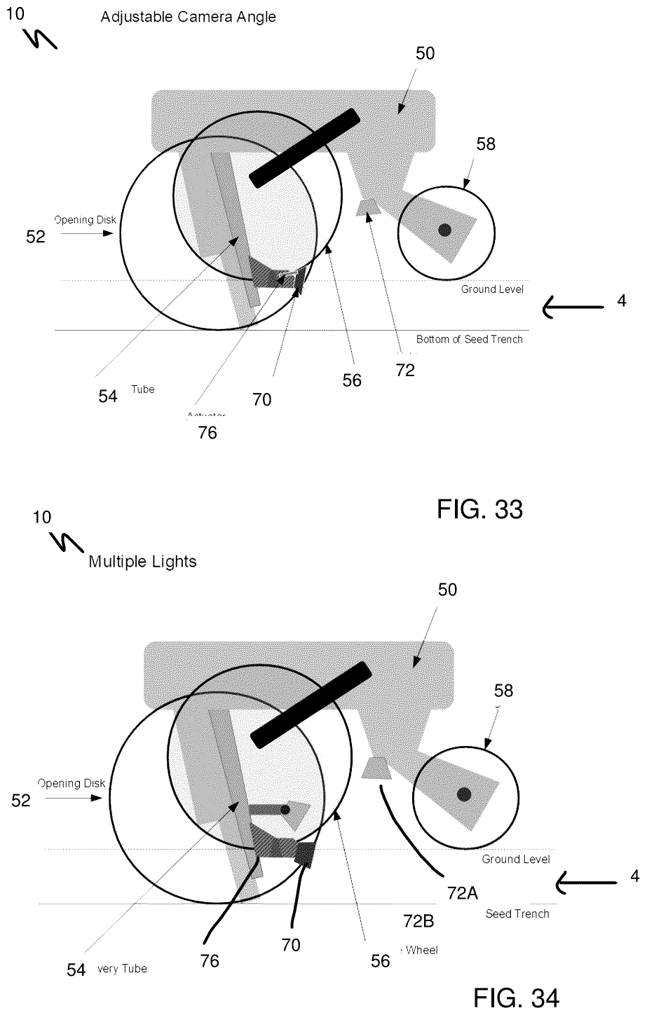

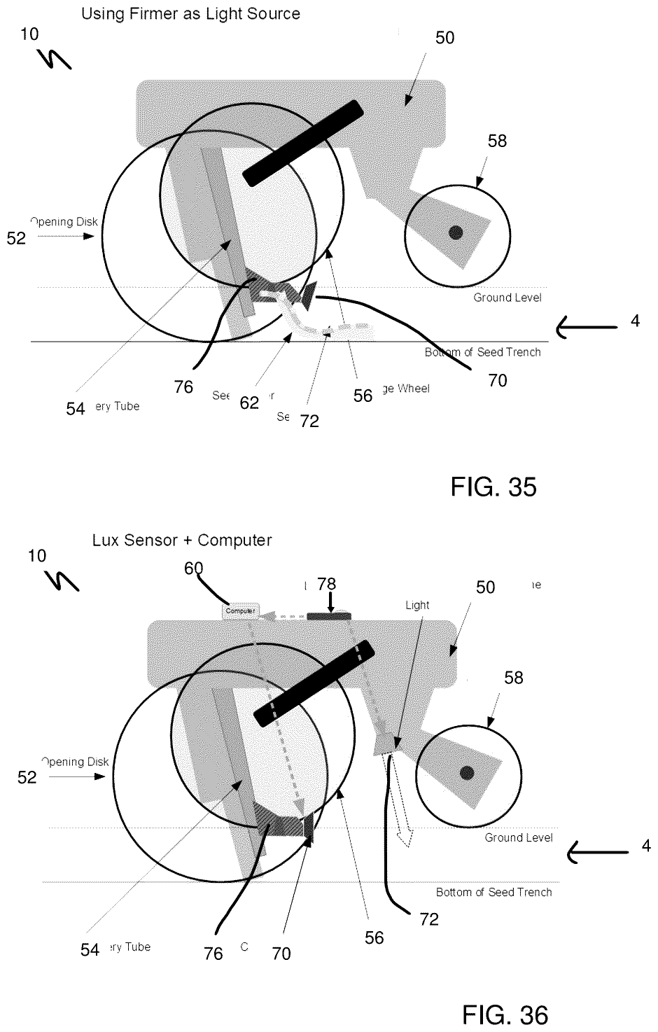

FIGS. 31 and 32 show examples of how the camera 70 for the system 10 may be installed on a row unit 50 depending on if the operator is utilizing a seed firmer 62 or not. FIG. 33 shows camera 70 placement with the addition of an optional actuator 76 that can adjust the angle of the camera 70 for the optimal view of the trench 44.

The placement of the vision sensor 70 may be determined by the location able to achieve the clearest and most accurate depiction of the seed trench 44 with and without a seed firmer 62. This may include, but is not limited to, integrating the camera 70 with the frame of the row unit 50, seed tube 54, seed firmer 62, or by using multiple and different cameras 70 and/or types of cameras 70 in various locations.

### Supplemental Lighting

There are many different types of lights 72 that can be used in a variety of applications to emphasize desirable features. In various implementations, the system 10 includes a spot 72A and a bar light 72B, shown for example in FIG. 34. A spotlight 72A creates a clear, round focus point that lights up the surrounding area while a bar light 72B acts like a line drawn across the trench giving a clear V shape focus point.

Various implementations may also include lasers that can be used to project lines or other designs on the trench 44 to show the various characteristics of a trench 44, as will be discussed further herein.

In various further implementations, the shape of the light beam can be changed with the use of different lenses. For example, taking a flood LED light chip and adding a lens that changes it into an elliptical beam. The ability to adjust the lens allows for better supplemental lighting depending on operator and/or system 10 requirements/needs.

Within the different types of lights 72 there are also different illumination methods such as continual and strobing. Continual lighting is a constant light that is unaltered during its time on. A strobing light operates by flashing rapidly, even faster than human eye detection, to create the look of a continuous beam of light. These lights can appear more intensely than continuous light as the light can flash at max luminosity before turning off to cool then flashing at maximum intensity. Strobing may be done by adding additional sensors that turn on light source when a specific event occurs, like a seed being placed or the speed of the planter.

Strobe lighting has the benefit of a lower cost of operation due to it only using bursts of electricity for light it does not consume as much power and heat as a continuous light while maintaining the same light intensity. This extends the life of LED light sources, reducing maintenance required on the lights and cost. In some implementations, the system 10 may use a strobing light in conjunction with a structured light filter to create the effect of a laser projection. In various implementations, a machine learning model may be used to quantify the image to be reported to the operator.

Alternatively, shadows may be used as structured light instead of adding supplemental light sources 72. This method takes advantage of the intensity of ambient lighting so that instead of increasing the power needed for a supplemental light source 72 to overpower ambient condition, a shadow can be used to block out a strip of light projected onto the trench. This shadow then acts as the structured light allowing for a clearly defined ‘V’ shape to take form.

Prisms may be used by both supplemental light 72 and ambient light to project different color lights onto the trench 44. A prism can achieve intense color payoff with lower powered supplemental lighting 72 since it is not defined by a wavelength frequency of light set by a filter 74. Should supplemental lights 72 fail to achieve the necessary brightness then ambient light can be harnessed to create colored projections.

Supplemental lighting 72 placement may be selected as a place that highlights the trench 44 profile while limiting the glare back onto the camera 18 lens. For these reasons, the lights 32 may be positioned behind the camera 70 to highlight the trench 44 profile and above the closing wheels 58 to achieve continual visibility during trench 44 formation, although other placements are possible. These placements also consider ambient lighting conditions that might obstruct visibility within the trench 44 and encourage consistency in lighting so that images are unaffected by ambient lighting.

Multiple lights 72 may be used to form shapes that allow for various views of the trench 44 profile. A line of LEDs, for example, can be positioned individually to highlight the cross-section of the trench 44. The definition can be created with a unique color, multiple colors, or different light intensities from additional light sources 72. FIG. 34 is a side view of a row unit 50 having multiple lights 72 to highlight the seed trench 44.

In some implementations, the seed firmer 62 may be modified to be a source of illumination due to the placement within the trench 44 allowing for direct lighting of the trench 44 sidewalls. This optionally aids analysis of the sidewall in cases of peeling and collapse through clear images. Further, the clear images may be a focus point for image analysis and other machine learning purposes. An example is shown in FIG. 36, where supplemental lighting sources 72 are placed along the length of the seed firmer 62.

Additionally, in some implementations the system 10 and devices may adjust supplemental light 72 intensity and position based on the ambient lighting conditions to maintain image quality. These and other implementations of the system 10 may work by adjusting the camera 70 settings to prevent poor quality images.

FIG. 36 shows an example of a lux sensor 78 being used by the system 10 to adjust supplemental lighting 72 based on ambient light conditions. In these and other implementation, the lux sensor 78 is placed on the row unit 50, optionally on the top of the row unit 50, to sense ambient lighting conditions. The lux sensor 78 is in communication with a computer 60/processor 60 to interpret the sensed lighting conditions and command actions to the camera 70 and supplemental lighting sources 72. The data from the lux sensor 78 may also be used by the system 10 to aid in image processing and other operations, as would be appreciated.

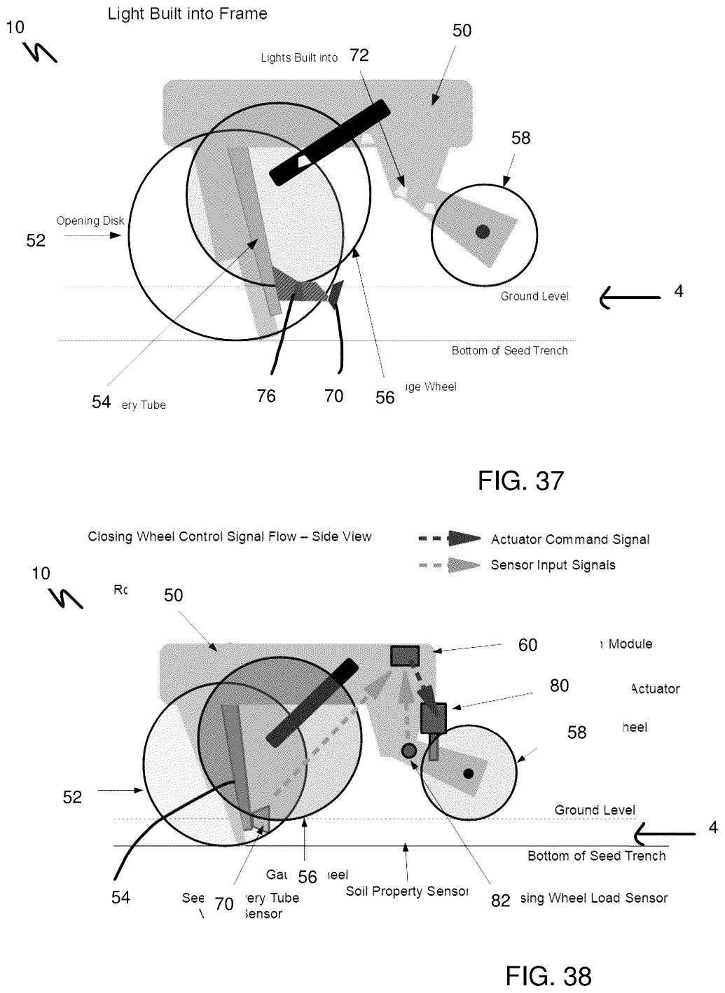

In certain further implementations, supplemental lights 72 may be placed along/into the frame of the row unit 50 and/or seed tube 54 to achieve a desired the amount of illumination of the trench 44, shown for example in FIG. 37. Lights 72 may be placed at various locations while maintaining the function of the row unit 50. Wires, heat sinks, and other additional equipment can be run through the row unit 50 preventing them from impeding planting or getting caught during operation.

### Additional Sensors

The system 10 may gather information from many sources that can then be used to aid in image analysis. Data from additional sensors added to the system 10 or from a various additional devices, such as a yield monitor, can provide various context to images to optionally teach a machine learning model. This data can be combined to form a complete story of the planting process to be shown to operators. An example could be an air quality sensor to detect the amount of dust present in the seed trench 44. Optionally, this data may not be presented in the overview display 14 for immediate viewing of the operator but in a separate section of the monitor 14. This information could be quantified as a percentage of the image or video obscured, or measurement of the number of airborne particulates through an air quality sensor.

In various implementations, the monitoring of downforce may be tied in with another piece of equipment, such as Ag Leader® SureForce®. In these and other implementations, the system 10 may have the ability to control that equipment without the need for operator input. In the example of downforce, the camera 70 may see that the trench 44 is collapsing. The system 10 then informs the operations system 2 to increase the amount of downforce to provide more compaction and properly form the trench 44 sidewalls. The system 10 can also report its findings and recommendations to the operator so that the operator can make adjustments.

In certain soil types with high moisture content, smearing and peeling can occur even when applying minimal force on the gauge wheels 56. When this occurs, the system 10 may reduce applied downforce until a minimal gauge wheel 56 load limit is reached. If the smearing or peeling condition persists after this time the operator could be notified. They could choose to cease planting until soil moisture decreased or continue planting with the knowledge that plant emergence or yield may be negatively affected.

In certain soil types with low moisture content, collapsing can occur even when applying significant force on the gauge wheels 56. When this occurs, the system 10 may increase the applied downforce until a maximum gauge wheel 56 load limit is reached. If the collapsing condition persists after this time the operator could be notified. They could choose to cease planting until soil moisture increased or continue planting with the knowledge that plant emergence or yield may be negatively affected.

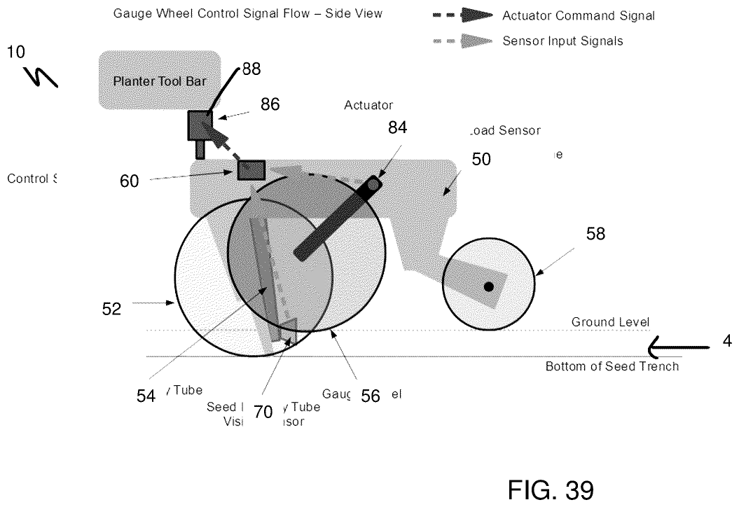

FIGS. 38 and 39 show how downforce can be adjusted based on feedback from images gathered by the camera 18. For example, as shown in FIG. 38, the closing wheel 58 may be adjusted via an actuator 80. The row unit 50 may include a closing wheel load sensor 82 to sense closing wheel 58 load. Similarly, as shown in FIG. 39, the system 10 may adjust the gauge wheels 56 via a gauge wheel actuator 86 and include a gauge wheel load sensor 84 to sense gauge wheel 56 load.

When using georeferenced data, like in Ag Leader® AgFiniti®, the system 10 may ensure that the GPS identification aligns with other devices and systems in use with a planter. That is, images of the trench 44 are assigned to the correct location in the field and can be compared with another device without needing to account for distortion. When the operator or farmer or system 10 is reviewing trench 44 formation, the various systems can then compare historical data of the field's history, like where low spots are, to how planting was affected. This also allows the system 10 to show the trench 44 quality across planting seasons or across different fields. Yield monitoring devices, like Ag Leader® Yield Monitor, can also be used to see how poor planting affects harvest yield and identify areas that an operator or farmer can improve within their field to improve.

Proximity sensors 88 may be added to parts of the row unit 50 that can be moved electronically to notify the operator when these areas are raised or lowered. When used in conjunction with the system 10, and optional machine learning model, the system 10 can use the sensors to know where a row unit 80 is located for calibration purposes. For example, when a row unit 50 is raised the gauge wheels 56 can be seen by the camera 70. When the row unit 50 is fully raised, as indicated by a proximity 88 sensor or position sensor 88 located on the actuator 86, or other location, then the system 10 can use this as a point of reference to take measurements of the gauge wheels 56 and calculate their alignment to make sure that they are still operating correctly. This can then be reported back to the operator should there be a problem so that they can adjust or alternatively be adjusted automatically by the system 10 and other interrelated planter systems and devices.

Light sensors 78 may be added to automatically adjust supplemental lighting 72 when ambient lighting conditions change, discussed above. This can be done with lux sensors 78 on the row unit 50 and near the trench 44. These readings can be reported to the operator in the form of Lux or Lumens, as desired, but optionally may not appear for immediate viewing. These sensors 78 may also take readings for the wavelength of light produced by supplemental light sources 72 and the temperature of the light. An additional sensor may be added to track the heat produced by these light sources 72.

### Data

The machine learning model may analyze the images to extract the data present. The system 10 has access to the view inside the trench 44 where planting occurs but also the area outside the trench 44 such as the gauge wheels 56 and closing wheels 58. To understand what happens in these domains there may be one or more machine learning models operating simultaneously to garner information that can be presented to the operator or farmer. In one implementation, the system 10 may include a master model that encompasses each point of interest. Alternatively, more specialized models that can focus on specific details of the trench 44 and the area surrounding it may be used.

By using different models, the system 10 can identify not only the desired features but also modify the image to focus on certain criteria such as cropping the image before classification to focus on the object of interest to improve accuracy. This may allow for more effective processing due to a smaller image taking less time to analyze. For example, position sensors 88 that indicate if the implement is raised or lowered could be used to shift the machine learning model from a trench 44 classification mode to a closing wheel 58 and/or gauge wheel 56 presence detection mode and crop the image.

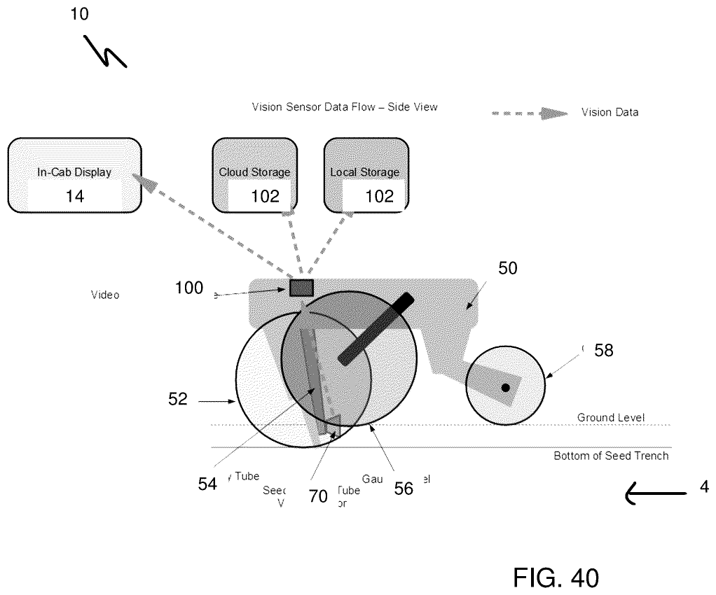

FIG. 40 shows how the machine learning system may work in taking images and processing them to extract data for the operator to view. That is, the system 10 may include a display 14, local and/or cloud based storage 102 to store images. The system 10 may further include a central processor 100 for processing images and executing a machine learning model for analyzing images and output the desired/selected outputs such as trench 44 quality scoring and the like as is discussed herein.

Within the models for in-trench and out-of-trench environments each model can be further specialized depending on how the machine learning model factors in external conditions while planting. In various implementations, the machine learning model may have subcategories that are tuned to the current state of the soil 45, weather, time of day, etc. For example, the system 10 may include one model for assessing/analyzing trench 44 quality in sunny conditions and a different model for wet soil environments. The planting condition data can be input by farmers or a third-party soil assessment into the model and/or otherwise obtained by the system 10 so the best algorithm can be selected for the conditions. Additional details regarding the planting depth, ride quality or amount of image bounce via a visual inspection, and other measurements may be used to create a complete picture of the planting process.

In the case of using multiple algorithms for different planting environments the machine learning model may switch between versions automatically or be manually selected by the operator. In a single model for inside or out of the trench 444, the model uses all the data collected during training and input by the operator to analyze images that can be sorted into categories. Both methods are carefully tuned to ensure that no matter what model is chosen for use in the system 10, the accuracy and efficiency of image processing will not be negatively impacted.

Additional sensors such as, but not limited to, those for reading soil moisture, light intensity, temperature, downforce, and humidity may be used along with the vision sensor 70 to collect data for training purposes and as supplemental data for the machine learning model to analyze. This allows for complete data collection that can be viewed and understood by those skilled in the art. For example, in the case of downforce, the model may automatically adjust the force applied on the row units 50 based on feedback provided from analyzing the images gathered. The machine learning model can also show this data to the operator and recommend adjustments to ensure that the row units 50 remain in the correct position for planting.

In various implementations, the machine learning model works by analyzing a whole image, along with any additional data, to find details that will determine the category and rating the image. Additional data can be described as information from other sensors present within the system 10 (i.e., a lux sensor 78), additional sensors on the row unit 50 (such as those for downforce gauge wheel load sensor 84 and/or closing wheel load sensor 82), or data input from outside sources (like geospatial location, GPS unit 15). In various implementations, each image is inspected before being organized into a report of the condition of inside or outside the trench 44.

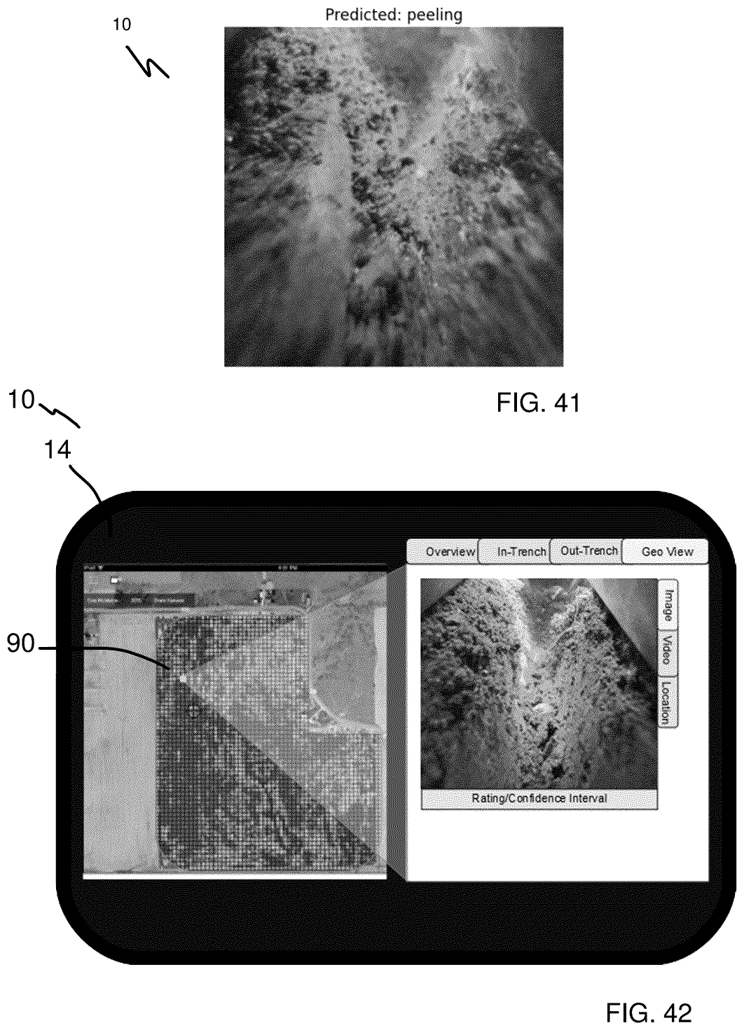

In implementations, where each image or video burst is rated individually to determine the classification the machine learning model looks for the desired traits of a properly formed trench 44. In this case, a single image can be inspected to determine the quality of the trench 44 by specifically indicating parts of the trench 44 inflicted with an undesirable trait. For example, what percentage, if any, of the trench 44 is covered by residue 48. Further information may be presented like the percent confidence within an image where parts of the trench 44 may be assessed to be collapsed but the dominant trait is that the trench 44 is experiencing peeling. The machine learning model may provide a breakdown of the trench 44 rating, for instance, 40% of the trench 44 is collapsing and 60% is peeling, for a final classification that the trench 44 is peeling. This demonstration of confidence may allow the operator to see how the program works and optionally increase the trust they have in the system 10. FIG. 41 shows an exemplary image where the a machine learning model within the system 10 has analyzed the images where the model ‘rates’ the likelihood that the trench 44 is experiencing certain conditions, here peeling.

In certain implementations, overall performance of the planter trench 44 status is calculated and compared over a unit of measurement. For example, the quality of the profile of the trench 44 could be rated over a linear distance, such as feet, to determine the final classification. For example, where over the course of the last ten feet 80% of the images taken within the trench 44 has been rated as good, the feedback provided to the operator is “good trench”. The trench 44 status may be communicated in a variety of manners including a pop-up message, a color indicator, a sound que, or any other notification method, as would be understood. Additionally or alternatively, the trench 44 status/planter status can be reported over time. For example, when for the last thirty seconds the closing wheels 58 are reported present on the row unit 50 and operating correctly, the feedback may be provided to an operator that the row unit 50 is functioning well.

In some implementations, the number of instances for various operating conditions or events may be collected until a threshold is reached before notifying the operator. In this situation the machine learning model is quantifying how many times an event happens over the course of a unit of measurement. For example, if the model does not detect fifty instances of high residue conditions within a single pass, then the operator would not be notified of any faults, but if high residue conditions are found more than fifty times on a pass the operator would be notified of that condition. Alternatively, if a condition or event exceeds the determined threshold, the system 10 may automatically take corrective action, such as engaging row cleaners, increasing/decreasing supplemental downforce, deploying/retracting a firmer, and the like.

If the trench 44 formation by one row unit 50 of the planter does not coincide with the performance of other row units 50 during the planting process an alert may be given to notify the operator. While planting conditions can change across a field, differences across rows may indicate problems within the field or with one or more row units 50. Should the field have a variety of environments, this data can be collected and processed to be reported to the operator. This information may be beneficial to those skilled in the art to remain informed of all the details regarding their land.

In various implementations, once the machine learning model performs analysis on the images gathered by the vision sensor 70 the details may be processed before presenting the analysis/findings to the farmer or operator. In certain implementations, the machine learning model is both determining trench 44 quality (if the trench is ‘good’) and also monitoring the overall performance of the row unit 50. In certain implementations, the information may be better understood through averaging the trench 44 quality over a course of time, linear distance, number of images taken, or other unit that can group the information gathered chronologically. In further implementations, individual images or groups of images may be viewed and analyzed.

To present all the data collected on trench 44 quality, such as seed placement, closing wheels 58, etc. in its raw form can be overwhelming and incomprehensible to the operator. The information may be made accessible, such as in a detailed report and image playback, and also in a general overview so that the operator can quickly assess what is happening during planting and make corrections as needed.

Condensing this data may optionally include averaging multiple images within a single row, and/or the behavior of trench 44 formation across all the row units 50 where the system 10 is active. An example would be a graphic that changes color depending on the overall performance of the trench 44 profile or an icon that changes depending if the model senses if all the gauge wheels 56 are present or not on the row unit 50. Other data from additional sensors may be simplified and presented on the graphic, such as in downforce which may be a provided value. Values like this may not require picture representation and may be shown as the provided number.

The goal of visualizing trench 44 quality and planter health is to demonstrate that the row units 50 are operating correctly. The presentation may focus on when an event occurs and not why it is happening. This can be done by simplifying the whole row unit 50 into categories like ‘overview,’ ‘in the trench,’ and ‘outside the trench.’ These categories can then be expanded on, if desired, to show video or image replay of trench formation either at individual locations or across different rows.

A display 14 view of the data may be available to be viewed on a georeferenced (e.g. GPS) map for the operator to play back as needed. Numerical information may also be available in the same way, for example, the operator could see that there is a lot of residue 48 in the trenches 44 from the overview graphic, bring up the rows that are being affected, view the video playback of the planter going through those locations, and see the analyzed percentage of the amount and size of ground coverage. This method can be applied to all the conditions and events detectable by the system 10 and displayed on a monitor 14 such as Ag Leader® InCommand® or AgFiniti®.

FIG. 42 is an example of a display 14 for the system 10 that has different tabs to categorize views that an operator may want to see. In this example, the display 14 includes tabs for the different views that the system 10 obtains (overview, in-trench, out-trench, and geo-view) and shows the corresponding image, video, and/or data within the window. In example, the display 14 also includes a georeferenced map 90 within the window or in a separate window, where the area of interest may be selected to recall the desired images/videos/data.

The video and image feed provided by the vision sensor 70 may recall the visuals in a variety of ways to best suit the conditions being viewed and the preference of the operator. For example, a video feed may be observed and broken down into freeze frame images or played back at a reduced speed that can be individually analyzed for accuracy of data. The display 14 may be able to recall and play video or images based on an area or point selected on a geospatial (e.g. GPS) map 90. This video may be synchronized with the numerical trench 44 parameters for identification within the field. To ensure that the image sensor 70 is properly set to view the area inside and surrounding the trench 44 the camera 70 and light angles may be displayed on the monitor 14 and adjusted.

In various further implementations, the data/planting process may be viewed in augmented reality where the video feed or images can be modified to fit the format for full application. By using a combination of lighting, visual, and other data collected by additional sensors a full reconstruction of the trench 44 can be done.

Information can be gathered on external conditions that may affect the quality of the image captured by the vision sensor 70 such as the amount of dust present. This may be quantified as a percentage of the image or video obscured, a measurement of the number of airborne particulates through an air quality sensor, or by another method that can report the data to the operator. When planting in overly wet conditions mud may collect on the lens of the camera 70 preventing image capturing. This may be used as a diagnostic tool that planting in these conditions is unadvisable. Should an operator wish to continue planting, the lens can be cleaned as needed or the position adjusted to minimize dirt build up on the lens.

The camera 70 may encounter images that cannot be classified because the image quality is poor due to environmental conditions. In these cases, the system 10 may display and record such instances as “poor image quality,” or another equivalent term, and state “low confidence” in the annotation category. “Low confidence” may be a numerical rating for the machine learning model and the strictness of the algorithm is determined by a threshold the operator sets or is otherwise determined by the system 10. If an image scores below this threshold, then the classification may be deemed unreliable. The system 10 may determine when these unreliable classifications occur by analyzing the sharpness, contrast, and pixel changes between images. The machine learning model may optionally ignore individual poor images so as to not negatively impact image analysis and/or machine learning. The system 10 may report the findings to the operator if a problem needs to be remedied. Further, in some implementations the machine learning model may be trained on poor quality images to indicate why the image is poor, such as declaring an image “dusty” when dust obscures the image or sticks to the lens.

Camera 70 health may be accessible through the display 14 to inform the operator when the vision sensor 70 requires maintenance. Minor issues could include dust on the lens that slightly obscures images. However, major problems can occur, for example, if the camera 70 lens is completely blocked by dirt. Should the vision sensor 70 fail to take images, an immediate alert can be sent to the operator. Instances may include damage to the camera 70 that affects the image clarity that cannot be remedied by adjusting visual settings or be fixed from the in-cab display 14.

Adjustments made to supplemental lighting 72 and camera 70 settings may be based on planting speed or triggered by events such as a seed passage that can reduce power needs. Lux sensors 78 may be used to adjust supplemental light 72 intensity based on ambient lighting conditions to have consistent images for analysis. Camera 70 settings can be tuned for maximum image quality depending on lighting conditions to prevent distortion caused by glare, light flare, ghosting, or light refracting inside of the lens. These features may be adjusted through the display 14 by the operator as needed.

Data on the display may contain measurements regarding the condition of the lighting instruments for the vision sensor 70. For a simple overview, an icon may be used to represent if the lights on all the row units are on or off and, should one go out, the operator could be notified by changing the icon's color. Additional information that could be shown alongside would be the intensity of the ambient lighting conditions so that the supplemental lights can be adjusted if needed.

Further details regarding the wavelength of light used in the presence of filters 74, supplemental lights 72, or ambient light may be available in addition to the temperature of light use. This information may optionally be available upon request of the operator and would allow operators to adjust these traits to suit the planting conditions. Data on current drawn, heat produced by lighting, and the operating condition of the lights may be added to the display or be easily accessible for diagnostic and programing purposes.

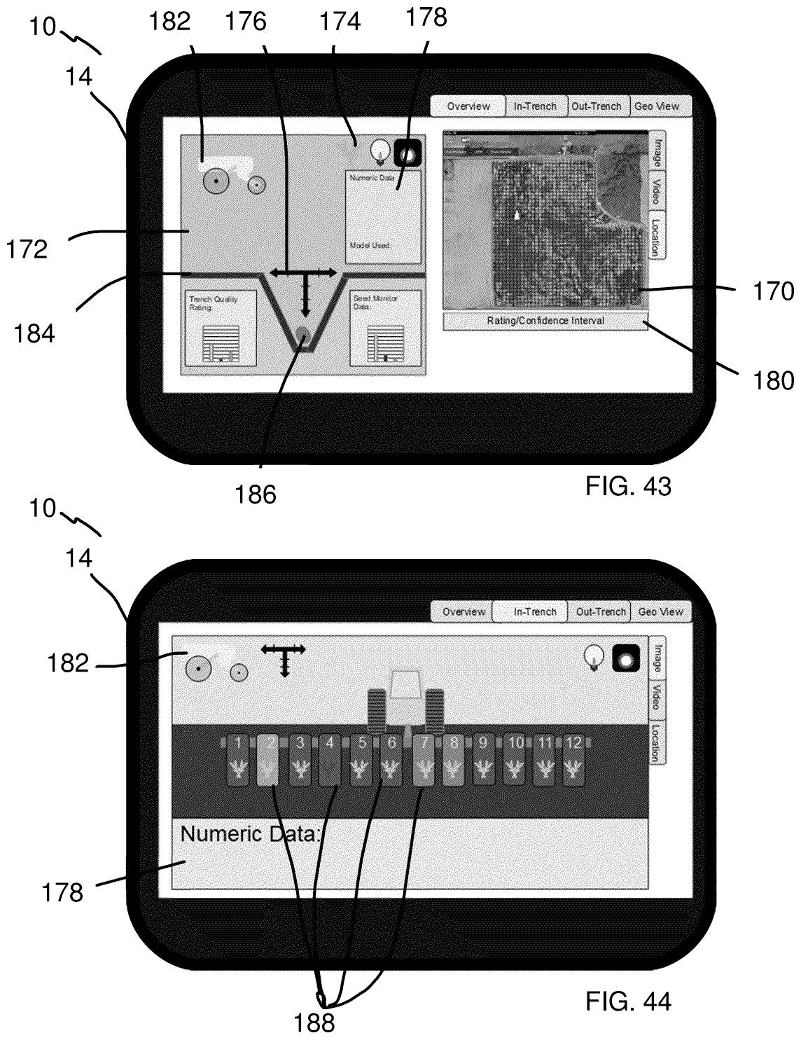

A ‘well-defined’ or ‘good’ trench 44 may be quantified in many ways and the display should reflect those factors. At a glance, the operator should be able to view information regarding the trench 44 profile, debris 48 content, planting depth, and trench width. This data can be shown as a picture diagram (show for example at 172 in FIG. 43). The diagram 172 may also reflect if a seed firmer 62 is being used as this may change the angle the images are gathered at. An example could be, a ‘V’ shaped profile that uses color to indicate the condition of the side walls, such as if they are collapsing, with an icon 174 that flashes when there is too much residue within the trench 44, and a ruler 176 in the shape of a crosshair to show the width and depth of the trench 44. This combination of both graphics 172 and numbers 178 may create an easily understood visual overview of the trench 44 quality.

Additional information on whether a trench 44 is well-formed or not may include icons 174 that change depending on the amount of residue 48 or debris 48 present and can be combined with other sensors, like a seed monitor, to also reflect seed placement within the trench 44. In the case of using a seed monitor the information present on it such as skips and doubles could be added as numeric data 178, a bar graph, or the like. This can be adapted to the needs and requirements of the operator.

Should there be a row unit 50 or devices thereon not performing similarly to others within a pass or across a field, an alert may be sent to the operator. In this situation a graphical view of the field to reference the position could be shown (such as a georeferenced map 90) and interacted with to play back the images captured. In the case that images are being processed as an average unit, such as linear distance, the data provided may indicate that a location be a generalized point like a dot on a map to represent a 50 ft section of the row.

FIG. 43 is an example of what an ‘overview’ of trench 44 conditions could look like on the display. On the right side of the screen the ‘location’ tab is selected and slightly changes color to indicate which tab is being viewed. The planter's location can then be seen on the screen via a map 90 during operation, as would be generally understood. At the bottom of the visual area there is a spot for ‘rating/confidence interval’ 180 which may be used to show the model's confidence in classifying the images and graphic or display the GPS coordinates of the planter in the field. Various additional orientations and placements for data within the display 14 are possible and would be recognized by those of skill in the art.

In this example, on the left side of the screen a diagram 172 of the trench profile shown with different icons 176 and sections where numeric data 178 like downforce are given. An icon 182 of a side profile of a row unit with a gauge wheel 56 and closing wheel 58 is shown in the upper left of this example to monitor and report their performance. For example, if one of the closing wheels 58 falls off on any of the rows then the closing wheel 58 on the icon 182 will change color to alert the operator. Various additional methods for alerting the operator are possible and would be understood by those of skill in the art.

The three icons 174 at the top right of the overview represent residue 48 or debris 48, supplemental lighting 72, and camera 70 health. If a problem occurs, these images could change color, flash, or otherwise change to indicate the issue. For debris 48, the icon may change color to show different amounts of residue 48 or what kind of debris 48 is present in the trench 44 or how many rows are affected.

The trench 44 profile shows a seed 42 at the bottom and a crosshair 176 to measure width and depth of the trench 44. The line 184 defining the trench 44 profile may change color depending on the average trench 44 quality across the row units 50, such as orange for collapsing, green for good, and purple for peeling with supplementary colors in-between to show changing conditions like blue for smearing. For example, a ‘good trench’ may have qualities that lean towards smearing so the color may change to a blue-green to communicate that. The seed 42 may also change color to signify seed 42 placement quality like a high amount of rolling, so that the operator or system 10 can adjust parameter to correct to desired planting conditions. Various alternative colors and indictors are possible and would be recognized by those of skill in the art.

As the model identifies a seed 42 in the trench 44, the data may be viewed for operator convenience on the monitor 14. For example, a seed icon 186 can be placed within the graphic 172 of the trench 44, as previously described, that is one color when singulation is good and another when there are too many skips or doubles. If the operator is planting in conditions with lots of debris 48, then a number may be displayed alongside the icon 186 or graphic 172 to indicate the percentage of seeds 42 that are covered by clods 48 or residue 48.

If the operator or farmer wants to view all the data analyzed by the model, then the information can be presented at the request of the user. Data that may be of interest such as seed 42 placement, refuge, or the location of the seed could be viewed as the number of instances recorded over a linear distance, instances over time, instances per row, or a variation that uses percentages would be made available to be viewed. Analyzing the location of seeds 42 within the trench 44 may be quantified as degrees from the center or as a latitude and longitudinal placement. This could be displayed as a number or by showing a graphic representation of the seed 42 placement within the trench 44.

In some implementations, the system 10 and machine learning model may act in place of a seed monitor. By using the vision sensor 70, the machine learning model can track seed 42 placement within the trench 44 as planting occurs. This data can then be used to calculate singulation, seed spacing, and other information that may be useful to the operator. This can be used in conjunction with geospatial (e.g. GPS) mapping 90 to allow the operator to playback footage of a seed 42 being planted at a specific point in the field that can be viewed in real time or later. Operators and the system 10 may then visually compare planting conditions to harvest yields allowing operators to remain completely informed about their fields.

The vision sensor 70 may also identify and count refuge seeds by looking for a different color seed and be used to calculate the percentage present in a field. Further applications, such as marking the seeds 42 using color or ultra-violet dye can be applied to identify seed 42 orientation and could be used to maximize production. Dye can also be added to treatments to clearly show application quality without disturbing the trench 44 formation. In the use of ultra-violet or fluorescent dye an additional lighting source 72 may be used in various implementations.

FIG. 44 is an example of what an expanded view of trench 44 formation across all the row units the system 10 and vision sensor 70 is present on may be displayed as. The squares 188 that represent the row units 80 could be numbered and change colors to indicate the different conditions within the individual trenches 44 from number of debris 48 or trench 44 quality. A space for numeric data 178 may be used to present information from the seed monitor or other sensors of the system 10 so that additional information regarding planting can be easily seen. At the top left of the monitor, the profile of the row unit 182 and the icon for seed placement are shown for monitoring.

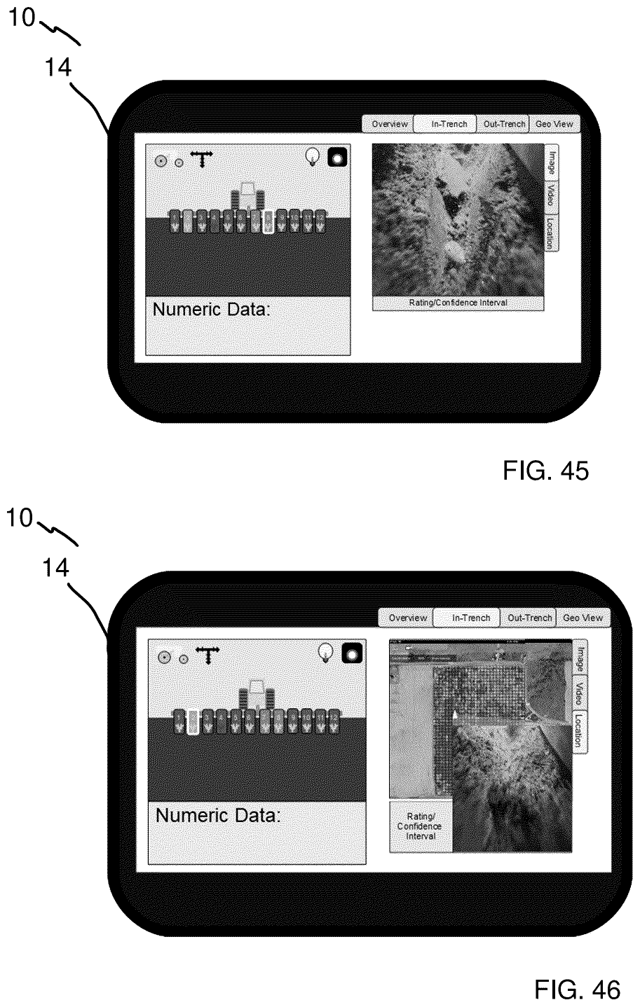

FIG. 45 shows an example of selecting a row unit 50 and display a corresponding image of the trench 44. The example shown is of row eight that becomes highlighted when selected and by clicking the ‘Image’ tab on the right-hand side an image of the trench 44 for that row is shown.

FIG. 46 shows an example of a different row and by selecting the location table an image of the trench 44 in that row can be seen in relation to the rest of the field.

Optionally, if the operator is using a seed firmer 62 then they may want to view the performance of the firmer 62 as part of the overview. This could be done by adjusting the trench graphic 172 to include an icon 190 of the seed firmer 62 within the trench 44. Should a problem arise, like seeds 42 collecting or the firmer 62 having a poor ride, then the icon 190 can change color or appearance to visually indicated the firmer status.

A separate view of the seed firmer 62 may optionally be constructed should the operator request more details regarding the quality of the seed firmer 62 within the trench 44. This may include numeric values that represent how often the seed firmer 62 is bouncing or becoming misaligned within the trench 44 such as instances per linear distance, time, rows, or, in the case of alignment, degrees off from the center. With seed firmer 62 bounce the machine learning model can inspect the recorded images to calculate the height of seed firmer 62 bounce that can be measured and shown as a figure. Should the operator want to view the images taken of the seed firmer while the planter is in operation they may do so through the display 14.

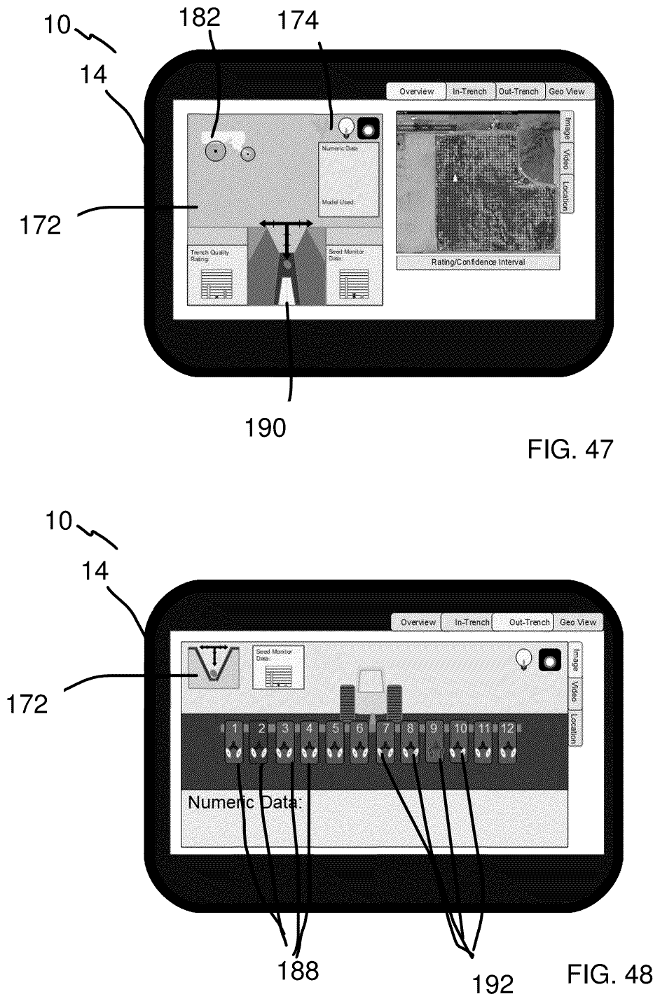

FIG. 47 shows an example of an ‘overview’ display that has been modified based on the view given by using a seed firmer 62. Similar icons to those discussed above are present except now there is the addition of a seed firmer icon 190 within the trench 44 that can change color or location based on the behavior of the seed firmer 62.

Residue 48 may be measured by the percentage of coverage, instances per linear distance such as inches, or by a method previously stated. The size of the debris 48, and in the case of residue 48, identifying the type i.e. corn stalk or bean stubble can then be recorded for the operator to view in depth at their leisure. This numerical data may also be accompanied by the images taken of the residue 48 by the vision sensor 70.

For quickly viewing the information about residue 48 an icon could be added to the graphic about the profile of the trench 44. If there is too much debris 48 the icon 174 can change color to indicate no, low, medium, and high levels of debris present within the trench 44. Other visual representations can be small graphs that show the average amount of debris 48 and the type, such as clods or rocks, present within the trench.

An icon 182 may be added to a page (optionally the ‘overview’ page) of the display to indicate whether both the closing wheels 58 are present and if one is plugged by residue 48. More detailed information could be displayed on the monitor 14 at the operator's discretion for individual rows or as the average health of all closing wheels 58. Values that quantify the quality of the mound the closing wheels 58 make, the amount of soil built up on the wheels 58, whether they are plugged, or any movement that can be a sign of a problem could be displayed in a separate window to be viewed. The images captured by the camera 70 can be viewed along with this information and on a geospatial map 90.

For quickly gaining an overview of gauge wheel 56 health an icon 182 may be used to represent the gauge wheel 56 on a page (optionally the ‘overview’ page) and would change its appearance when a problem is detected. Additional information may be displayed along with it like the RPM or downforce applied to the gauge wheels 56. A full report of the condition of the gauge wheels 56, such as if they are dragging or have soil build up, can be viewed on the display 14 as needed either through showing the images taken of the gauge wheels 56 or by quantifying the behavior.

FIG. 48 shows an example of how features of the row units 50 that do not specifically concern the view of the trench 44 can be shown to the operator. In this example, gauge wheel 56 status and closing wheel status 58 are shown. In this example, when problems with a gauge wheels 56 occur the color of the row unit icon 188 changes. If there are problems with a closing disk 58, then the closing disk icon 192 within the row unit icon 188 would change color. In the top left corner, a smaller version of the trench overview 172 that concerns trench formation is presented so that no matter what view is selected the operator can remain informed. Various alternative icons and methods for display data are possible and would be appreciated by those of skill in the art.

### Laser

In various implementations, the system 10 includes a laser 200 for visualization of the trench 44 through dirt, dust, and debris 48, particularly present at high speeds. By including a laser 200 along with a vision sensor 70 the operator can see the seed trench 44 profile and adjust planter parameters (e.g., downforce) to maintain trench 44 formation. Implementations of the system 10 including a laser 200 can identify seed trench 44 quality, and optionally emphasize the appearance of the sidewalls.

As would be understood, a laser 200 is a beam of light emitting a specific wavelength that is amplified to make the beam more visible in bright lighting and travel further. This ray of light creates a focused point, but when passed through different lenses its shape can be changed, for example, into a line. Depending on the length the laser 200 needs to travel, the beam's intensity may be adjusted by changing the distance between the lens and the light source. Other forms of narrow beams of light may include those used in structured lighting among others, as would be appreciated by those of skill in the art, discussed elsewhere herein.

In the various implementations disclosed herein, the light intensity of lasers 200 or other forms of lighting may be controlled manually by the operator, automatically by the machine learning model, automatically by sensors detecting ambient light (such as a lux sensor 78, discussed above) in or around the seed trench 44, and the like. That is, various systems, methods and devices may be implemented to adjust laser 200 beam intensity depending on the conditions within the seed trench 44.

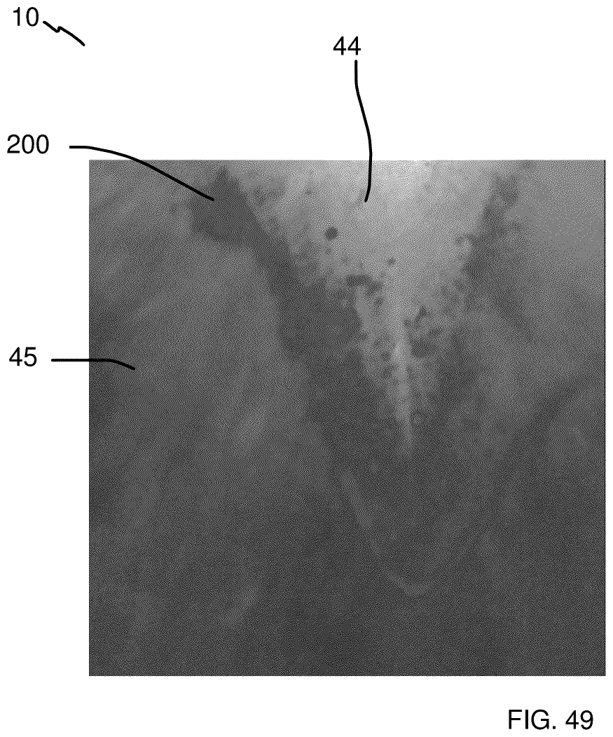

As disclosed herein, the laser 200 can be used to highlight the various characteristics of different types of seed trench 44 sidewalls. In various implementations, the system 10 provides a continuous beam of a laser 200 whereby if an object, such as a clod 48 of soil, blocks the path of the laser 200 a clear shadow is created that can then be read and detected by the system 10. For example, if using a laser 200 with a beam in the shape of a line then when the laser 200 is shown perpendicular to the trench 44 then the profile will be highlighted as a ‘V’, shown in FIG. 49. If the sidewalls are compacted, then the laser 200 line will be an unbroken line following the shape of the seed trench 44 but if the sidewalls have collapsed then the laser 200 beam will appear as a shallow ‘V’. In various implementations, implementing machine learning and data processing capabilities the algorithm will assess the quality of the seed trench 44 by analyzing how the laser 200 beam looks along the seed trench 44 profile.

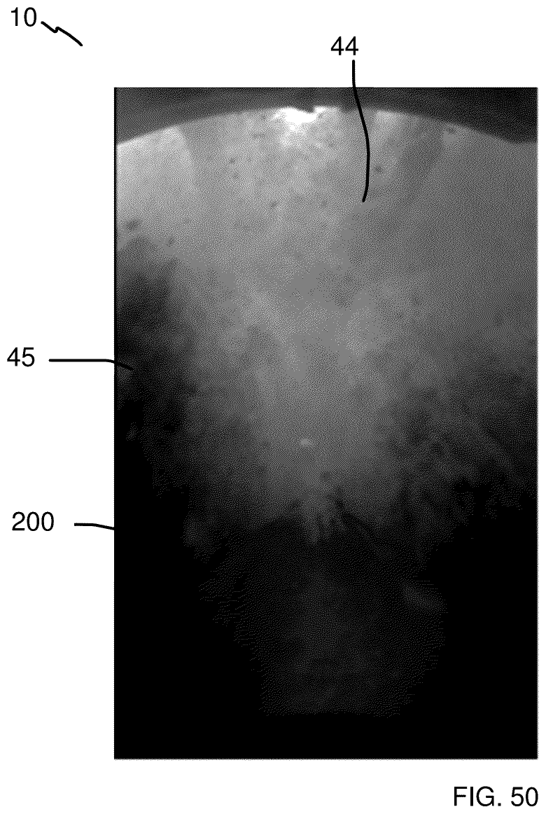

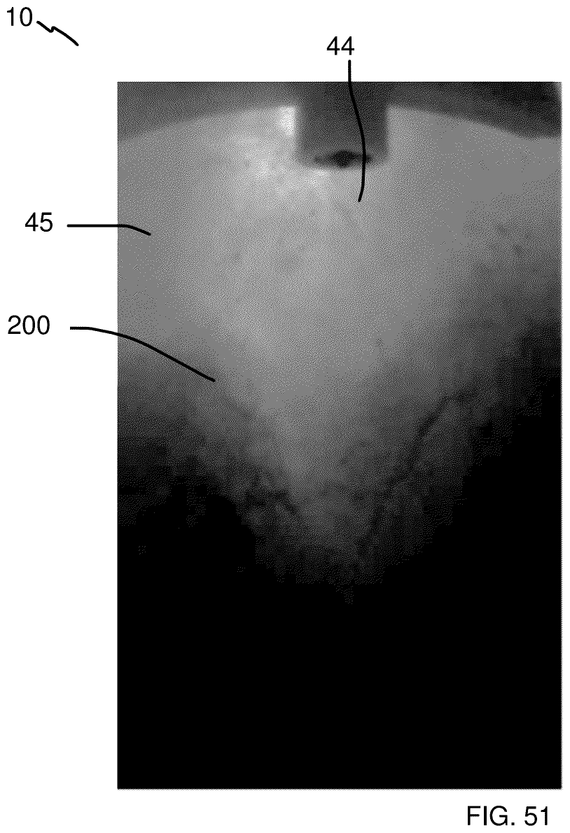

In certain implementations, the laser 200 may be mounted on a row unit 50 behind the opening disks 52 and above the seed trench 44 to show a full ‘V’ profile of the seed trench 44 (FIG. 49) or mounted below the camera 70 to show the seed trench 44 sidewalls moving towards the closing wheels 58 (FIG. 50). In high dust environments with the laser 200 in a top-down position the operator/system may look for the lowest part of the seed trench 44 to determine the depth and full shape of the seed trench 44 (FIG. 51). Alternatively, when the laser 200 is in a lower position the operator/system 10 may look for the highest part of the laser 200 line to assess the shape of the seed trench 44.

The seed trench 44 sidewalls have characteristics that determine the quality of the formation. For example, compacted sidewalls that are not very wet can be seen as smooth and forming a too perfect ‘V’ shape. This can be mistaken as a well-defined trench 44 but under closer inspection these seed trench 44 sidewalls often have cracks that can easily be broken off and fall into the seed trench 44 or the bottom of the sidewall may lift slightly from the trench 44. The smooth sidewalls may also be an indicator that the soil 45 has been overly compacted from excessive downforce as correctly made seed trench 4 sidewalls still appear ‘fluffy’ like the soil 45 has been gently pushed open to reveal the moist soil 45 underneath; not patted flat like a dirt wall. In conditions where the soil 45 is moist, the seed trench 44 sidewalls may appear smooth and shiny. This is different from compacted damp soil 45 as compacted moist soil 45 has the potential to stick to the parts of the planter in contact with the soil 45 like opening disk(s) 52, closing wheel(s) 58, and gauge wheel(s) 56. When soil 45 sticks to the opening disk(s) 52 it can detach from the seed trench 44 sidewall and fall into the trench 44 disturbing seed 42 placement.

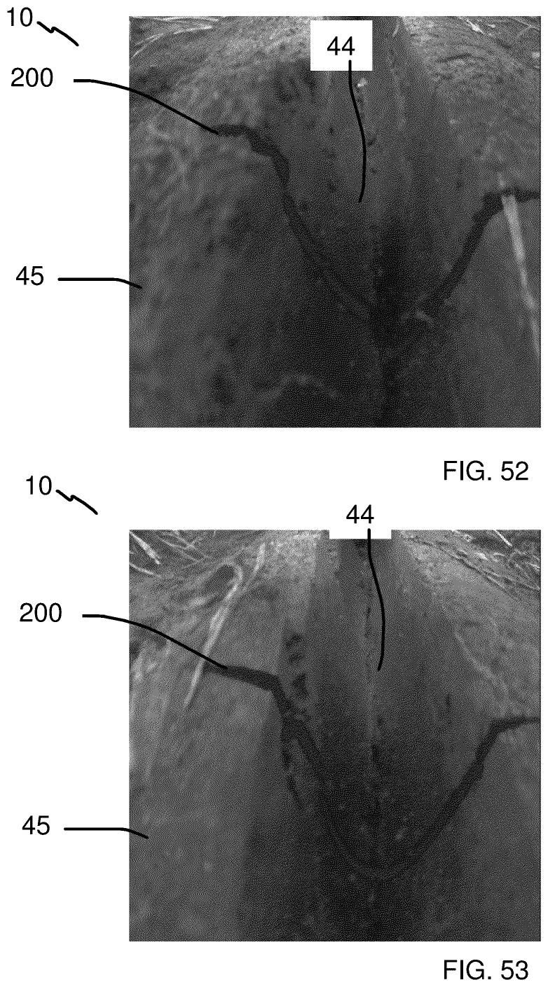

In FIG. 52 the laser 200 beam appears as a solid and smooth line going across the seed trench 44. The smoothness and evenness of the laser 200 line indicates a compacted seed trench 44 where soil 45 is smeared against the opening disk(s) 52 causing the seed trench 44 sidewall to have a smooth, flat appearance. The pressure of the downforce not only compacts the sidewalls but also causes them to begin peeling away from the surrounding soil 45. This is shown at the bottom of the seed trench 44 where the laser 200 line has visible discontinuity.

In FIG. 53 the laser 200 line is smooth and even across the seed trench 44, however, excessive downforce has caused a void to form in the seed trench 44 sidewall where the sidewall has buckled from the pressure. The laser 200 beam skips (is broken) over the area with the gap but otherwise follows the shape of the seed trench 44.

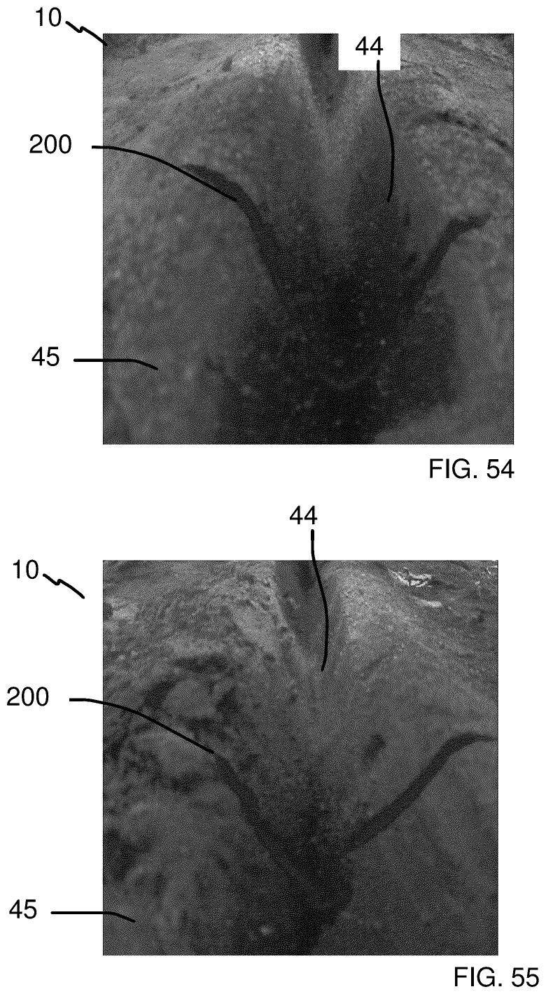

In FIG. 54 the laser 200 beam shows a properly formed seed trench 44. The laser 200 line across the seed trench 44 is not as smooth or as even as one that is on a compacted seed trench 44 (FIGS. 52-53) but there is still a clear ‘V’ shape. While there are points along the laser 200 that are smooth there are also parts of the laser 200 line where the line is diffused and not solid.

Collapsing seed trench 44 sidewalls are most common in dry soil 45 conditions. Without enough moisture to bind the soil 45 particles together the soil 45 remains visibly crumbly and dusty. Dry soil 45 requires a high amount of downforce to be applied so that the seed trench 44 sidewalls can hold their shape. There are various levels of a collapsed seed trench 44 from only partially collapsed to a completely filled in seed trench 44. If a seed 42 is placed on top of fallen soil 45, then they will not be planted at the proper depth, conversely, if the seed 42 is placed at the bottom of the trench 44 and dry soil 45 falls on top then the soil 45 can absorb the available moisture from inside the seed trench 44 and prevent germination. A good seed trench 44 wall should maintain the light texture of quality soil 45 while still having enough structure to prevent any disruption to the seed 42.

In FIG. 55 the laser 200 beam shows a ‘V’ shape, has smooth lines, and has sections where the line is diffused. While these details may be a part of good and compacted trench the ‘V’ profile is too shallow and indicates a collapsing trench 44. The seed trench 44 has not fully collapsed since there is still a ‘V’ shape but by using the laser 200 beam the overall shape does not reflect a seed trench 44 that has been formed at the full planting depth.

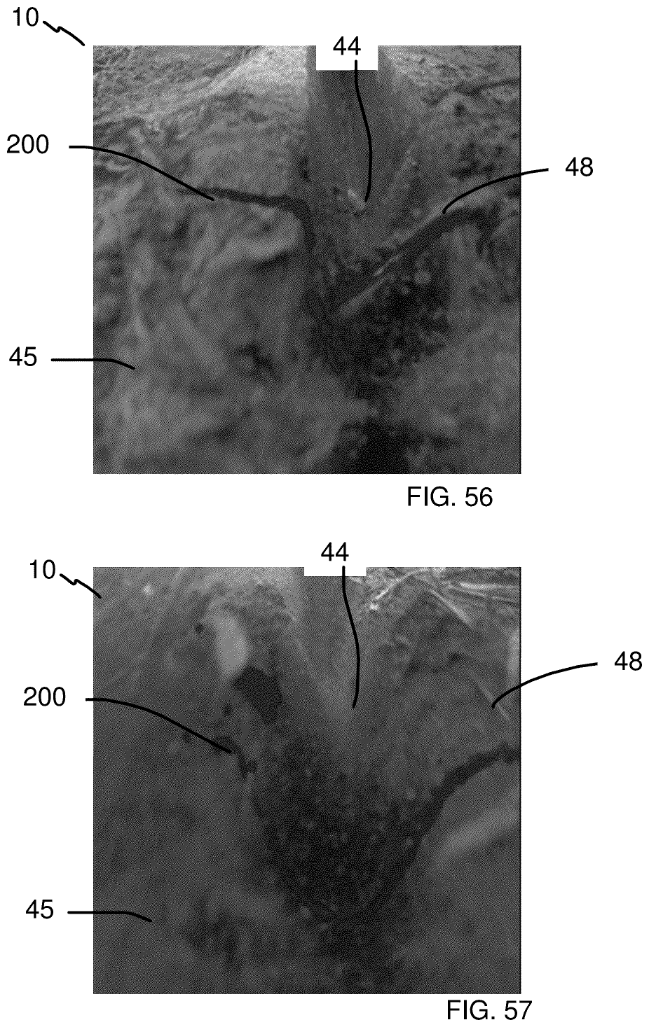

In FIG. 56 the laser 200 beam has hit a piece of residue 48 that has fallen into the seed trench 44. The laser 200 line can be seen to be broken into many separate pieces where the laser 200 beam first highlights a well-formed seed trench 44 sidewall before striking the piece of residue 48. This residue 48 blocks most of the laser 200 beam as seen by the straight laser 200 line in the middle of the seed trench 44. However, the laser 200 beam is still able to sporadically hit the other sections of the seed trench 44 as seen along the bottom right of the seed trench 44 sidewall.

In FIG. 57 there are characteristics of both collapsing and good seed trenches 44. The laser 200 beam clearly shows a ‘V’ shape along the profile of the seed trench 44 despite the addition of debris 48 scattering the light in the center of the seed trench 44. The laser 200 beam present in the image, improves identification of the seed trench 44 quality by improving the ability to see the seed trench 44 profile.

At higher speeds, a laser 200 can cut through flying dust and debris to highlight the solid seed trench 44 profile underneath. The airborne particles may diffuse the laser 200 line and create a bright triangle in the center of the seed trench 44 but by viewing the darker areas of the images taken by the vision sensor 70 and the system 10 the contrast between the laser 200 and the soil 45 of the seed trench 44 can assist in distinguishing trench 44 quality.

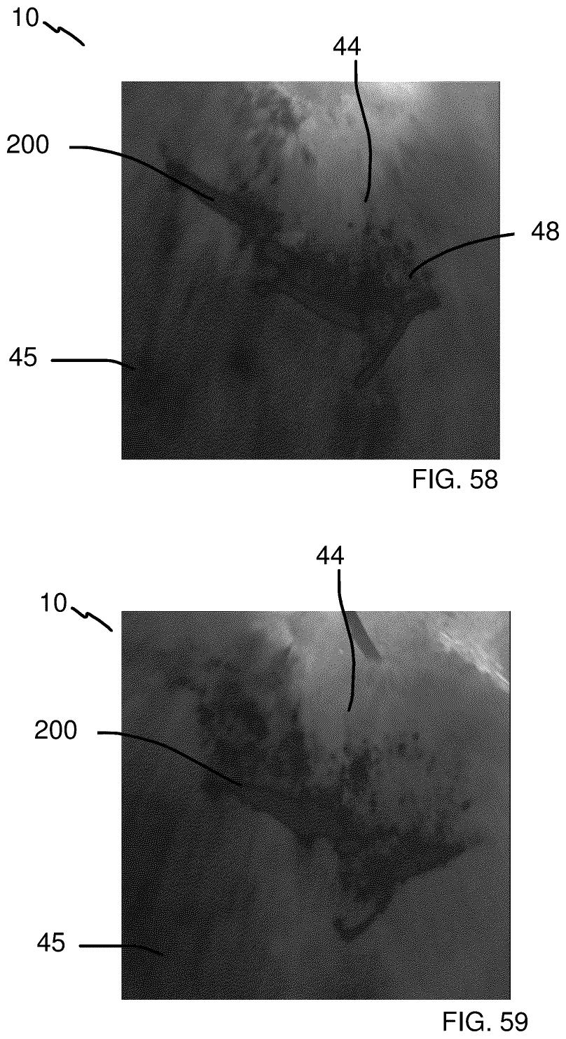

In FIG. 58, the shape of the laser 200 on the seed trench 44 appears to show a lack of a ‘V’ shape which makes the seed trench 44 looks like it is collapsing. However, the laser 200 beam highlights several areas where there are straight, even lines that are characteristic of a compacted seed trench 44. This indicates that soil 45 has been compacted against the seed disk and formed ribbons that eventually fell into the seed trench 44 disturbing the trench 44. Due to the speed of the planter, in this example, flying soil 45 has obscured the area surrounding the seed trench 45. For this reason, in various implementations, the system 10 may be configured to analyze not only the area above where the ‘V’ shape of the seed trench 44 should be but below it. This area is towards the bottom of the image has less debris 48 and helps form an assessment of the quality of the seed trench 44 in situations where the whole seed trench 44 is not visible.

FIG. 59 shows a collapsed seed trench 44 indicated by the laser 200. Here, the laser 200 line does not show a ‘V’ shape, and the jagged laser 200 beam is a characteristic of soil 45 that has not had enough downforce applied to properly form the seed trench 44 sidewalls. Despite the amount of flying soil 45 obscuring the area surrounding the seed trench 44 causing the laser 200 beam to be diffused across the upper part of the image by viewing the area underneath the laser 200 line the true seed trench 44 profile is able to be determined.

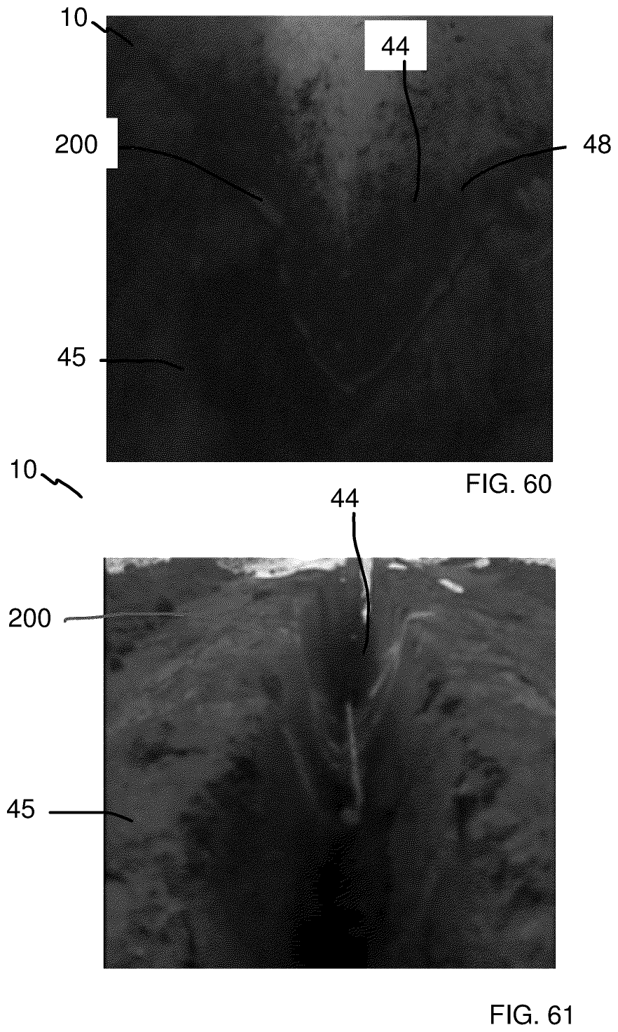

FIG. 60 shows the laser 200 line through debris 48 and shows the seed trench 44 profile. As shown, debris 48 can obscure the inside view of the seed trench 44 so instead focus should be on the area below the laser line 200 to gain a better understanding of the quality of the seed trench 44. For example, it can be seen that the laser 200 beam is not straight and even like those seen in compacted seed trenches 44, yet even though the line is blurry because the bottom of the laser 200 reaches the full depth of the seed trench 44 the trench 44 is not collapsing. The laser 200 shows that the seed trench 44 is a solid ‘V’ shape with sidewalls that are not compacted or collapsing which indicates that this seed trench 44 is properly formed and is of good quality.

Various different laser 200 lenses may be used with the system 10 to change the shape of the laser 200 beam depending on the seed trench 44 condition, as would be appreciated. There are multiple types of lenses such as multi-line, crosshair, square, circle, and dotted lines. Laser 200 shapes may be used for added benefits beyond the trench 44, for instance, the crosshair laser may be used to assess if the closing wheels 58 remain centered with the seed trench 44. FIG. 61 shows an exemplary crosshair laser 200.

In various implementations, the color of the laser 200 beam may be changed to best suit the color of the soil 45 or to reflect operator preference for viewing the trench 44. Optionally, the laser 200 may be red, blue, or any other appropriate color, as would be recognized and understood.

Various additional implementations include use of a laser 200 beam for measuring and analyzing the depth of the seed trench 44, optionally in comparison to the planting depth set by the operator/system 10.

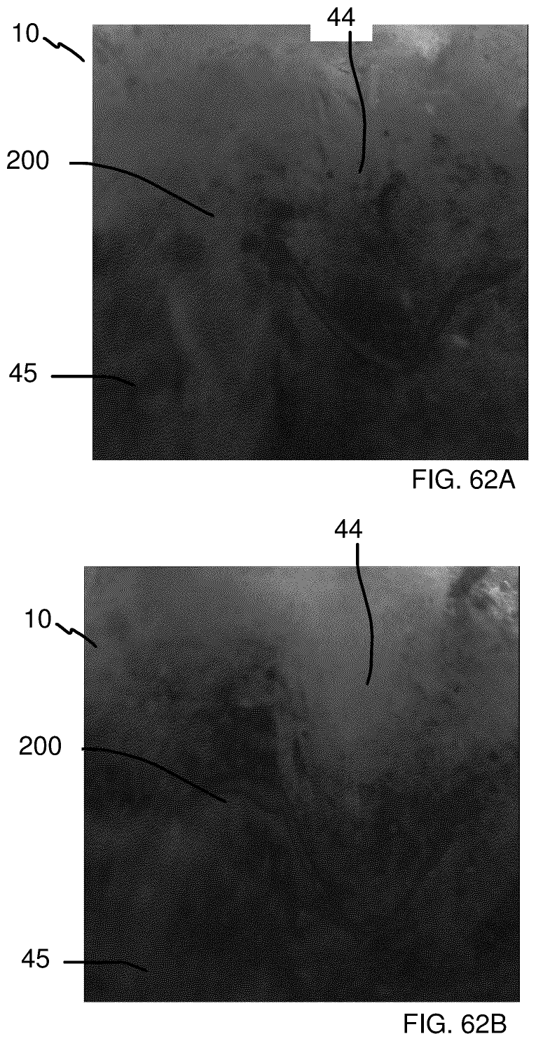

FIGS. 62A and 62B show images taken by the system 10 in sequence at a high planting speed. A laser 200 beam shown across the seed trench 44 shows the seed trench 44 profile of both images. In these and other implementations the camera 70 is a fixed, stationary object so the position of the seed trench 44 in the frame is the same across these two images. Despite this, the laser 200 line shows the trench 44 of FIG. 62A is at a shallower depth than the seed trench 44 of FIG. 62B. That is, the gap from the apex of the seed trench 44 to the bottom of the frame in the FIG. 62A is larger than that of FIG. 62B. The use of the laser 200 beam to assess the depth of the seed trench 44 can be used to alert the operator when additional downforce needs to be applied to maintain full contact with the soil 45 during planting. Alternatively, the system 10 may automatically detect the trench 44 being too shallow and automatically or semi-automatically adjust downforce on the row unit 50.

In some implementations, the laser 200 may be used in conjunction with a 3D imaging camera 70 to acquire accurate depth data that can be reported to the operator or otherwise logged by the system 10. This includes, but is not limited to, analyzing seed trench 44 depth to predetermined accuracy and displaying the seed trench 44 as a 3D model to the operator to view. Alternatively, a series of images collected by the vision sensor 70 and system 10 may be used to construct a 3D rendering of the seed trench 44 without the use of a depth sensor.

Various implementations may include additional sensors such as, but not limited to, a GPS receiver 15 to acquire ground speed and/or geolocate/tag the images. Ground speed may also be acquired by calculating ground speed by analyzing the images (determining the amount time a point in the images moves across a linear distance), using the speed data from the tractor 1, and the like as would be understood.

In analyzing the unique characteristics of different seed trench 44 qualities, the machine learning model may determine a final rating of the seed trench 44 and report this finding back to the operator and/or otherwise log the rating for future access and analysis, as has been discussed herein. The data collected in the seed trench 44 may be displayed to the operator on an in-cab display 14, as a still image or video play back. In certain implementations, the system 10 may also display numeric statistical data such as, but not limited to, instances per linear distance or the percentage of seed trenches 44 across a field in the same quality category. For example, if the operator or system 10 receives reports that the seed trench 44 is experiencing higher instances of collapsing seed trenches 44, then the operator or system 10 should increase the amount of downforce applied to properly form the seed trench 44 sidewalls. These actions may also be taken automatically by the system 10, as would be understood, with or without operator input. In certain implementations, the operator may have the option to change the adjustment settings from being manually imputed by the operator to relying on the machine learning model to automatically adjust downforce as needed while planting.

Additionally, as soil conditions change day to day or across a field the algorithm may adapt and correct the amount of downforce applied to the seed trench 44 accordingly. This may involve automatically or semi-automatically updating the alert criteria to the operator so that the operator is only informed concerning seed trench 44 formation that is specific to the soil 45 condition at the time of planting. For instance, if the operator is planting in very moist soil, then some compaction may occur at a higher rate even at the proper downforce setting. The alert threshold may then be changed so that the tolerance for a properly formed seed trench 44 may also include seed trenches 44 that are experiencing minor compaction but are otherwise well-formed. The operator would then only be alerted to seed trench 44 conditions that experience high amounts of compaction such as ribbons of moist soil 45 falling into the seed trench 44.

In certain implementations, data may be gathered from previous years and used in determining the appropriate amount of downforce in a field. In these and other implementations, the machine learning model may use operator input to determine the planter's location or use GPS 15 to locate the exact position relative to the position of the planter for accuracy purposes. For example, historical information regarding the planting conditions, such as but not limited to, soil 45 composition, soil 45 conditions, weather patterns to estimated soil 45 moisture, previous trench 44 quality, and other suitable data may be used to increase or decrease the downforce while planting. This cumulative data may optionally be used to determine the amount of downforce necessary for proper seed trench 44 formation in a specific row or at a specific point in the field, optionally aided by the system 10 discussed herein. The ability to have control over the quality of seed trench 44 formation across a field and across planting seasons allows operators to remain confident that plant growth will not be impeded by poor trench downforce. Compaction data from previous years could also be used to predict areas in the field where compaction or collapsing has historically been an issue. This information could be used to preemptively adjust a downforce or other control systems when approaching these areas.

### Temperature Sensors

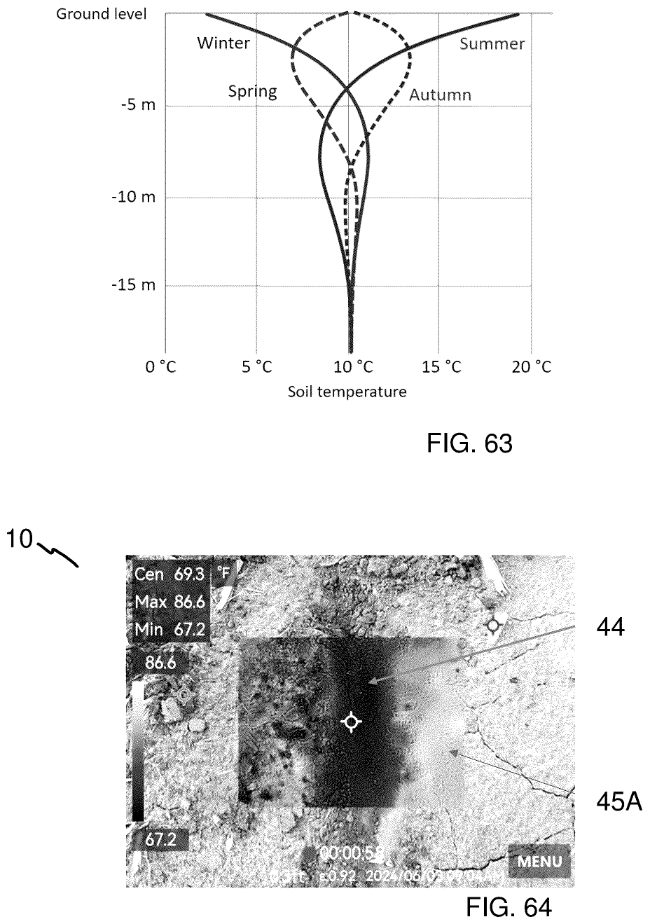

When analyzing the soil, there is often a temperature difference between surface soil 45A, seed trench 44 sidewalls, the bottom of the trench 44. This is because a soil temperature gradient exists in the vertical soil 45 profile. In geographies where the planting season (spring) occurs after a cold season (winter), surface soil 45A and objects laying on the surface are usually warmer than the seed trench 44. FIG. 63 shows a graphical representation of soil 45 temperature gradients are various depts in different seasons. FIG. 64 shows a thermal image of a seed trench 44 showing the cooler temperature of the seed trench 44 relative to the warmer topsoil 45A. For example, when planting during the day in direct sunlight the surface temperature may be about 10 degrees Fahrenheit warmer than soil at the bottom of a trench 44. As such, if debris 48 from the surface were to fall into the seed trench 44 the debris 48 will be warmer than its surroundings. It would be understood that surface soil 45A and subsoil (inside the trench 44) absolute temperatures and relative temperature difference may change throughout the day as atmospheric and light conditions change.

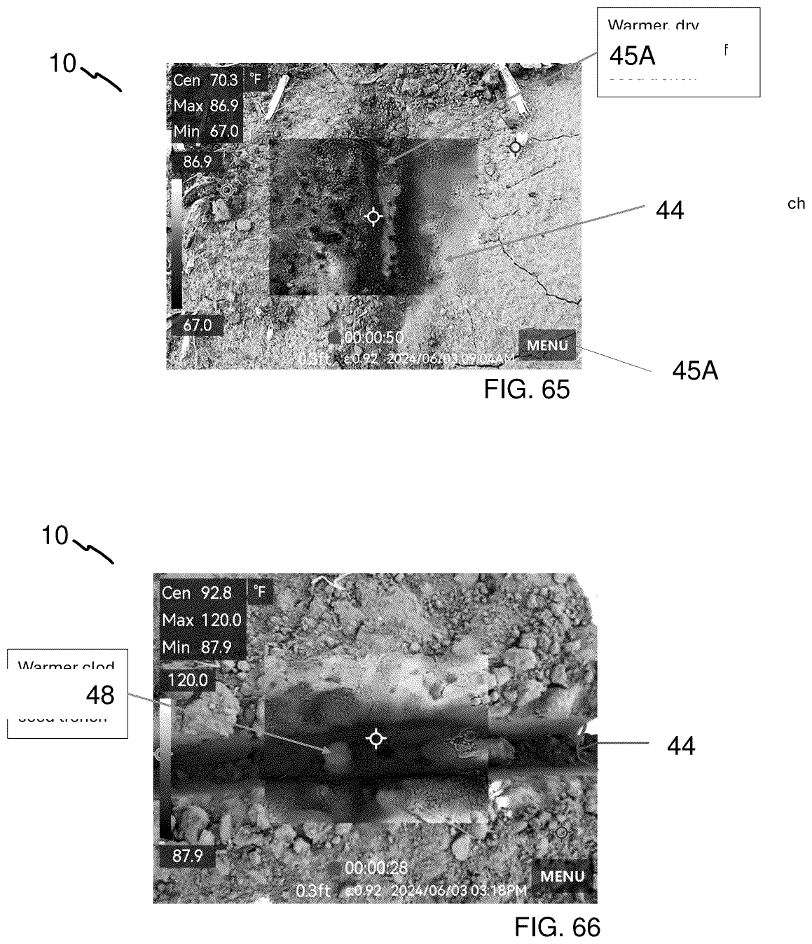

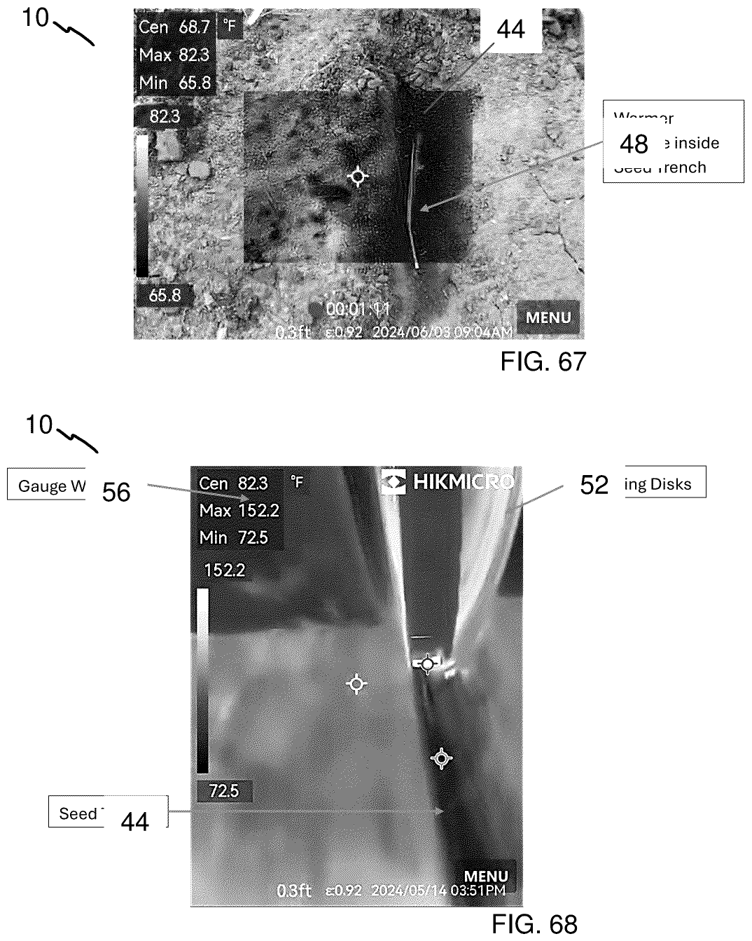

As an example, dry debris 48/topsoil 45A may have a higher temperature than that of the sidewalls of an open trench 44. As would be understood, if dry debris 48, such as dry topsoil 45A, falls into the trench 44 that dry topsoil 45A may surround the seed 42 and delay or stunt germination if moist soil 45 is unable to contact the seed 42. The ability to detect this debris 48/topsoil 45A falling into the trench 44 may help with germination and ultimately maximizing yields. FIG. 65 shows a thermal image of warmer dry topsoil 45A that has fallen into an open seed trench 44. FIG. 66 shows a warmer clod 48 fallen into the open seed trench 44. FIG. 67 is a further example of warmer residue 48 fallen into the open seed trench 44.

In another example, if the opening disk(s) 52 is dragged through the soil 45 the disk 52 will begin to experience a temperature change from the friction of the soil moving past. FIG. 68 shows an exemplary thermal image showing the opening disks 52 and gauge wheels 56. This temperature change would be distinguishable from the surrounding environment by using a device that can identify the temperature gradient such as, but not limited to, a temperature sensor 150 or sensors or a thermal camera 150, as will be discussed further herein.

A further example includes a gauge wheel 56 dragging against the soil 45, this situation creates a temperature change to the gauge wheel 45 as friction causes the part of the wheel 46 with wheel 45 to soil 45 contact to increase in temperature.

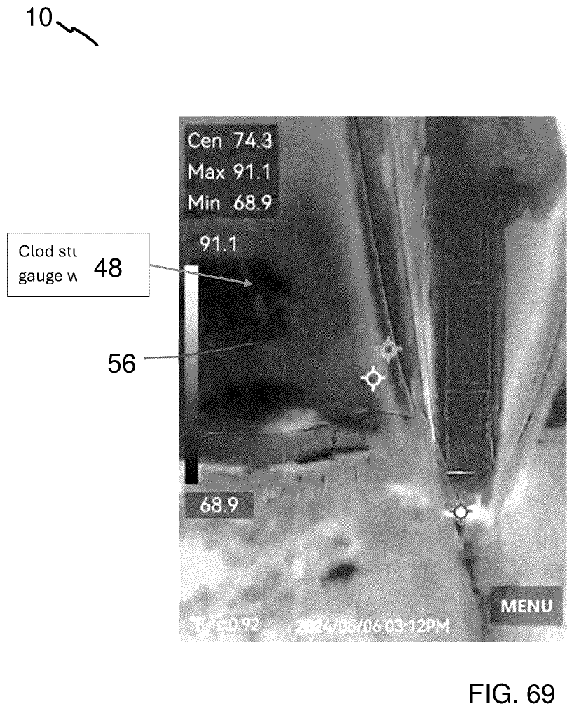

In a still further example, should a piece of debris 48 be caught in a closing wheel 58 or gauge wheel 56 the cooler residue 48 or soil stuck on the wheel 56, 58 could be detected by a temperature sensor/system 10, as will be discussed herein. This is shown for example in FIG. 69.

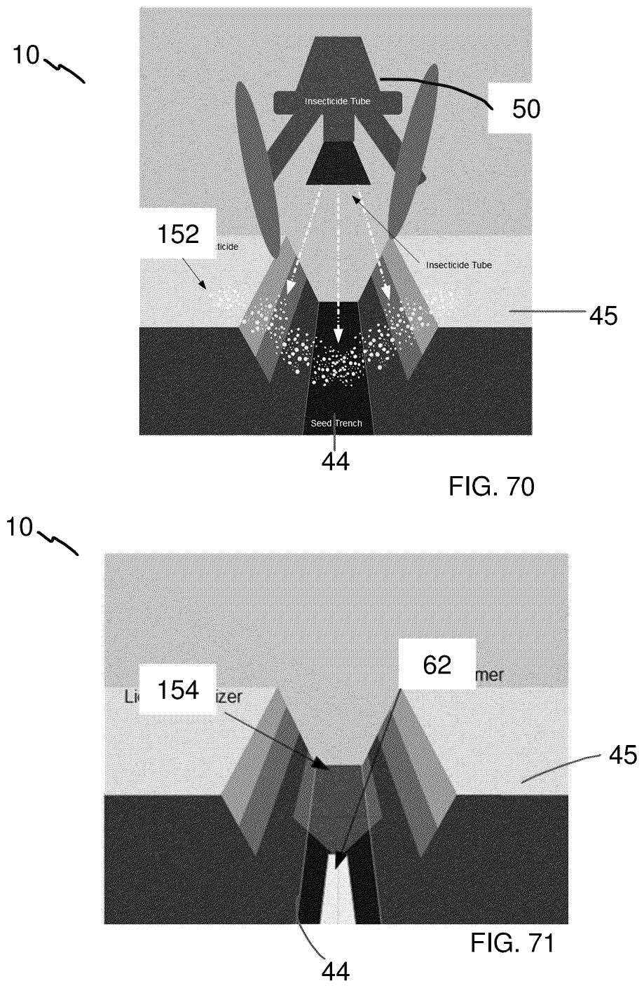

When applying additives (e.g., fertilizer, pesticide, insecticide, etc.) there may be a temperature difference between the product 152, 154 (such as powder insecticide 152 or liquid fertiziler 154 shown in FIGS. 70-71) and the soil 45 within the trench 44. For example, liquid fertilizer 154 placed at the bottom of the seed trench 44 may have a cooler temperature than the soil 54 around it. Comparatively, when applying dry insecticide 152, due to the application method placing the product both at the top and bottom of the seed trench 44, the insecticide 152 may be cooler in relation to the soil 45 at the top of the trench 44, but warmer than the soil 45 at the bottom of the trench 44. Being able to detect crop care additives within the trench 44 allows the operator to have confidence that there will not be an economic (yield) loss due to faulty application.

In various implementations, the system 10 is able to detect dry topsoil 45A, residue 48, clods 48, and other debris 48 in the seed trench 44 by use of thermal sensors/imaging in addition to or in place of the various other devices and methods discussed elsewhere herein. In various further implementations, the system 10 automatically or semi-automatically adjusts planter settings based on the condition of the seed trench 44, including detected debris 48. In certain implementations, an operator may be altered to the seed trench 44 condition such that planter settings may be adjusted manually or with certain manual input/confirmation.

As would be appreciated, the thermal reading of a given field of view of a rotating opening disc 52 and gauge wheel 56 typically varies. When stationary, the temperature usually stays constant. This phenomenon may be used by a thermal sensor 150 to detect malfunctions in rotating devices. For example, malfunctions that stop rotation, indicated by a constant temperature in a field of view. Malfunctions that cause rotation may be indicated by temperature variation in a field of view.

In using temperature sensors 150 these unideal situations, (e.g., debris 48 in the trench 44, planter obstruction/malfunction, and incorrect additive 152, 154 application) that could negatively affect planting quality, can be remedied by the operator and/or system 10 before damage to the yield potential occurs.

In various implementations, a vision sensor 70 mounted underneath the planter is used to observe seed trench 44 formation, the planter's condition, and the application of crop care products 152, 154. In certain implementations, the sensor 70 is an infrared or thermal vision sensor 150, (also referred to herein as a thermal camera 150). Various combinations of different types of vision sensors 70, 150 and other sensors discussed elsewhere herein are possible. In these and other implementations, the thermal camera 150 measures the temperature gradient at various locations in the planting process and optionally presents visual confirmation of this data to an operator. Additionally or alternatively, the system 10 may include other thermal sensors 150 such as, but not limited to, thermocouples, resistance temperature detectors, negative temperature coefficient thermistors, and other energy detecting devices. Thermal sensors 150 may be used in conjunction with other types of data collecting devices such as vision 70, time of flight, electromagnetic, and other sensors, discussed herein and known and appreciated by those of skill in the art.

As would be understood, thermal cameras 150 operate by sensing the infrared energy emitted by objects also known as emissivity. Even if two objects experience the same temperature conditions, they may appear differently on the thermal camera's 150 readout. This allows for detecting debris 48 within the seed trench 44 even when atmospheric conditions may cause the seed trench 44 and debris 48 to appear to have the same temperature when using conventional temperature sensors such as a thermometer. Because of differences in emissivity debris 48 may be detected by calibrating the thermal camera 150 to focus on a specific range of infrared energy. For example, if there are two objects of the same temperature but one was shiny then the shiny object would appear brighter on a thermal camera 150 because it is reflecting the infrared energy of the surrounding environment. Comparatively, objects made from different materials, with the same temperature and finish, may appear differently on the thermal camera 150 readout because certain materials may emit radiant energy better than others.

Other techniques may be employed to render a thermal image in difficult environmental conditions such as using different thermal color themes, such as White Hot, or using additional sensors. In various implementations, if the thermal camera 150 is unable to detect debris 48 within the seed trench 44 due to the similarities in temperature the operator may be alerted to this situation. In these situations, the operator may choose to disable the thermal detection feature of the system 10 and instead choose to record the temperature within the seed trench 44 to assess the quality of seed germination after planting or use the thermal camera 150 to record other conditions in the trench 44 such as, but not limited to, the condition of the planter or application of crop care 152, 154 within the trench 44.

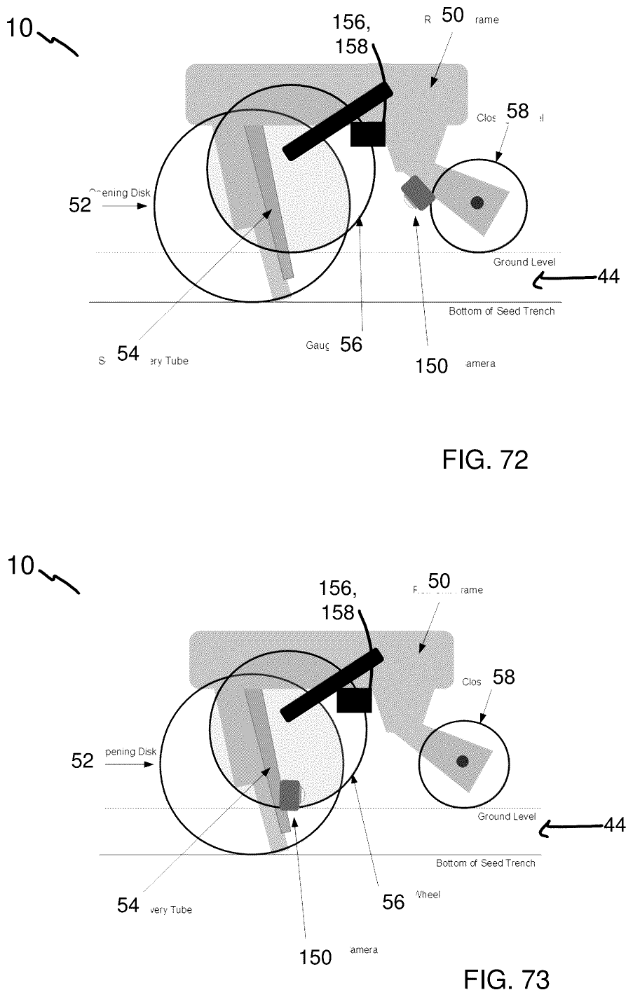

In various implementations, the system 10 may include an additional mechanism to cool or heat the seed trench 44 to maintain the temperature difference needed for debris detection. That is, the system 10 may include a supplemental heat source 156, shown in FIG. 72, such as a heat lamp, near the soil to increase the temperature of the surface soil. Additionally or alternatively, the system 10 may include air conditioning unit or similar cooling unit 158, shown in FIG. 72, to blow cool air within the seed trench 44 to cool down the sidewalls. Various other devices for heating and/or cooling are possible and may include, but are not limited to, high-efficiency lasers or a modified seed firmer. A modified seed firmer 62 may be configured to change the temperature of the seed trench 44 through direct contact with the soil 45.

For a thermal camera 150 to reliably detect trench 44 debris 48, there must be a temperature difference between the seed trench 444 and adjacent soil surfaces. If the temperature is the same, the camera 150 may detect false positives (e.g., trench 44 is clean when it has debris 48). There may be infrequent cases where there is not a temperature difference. For example, no till fields covered in crop residue 48 may prevent the soil surface 45A from warming, especially on a cold overcast day. In various implementations, to prevent false readings, the camera 18 and system 10 may be configured to detect this state and temporarily disable debris 48 detection until a temperature difference reappears.

In various implementations, the field of view (FOV) of the thermal camera 150 includes the seed trench 44 and the adjacent soil 45 surfaces, as shown in FIG. 64, to assist in detection of the temperature gradient. If the camera 150 detects an adequate temperature difference between the seed trench 44 and soil surface 45A, debris 48 detection may be automatically or semi-automatically enabled. In various implementations, an adequate temperature difference may be about 2 or more degrees F. Various other threshold temperature differences are possible and could be inputted by a user, preset in the system 10, and/or determined via a machine learning model. In various implementations, the camera 150 knows the location of the seed trench 44 in its FOV (i.e. which portion of the FOV is occupied by the seed trench 44) to check for a temperature difference. In certain implementations, locating the seed trench 44 may require a calibration routine.

When debris 48 detection is enabled, the system 10 determines if the seed trench 44 is the same temperature or not as the surrounding topsoil 45A. If not, the system 10 may determine if unwanted debris 48 is in the trench 44. The system 10 may warn the planter operator and/or spatially map the debris location. The system 10 may also summarize debris 48 detections by row, by field, and/or by pass. After notification, the planter operator may make planter adjustments, optionally certain adjustment may be automatic or prompted by the system 10. The planter operator may look at an on-the-go map to quickly determine if the adjustments worked (reduced debris) or if further adjustments are needed. This determination may also be automatic or determined by a machine learning or artificial intelligence algorithm. In various implementations, as discussed above, the system 10 may only alert an operator to a high debris 48 condition when more than a threshold number of instances/occurrences of debris 48 are detected.

As would be understood, in most cases, debris 48 in the trench 44 will be warmer than the trench 44 sidewalls. There may be infrequent cases where the opposite is true-debris 48 is cooler than the trench 44. The system 10 implementing a thermal camera 150 will work in both cases because the system 10 operates in these implementations by detecting by an absolute value difference between the soil 45 and debris 48. That is, the system 10 determines whether the temperature of the trench 44 is uniform or not. The system 10 implementing a thermal camera 150 will also work as the environment heats and cools the soil throughout the day as long a temperature difference exists between trench 44 and soil 45A surface.

FIG. 65 shows an exemplary thermal image of dry topsoil 45A within the open trench 44. FIG. 66 is an exemplary thermal image of a clod 48 within the open trench 44. FIG. 67 is an exemplary thermal image of residue 48 within the open trench 44.

In various implementations, the sensors 150 may be installed so that the center of the seed trench 44 remains in the same spot in the detection zone. For instance, the seed trench 44 may run vertically in a straight line down the center of the image so that the sensor 150 is consistently observing the temperature difference between the seed trench 44 walls and debris 48 within the trench 44.

Alternatively, as would be appreciated a properly formed seed trench 44 should be consistent in placement and run in a straight line. In certain implementations, the thermal camera 150 may be calibrated to spot this unique feature allow the thermal camera 150 to follow the seed trench 44 even as the planter row unit 50 shifts and moves while in the field. That is, the thermal camera 150 may be capable of dynamic movement. If the ride of the row unit 50 causes the thermal camera 150 and other sensors to shake and prevents accurate data collection they may be connected to an adjustable arm or base to maintain contact with the desired object and prevent poor quality images.

### Planter Condition

In various implementations, a thermal camera 150 may also be used to look at the planter row unit 50 to ensure that the mechanical and electrical components are working properly. See FIGS. 68 and 69, where issues with the opening disks 52 and/or gauge wheels 56 are identified in the thermal images. As the row unit 50 is moved through the soil, many parts rotate and rub, creating friction that causes a temperature increase in the area. In one example, if the ball bearing in an opening disk 52 wears out after prolonged use and if left unmaintained the creation of the seed trench 44 could be negative impacted. FIG. 68 shows an exemplary thermal image including the opening disks 52. A thermal camera 150 may be used to non-invasively and easily assess the condition of the ball bearing to inform the operator when the bearing reaches the end of its lifespan. That is, causes a hot spot from the worn bearing can be detected and reported to the operator for possible maintenance.

Another example includes use to detect when an opening disk 52 or gauge wheel 56 becomes jammed and is unable to spin correctly. In this example the wheel 52, 56 would be dragged through the soil, increasing its temperature irregularly, visible through thermal imaging. Various further examples and uses for detecting and monitoring planter conditions are possible and would be understood by those of skill in the art in light of this disclosure. FIG. 69 shows an exemplary thermal image of a gauge wheel 56 collecting a moist soil clod 48.

### Crop Care

In various implementations, the system 10 includes the use of a thermal camera 150 to visually identify the quality of crop care (i.e. additives such as fertilizer 154, insecticide 152, and pesticide) application. See FIGS. 70-71. In certain implementations, the quality and application can be reported to and monitored by an operator to make assessments on the type of crop care, liquid 154 or powder 152, and the amount used. Additionally or alternatively, the application of crop care can be automatically monitored by the system 10 and dynamic decisions made automatically or semiautomatically to adjust application parameters and/or alert an operator that maintenance or adjustments are necessary. In some implementations, a machine learning model may be implemented to assess the quality of crop care applications. Details of the machine learning model are discussed elsewhere herein.

In the instance of dry insecticide 152, the product is sifted into the open trench 44 covering both the inside of the trench 44 where the seed is, and the top of the trench 44 where it meets the surface 45, shown for example in FIG. 70. By using a thermal camera 150 to view this process an operator/the system 10 may see and evaluate the evenness of application. In certain implementations, the application can be assessed through the temperature gradient between the insecticide 152 and soil 45, and the amount being applied. Should it be seen that an inadequate amount of insecticide 152 is being applied to the seed trench 44, the operator can fix the situation before harvest yields are affected, or alternatively the system 10 may automatically adjust the application.

In the case of liquid application 154 (e.g., fertilizer), where the operator uses a seed firmer 62 to apply the treatment to the soil 45 the thermal camera 150 may view the liquid 154 as it moves through the seed firmer 62 into the trench 44 due to the temperature difference between the liquid fertilizer 154 and the bottom of the trench 44, shown for example in FIG. 71. This would ensure that if the fertilizer 154 tube becomes clogged with debris the operator could be notified and remove the blockage before crop yield can be affected.

Various further examples are possible and would be understood by those of skill in the art.

### Thermal Sensor

The placement, amount, and type of temperature sensors 150 used may be selected based on the area of interest for analysis. When viewing the seed trench 44 a thermal camera 150 may be used as the selected temperature sensor 150 to achieve accurate data. In these and other implementations, a thermal camera 150 would not need to contact the soil 45 or debris 48, but instead implement an infrared sensor to detect the energy emitted from the trench and residue. In certain implementations, the thermal camera 150 may be mounted above the trench 44 facing the seed tube 54 such that a clear image of the seed trench 44 as it forms can be seen, shown in FIG. 72. By using a non-contact thermal camera 150/sensor 150 the development of the seed trench 44 is not impacted or disturbed.

To view the mechanical properties of the trench 44, the thermal sensor(s) 150 may be mounted in locations on the row unit 50 that allow for data collection. For example, to view the condition of the opening disks 52 a thermal camera 150 may be mounted underneath the row unit 50 off the shank pointed towards the seed tube 54 in addition to other sensors on the disk 52 itself, shown in FIG. 72. This position does not disturb the formation of the trench 44 and allows a clear view of the gauge wheels 56, opening disks 52, and other areas of interest such as a seed firmer 62 is present.

Alternatively, to view the condition of the closing wheels 58 the thermal camera 150 may be mounted off the row unit 40 shank pointing towards the closing wheels 58. Other locations to mount the thermal camera 150 to view the closing wheels 58 may also include off the seed tube 54, shown in FIG. 73. In viewing the closing wheels 58, analysis may also be done on the quality of the closing mound. As the closing wheel 58 pushes the soil together to close the seed trench 44, the temperature gradient of the soil should not be disturbed. If the gradient has been disrupted this may be a sign that dry soil topsoil 45A is being mixed with the cooler, moist soil of the seed trench 44 causing less moisture around the planted seed.

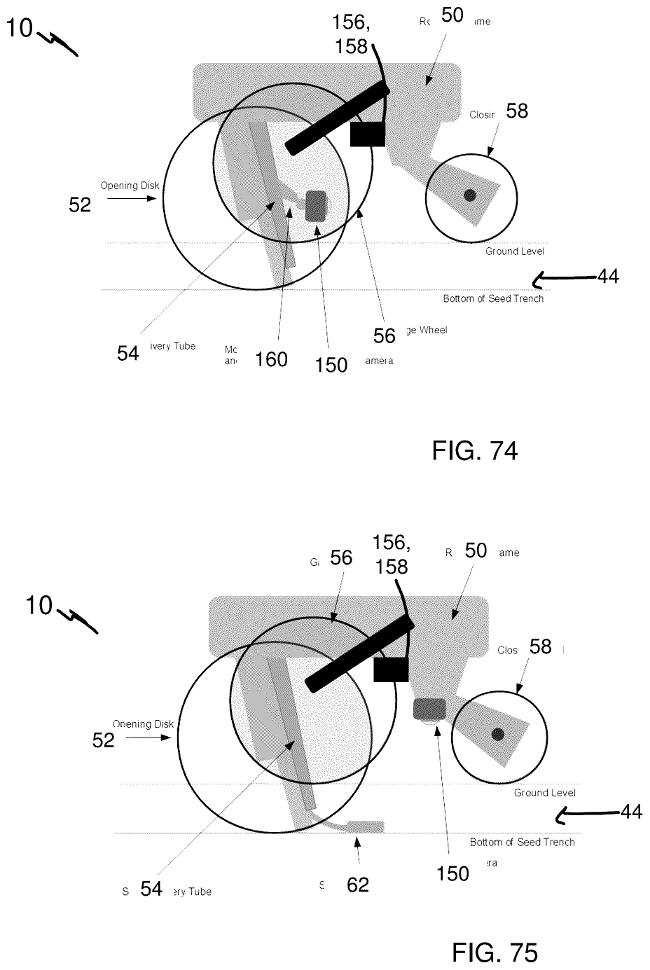

In certain implementations the thermal camera 150 and other sensors may be fitted with a motorized arm 160, like a ball and socket joint 160, which can be adjusted by the operator from inside the cab or automatically by the system 10 and optional machine learning model, shown in FIG. 74.

In various further implementations, the thermal camera 150 may be mounted to the shank of the planter row unit 50 and pointed downwards toward the seed trench 44. In these implementations, the system 10 is provided with a birds-eye or top down view of the seed trench 44, shown in FIG. 75.

It would be appreciated and understood, that the system may include one or more thermal sensors 150 mounted at one or more locations on the row unit 50, including those described above and alternative locations as desired for the application.

### Data Display

In implementations, using multiple types of sensors (including vision sensors 70, lasers 200, and thermal cameras 150, among others) to sense changes in the condition of the planter and seed trench 44, a complete analysis of the quality of planting may be done and presented to the operator. For example, by examining the temperature gradient of a seed trench 44 in a no-till field, a comparison of soil health to planting efficiency can be made. In this example, various sensors can collect data about the residue around and inside the seed trench 44, visible with the thermal camera 150, RPM (optionally collected with a time-of-flight sensor), and temperature data of the opening disks 52 and closing disks 58. This data optionally allow analysis of how a high residue 48 field at different soil temperatures affects the wear on a planter and the ability to form a quality seed trench 44. This data could also help understand the effect different planting environments have on the yield and the maintenance cost of planting in those environments to the operator. This data may be used to modify the operator's planting process to adapt to maximize planting efficiency and quality while maintaining the integrity of their equipment.

The sensors (including vision sensors 70, lasers 200, and thermal cameras 150, among others) may optionally transmit data wirelessly from the row unit 50 to the operator and other associated systems and devices such as a storage 102, display 14, CPU 100, and the like. To analyze the data gathered by the thermal 150 and other sensors (including vision sensors 70 and lasers 200, among others) a machine learning algorithm may be employed to quantify the data to the operator. Methods of quantifying the data may include an average temperature change of an area of interest, such as seed trench 44, or number of debris 48 identified over a linear distance amongst other methods that allow for the clear deciphering of information. This data may then be presented to the operator through a display 14, as discussed above, optionally as a slow-motion playback, actual recorded speed, and/or still images.

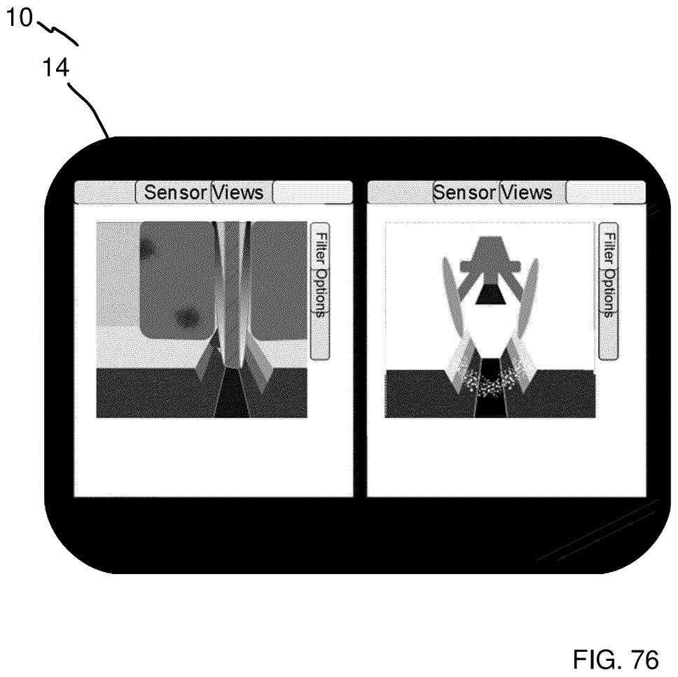

In various implementations, additional image views may be provided such as other thermal camera 150 filters, multiple thermal views from other camera locations, or a separate RGB image to better communicate the data collected by the sensors, shown in FIG. 76. Should geospatial (i.e. GPS 15) and time stamp data be collected along with the sensor data then the images collected may be viewed through a monitor 14, discussed above. In connecting images with GPS 15 location an operator may make informed planting decisions based on the thermal activity present in the soil 45, debris 48, and planter row unit 50 at various points in the field and at different planting times.

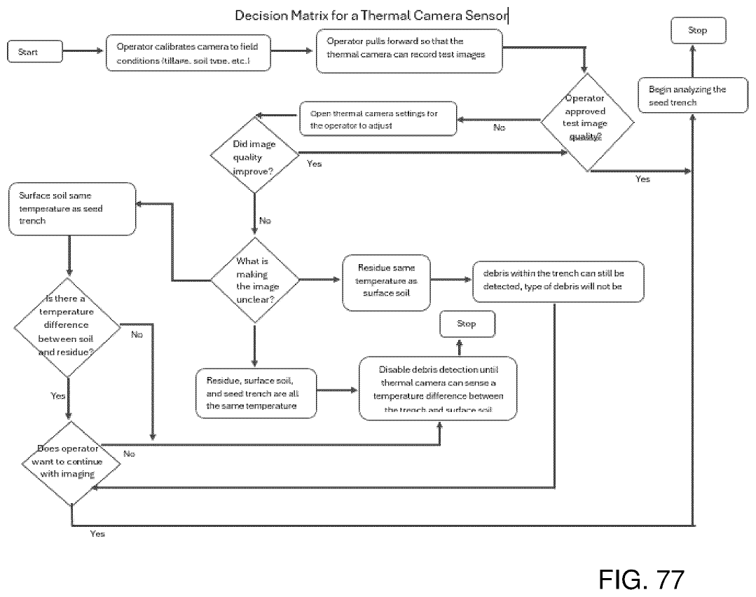

FIG. 77 shows an exemplary decision matrix for use by the thermal camera 150 and system 10 discussed herein.

### Placement

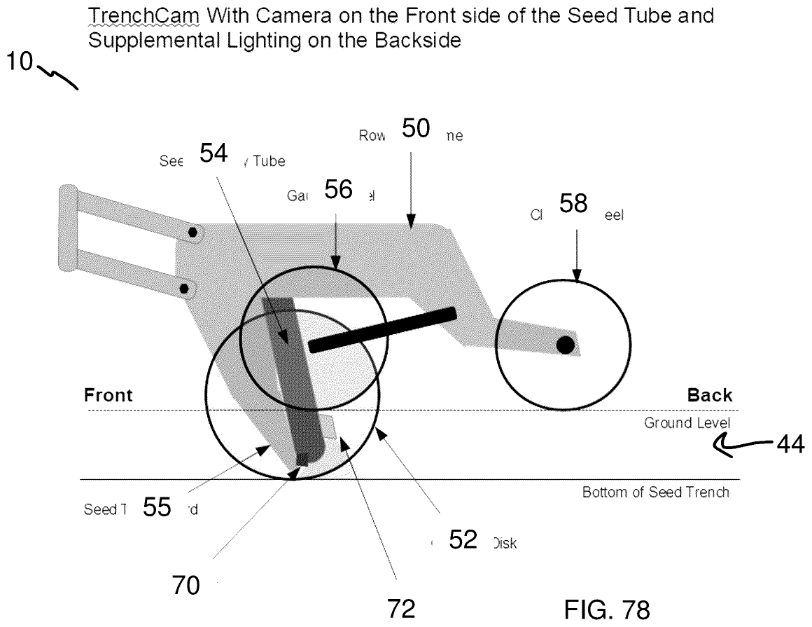

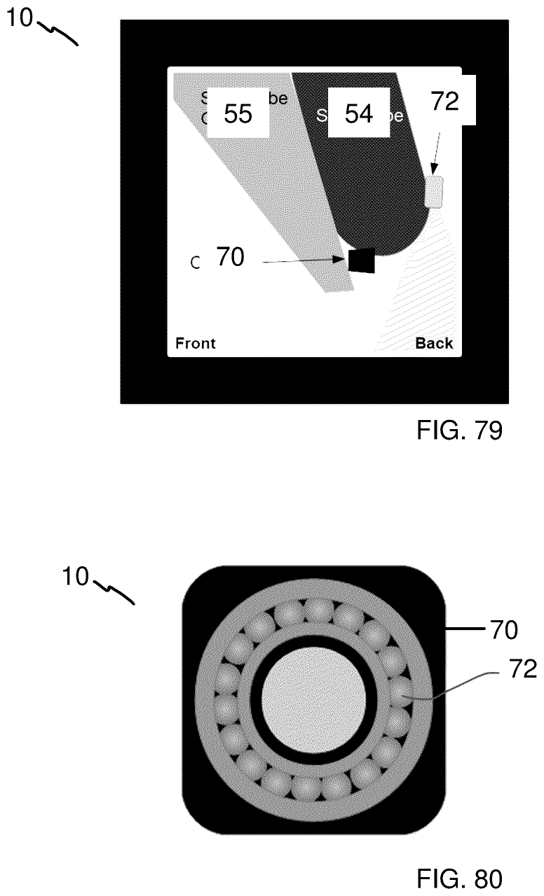

To gain a clear image of the seed trench 44 without compromising on the integrity of existing planter row unit 50 construction the imaging sensor 70 may be placed on the front side of the seed tube 54 at the bottom area in between the seed tube 54 and seed tube guard 55, shown in FIG. 78. The front side of the seed tube 54 refers to the side that faces the direction of travel while the back side faces the closing wheels 58. At this mounting location the image sensor 70 is protected from debris 48 such as, but not limited to, soil, dust, rocks, clods, and plant material while being directly inside of the seed trench 44. This location is calm in comparison to other spots along the seed trench 44 and does not inhibit normal planter performance. By placing the camera 70 below the exit point of a seed tube 54 a clear and accurate view of the seed trench 44 sidewalls can be seen as well as the seeds 42 as they are being deposited by the seed tube 54. FIG. 79 shows a close up view of the placement of the imaging sensor 70 on the front side of the seed tube 54, like that of FIG. 78.

This placement of the imaging sensor 70 has the camera 70 below the seed 42 as it emerges from the seed tube 54 allowing the ability to see the seed 42 as it settles to the bottom of the seed trench 44 and if there are any seed 42 to soil 45 contact issues that the operator should be aware of. This placement may allow the machine learning model to act as a seed meter 53 and determine the amount of skips, doubles, and percentage of refuse seed within the seed trench 44. Additionally, this placement maintains the ability to use a seed firmer 62 while planting and does not affect the performance of the seed firmer 62 as the vision sensor 70 is able to view the seed 42 within the seed trench 44 before it is pressed into the seed trench 44 by the seed firmer 62.

Supplemental lighting 72 can be placed at the bottom of the seed tube 44 next to the camera 70 (shown for example in FIG. 80 with lighting 72 embedded in the camera 70 housing) and in front of the camera 70 on the backside of the seed tube 54 (shown for example in FIGS. 78 and 79). These placements allow supplemental lighting 72 to illuminate the seed trench 44 where the seed 42 is being placed. Additional lights 71 may be placed along the row unit 50 to view the full length of the open trench from openers 52 to closers 58 or may be integrated into a seed firmer 58. Various lighting schemes have been described elsewhere herein.

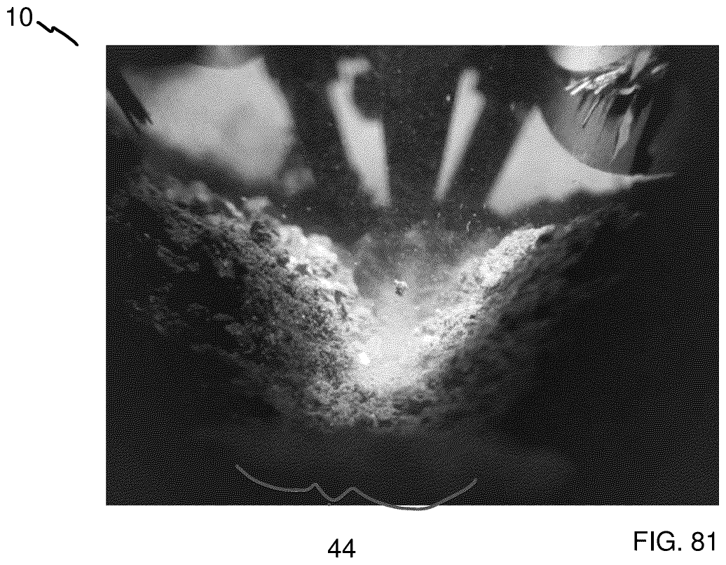

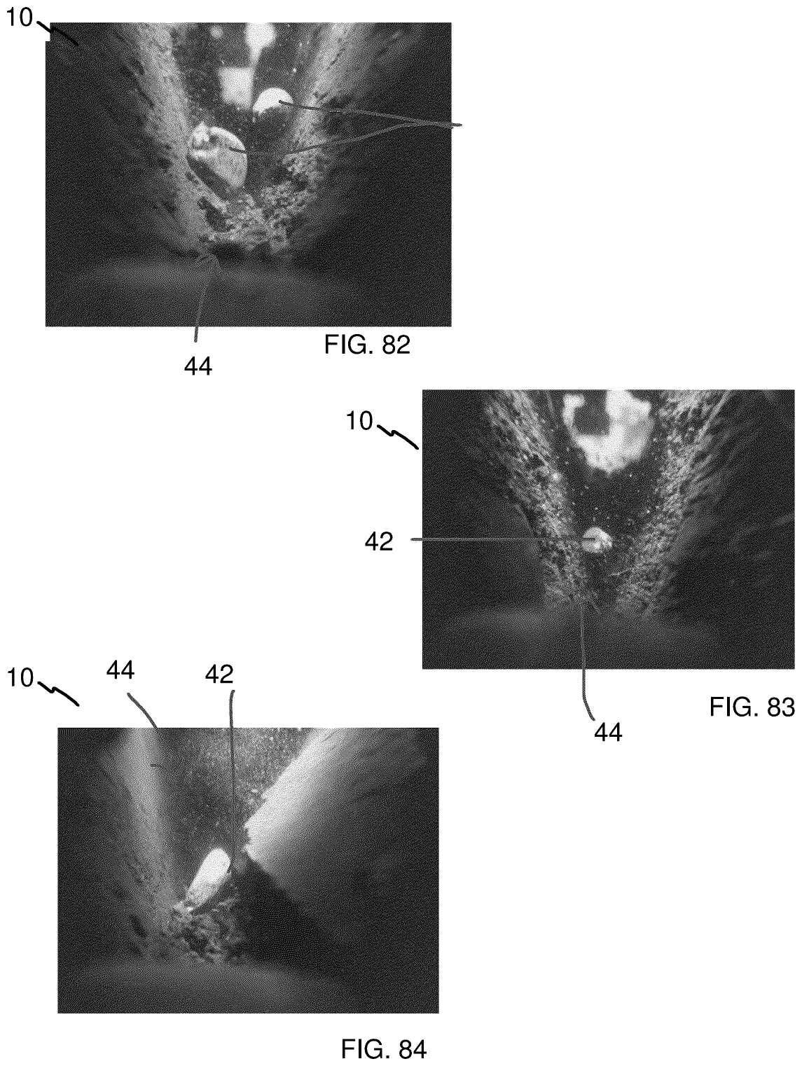

FIG. 81 shows an exemplary image of the seed trench 44 with a seed firmer 62 taken at low speeds by the system 10 with the imaging sensor 70 and lighting 72 placed as described above in connection to FIGS. 78 and 79. Similarly, FIG. 82 shows an exemplary image of seed 42 doubles taken by the system 10, FIG. 83 shows an exemplary image of a well-formed seed trench 44 taken at low speed by the system 10, and FIG. 84 shows an exemplary image of an over compacted seed trench 44 taken at high speeds by the system 10, each with the imaging sensor 70 and lighting placed as described above in connection to FIGS. 78 and 79.

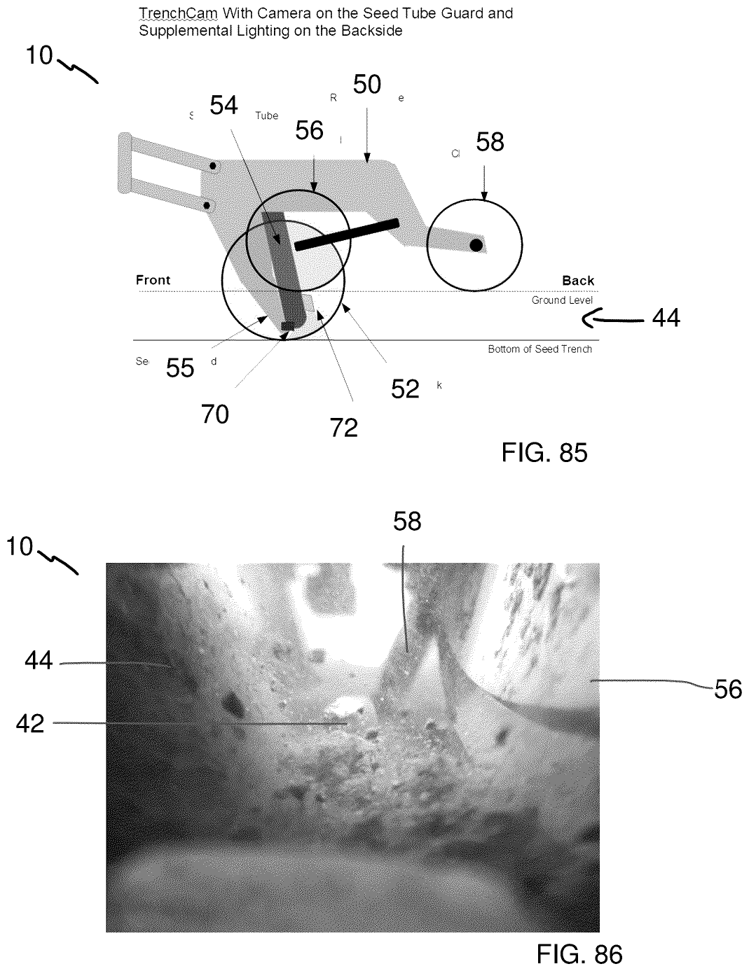

In alternative implementations, the camera/imaging sensor 70 may be placed on the seed tube guard 55 itself, shown in FIG. 85. This placement allows the seed tube to remain easily removable for servicing and maintenance while minimizing the chance that the image sensor 70 may become damaged in the process. Additionally, placing an imaging sensor 70 on the seed tube guard 55 prevents the camera 70 from experiencing excess vibration from the seed tube 54 moving while in operation. By limiting the amount of unnecessary motion experienced by the camera 70 the images collected may be of higher quality. Higher quality images allow the machine learning model to extract more data from images such as, but not limited to, planting depth and other values and data discussed herein. The machine learning model may do this by determining the distance between the bottom of the seed trench 44 and the contact point of the gauge wheels 56 on the soil since as the seed guard 55 rises with the row unit 50, the gauge wheels 56 should maintain contact with the soil.

FIG. 86 shows an exemplary image of a gauge wheel 56 and closing wheels 58 taken at low speeds by the system 10. Here depth loss can be seen by the seed 42 being parallel to the gauge wheels 56.

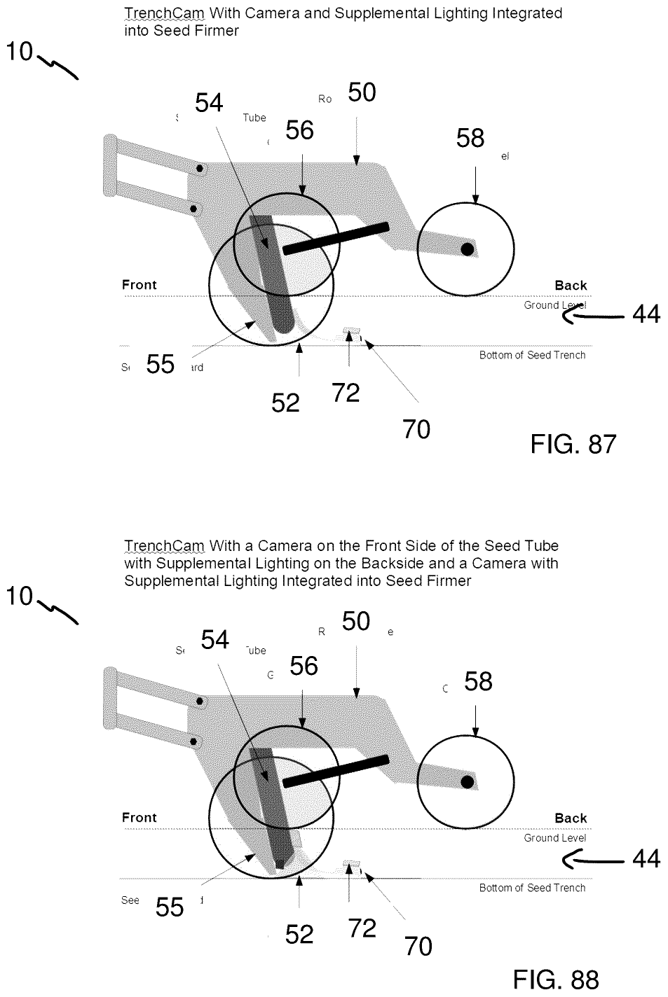

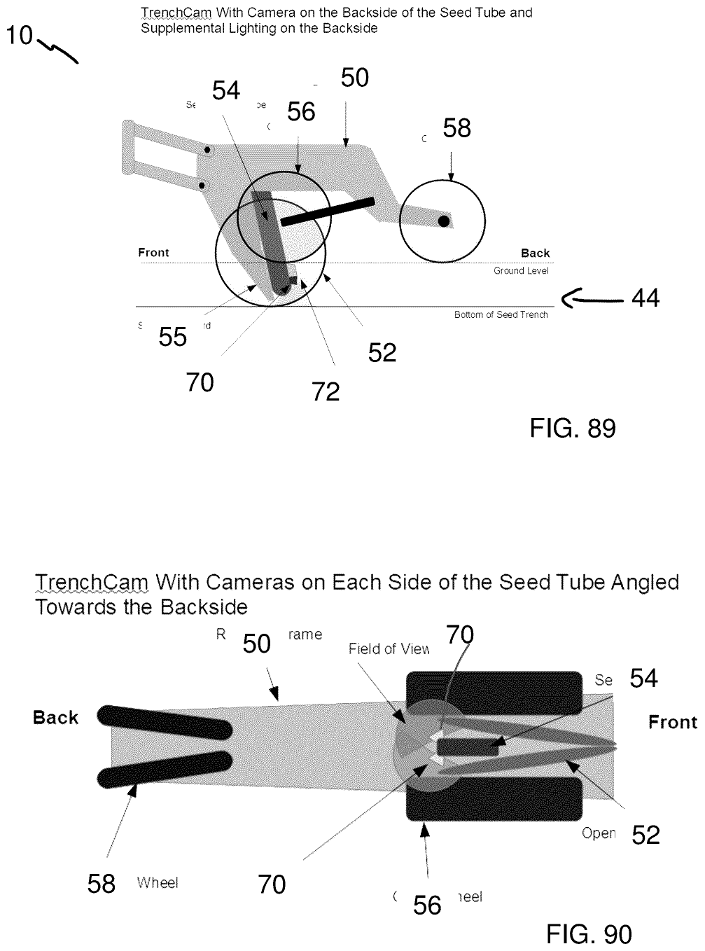

Further locations for an imaging sensor 70 to be placed may include, but are not limited to, being integrated with a seed firmer 62 (shown for example in FIGS. 87 and 88), placing the camera 70 on the backside of the seed tube 54 (shown for example in FIG. 89), and using multiple cameras 70 at the bottom of the seed tube 54 (shown in FIG. 90) and optionally along the row unit to acquire high quality images.

Turning to FIG. 90, for example, two cameras 70 may be utilized with one on each side of the seed tube 54 with a wide field of view (FOV) lenses. The use of wide lenses may allow the image sensors 70 to gather views of both the seed 42 in the seed trench 44 and the process of the seed trench 44 being opened by the opening disks 52. Two cameras 70 may also be used to compare stereo images and estimate the range of objects visible in both images.

The use of multiple image sensors 70 allows for full analysis of the seed trench 44 from when the openers 52 engage the soil to where the closers 58 seal the seed trench 44. Shown in FIG. 88, for instance, a camera 70 located on the front side of the bottom of the seed tube 54 where the seed 42 emerges can determine the quality of the environment that the seed 42 has been placed in, i.e., the quality of the seed trench. Adding a camera 70 integrated with a seed firmer 62 may allow for visualization that the seed 42 remains in the correct seed spacing while additionally being able to view the seed 42 as the closers 58 close the seed trench 44. The quality of the closing mound can also be assessed and reported to the operator if adjustments need to be made to ensure that the closers 58 remain centered and parallel with the seed trench 44.

When mounting a camera 70 at the distal end of the seed tube 54 and/or guard 55 within the seed trench 44 the gauge wheels 56 and closers 58 become difficult to image due to the dusty environment of the seed trench 44 while the row unit 50 is operating and the distance from the camera 70 to these parts. To retain the ability to determine if there is a problem with the gauge wheels 56 and closers 58 during planting the machine learning model may recommend the operator to slow down planting operations for a linear distance, for example slowing down from 9 mph to 2 mph for 50 ft, so that the debris 48 kicked up during planting can settle allowing a clear image of the gauge wheels 56 and closers 58 to be taken. Additionally or alternatively, to maintain productivity during planting the model may assess the presence and condition of the closers 58 and gauge wheels 56 when the row unit 50 is lifted during planting. If an operator does not lift the row unit 50 while turning and continuously plants, then the model may recommend that the operator pause planting to raise and lower the row unit 50 to check the presence and condition of the closers 58, openers 52, and gauge wheels 56.

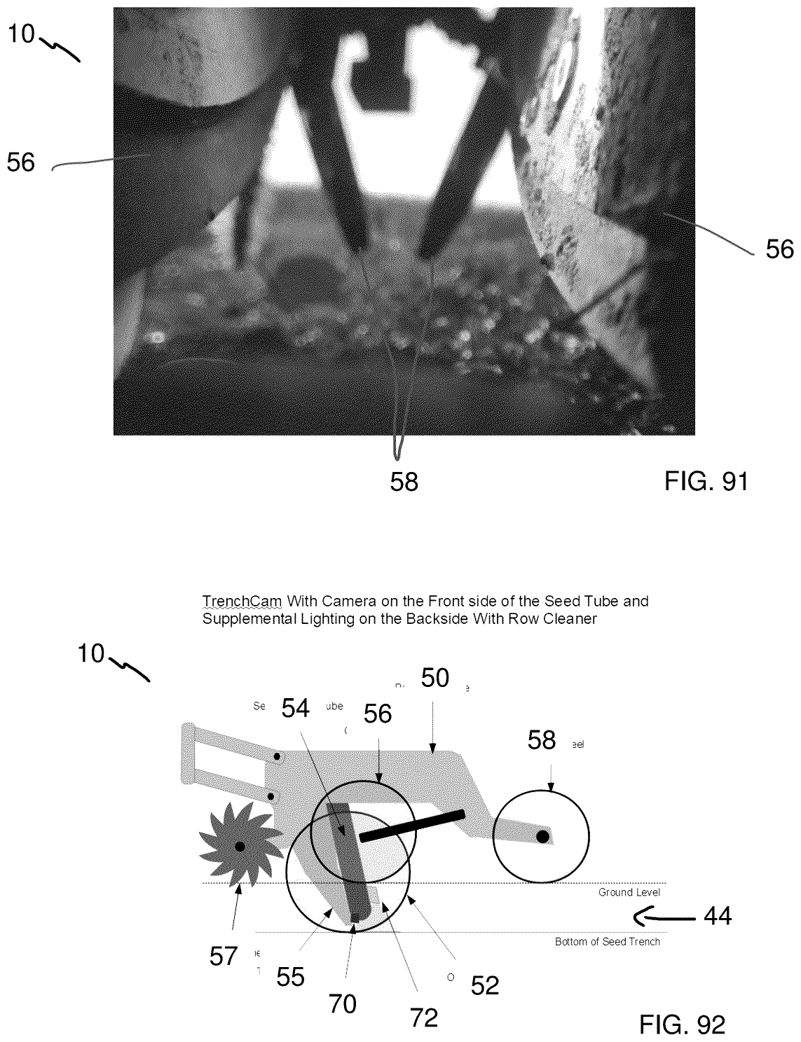

FIG. 91 shows an exemplary image of gauge wheels 56 and closers 58 taken by the system 10 while the row unit 50 was in a raised position.

Depending on the positioning of the vision sensor 70 within the seed trench 44 the camera 70 may be able to record images that also include the opening disks 52. For example, if two cameras 70 are used, one on each side of the seed tube 54, with a wide lens then the openers 52, gauge wheels 56, and closers 58 may be captured within an image. If the model can analyze images that include the openers 52, closers 58, and gauge wheels 56 then the model can assess the condition of the parts and recommend adjustments to improve the quality of the seed trench 44. For instance, when planting if the angle of the openers 52 is not properly set then a ‘W’ shape can form at the bottom peak of the seed trench 44 instead of a ‘V’ due to a gap between the opening disks 52. If the model determines that the openers 52 are properly set by analyzing the tilt of the openers 52 in relation to a spot on the row unit 50 then the model may recommend an operator check the wear of the opening disk 52. Normal wear causes the opening disks 52 to decrease in diameter creating a gap and if this problem is not fixed then soil can be pushed through the gap and become stuck in the openers. This prevents the opening disks 52 from operating correctly damaging the seed trench 44 and subsequently emergence and yield.

Additionally, the row cleaners 57, openers 52, gauge wheels 56, and closers 58 may be modified to be adjustable remotely, for example adding actuators to each part, so that while the planter is undergoing operation the machine learning model can analyze and adjust the row unit 50 settings as needed to optimize the quality of seed trench 44 formation and closing. Adjustment may be automatic, semi-automatic, or confirmed by a user. The operator may also be able to set guidelines for the machine learning model to follow such as the type of closers 58 used and the soil condition that would allow the model to make informed decisions and recommendations. For instance, as the planting depth changes the model may adjust downforce and the closing depth to ensure that planter settings maximize plant germination and growth.

Furthermore, due to the vision sensor 70 being located within the seed trench 44 the model can view the seed trench 44 sidewalls in detail. By acquiring detailed images, the model can view debris 48, voids in the sidewall, and other characteristics of the soil's condition. This may allow the model to make recommendations to the farmer on how to maintain or improve the quality of their soil. For example, frequent instances of debris 48, such as crop residue and clods or dry soil falling into the trench 44, that have been detected by the model may be a sign of poor trench 44 quality. The machine learning model may suggest lowering the row cleaners 57 to remove crop residue, clods or dry soil. The system 10 may also automatically control row cleaner 57 depth using the amount of debris 48 detected by the system 10 as feedback for the control loop. FIG. 92 shows an exemplary row unit 50 having a row cleaner 57 implementing the system 10.

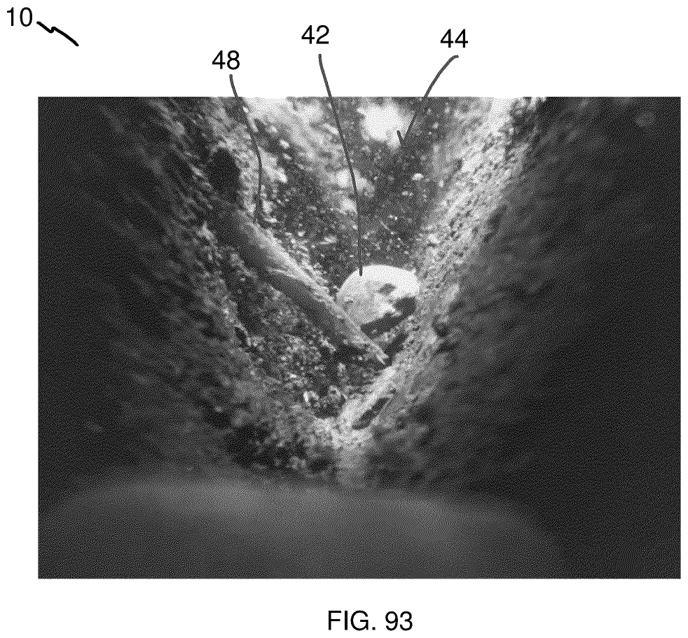

FIG. 93 shows an exemplary image of residue 48 within the seed trench taken at high speed by the system 10.

In various implementations, the system 10 includes various software, hardware, and firmware components needed to execute the programs and methods of the system 10. Optionally, the system 10 may include a communications component 6 configured to convey data from the cameras 70 to a tractor 1/display 14/storage 102 for further processing by the processor 100.

The display 14 may optionally include a communications component 6 configured to send and receive instructions for operation of the system, planter, and components thereof. The display 14 may also optionally include a graphical user interface (GUI) 22, a memory/storage 102, a global positioning system (GPS) 15, and other components necessary to effectuate the methods of the system 10.

Although the disclosure has been described with references to various embodiments, persons skilled in the art will recognize that changes may be made in form and detail without departing from the spirit and scope of this disclosure.

1. An agricultural image analysis system comprising:
(a) at least one vision sensor configured to view a seed trench;
(b) a storage module in communication with the at least one vision sensor;
(c) a processor in communication with the storage module, the processor executing at least one machine learning module for analysis of images from the at least one vision sensor.

2. The system of claim 1, wherein the at least one machine learning module is configured to detect trench formation issues including one more of peeling, smearing, collapsing, debris incursion, sidewall blowout, improper width, and improper depth.

3. The system of claim 2, wherein the processor is configured to command adjustments to one or more of a closing wheel downforce, gauge wheel downforce, row cleaner deployment based on detected trench formation issues.

4. The system of claim 2, wherein the at least one machine learning module is configured to alert an operator to the trench formation issues when more than a threshold number instances of the trench formation issue has occurred.

5. The system of claim 1, wherein the at least one machine learning module is configured to detect trench formation quality.

6. The system of claim 1, further comprising at least one supplemental lighting source mounted on a row unit.

7. The system of claim 6, further comprising one or more light filters in association with the at least one vision sensor or supplemental lighting source.

8. The system of claim 1, further comprising a position sensor configured to detect the vertical position of a row unit.

9. The system of claim 1, further comprising at least one laser configured to project a beam into the seed trench for viewing by the at least one vision sensor.

10. The system of claim 1, further comprising at least one thermal camera configured to view of the seed trench.

11. The system of claim 1, wherein the at least one vision sensor is mounted at a distal end of a seed tube.

12. The system of claim 1, further comprising at least one seed firmer disposed on a row unit, and wherein the at least one vision sensor view the seed firmer.

13. The system of claim 1, wherein the at least one vision sensor is mounted at a distal end of a seed tube guard below a seed exit point of a seed tube.

14. The system of claim 1, further comprising at least one vision sensor actuator, wherein the at least one vision sensor actuator is configured to move the at least one vision sensor.

15. An seed trench analysis system comprising:
(a) at least one laser configured to emit a beam at an open seed trench;
(b) at least one vision sensor configured to view the open seed trench and the beam;
(c) a storage module in communication with the at least one vision sensor; and
(d) a processor in communication with the storage module, the processor executing at least one machine learning module for analysis of images from the at least one vision sensor.

16. The seed trench analysis system of claim 14, wherein the at least one machine learning module is configured to detect one or more of trench peeling, trench smearing, trench collapsing, debris in the trench, seed placement errors, seed firmer errors, opening disk errors, gauge wheel errors, closing wheel errors, insecticide application errors, fertilizer application errors.

17. The system of claim 14, wherein the at least one machine learning module is configured to detect trench formation quality.

18. An agricultural planting monitoring system comprising:
(a) a thermal camera mounted to a row unit;
(b) a processor in communication with the thermal camera, the processor executing at least one machine learning module for analysis of images from the thermal camera; and
(c) a display in communication with the processor,
wherein the thermal camera is configured to capture images of a seed trench during planting operations for processing by the processor and display to an operator on the display.

19. The seed trench analysis system of claim 18, wherein the at least one machine learning module is configured to detect one or more of trench peeling, trench smearing, trench collapsing, debris in the trench, seed placement errors, seed firmer errors, opening disk errors, gauge wheel errors, closing wheel errors, insecticide application errors, fertilizer application errors.

20. The system of claim 19, wherein the at least one machine learning module is configured to detect trench formation quality.
